(19) United States
(12) Patent Application Publication
(10) Pub. No.: US 2008/0140695 A1
(43) Pub. Date: Jun. 12, 2008

(54) Intellectual property related method and computer program

(75) Inventor: Robert H. DeSelms, Washington, DC (US)

Correspondence Address: PARAGEN, INC., 1833 BILTMORE ST., NW, SUITE B, WASHINGTON, DC, 20009, US

(73) Assignee: PARAGEN, INC., Washington, DC (US)

(21) Appl. No.: 11/609,703

(22) Filed: Dec. 12, 2006

(51) Int. Cl. G06F 17/30

(52) U.S. Cl. 707/102; 707/104.1; 707/E17.009

(57) ABSTRACT

Method and computer program article of manufacture for intellectual property are disclosed. Value is added to intellectual property by including information pertaining to written description and/or enablement including embodiments, genera, processes, and/or examples. The business method includes strategies for creating and/or adding value to intellectual property by including such information, and includes strategies for using the intellectual property. A computer program and computer-based method of creating data objects that can be used as information pertaining to written description and enablement are disclosed.

### BACKGROUND

The invention relates to a method and computer program for creating, using, and/or increasing the value of intellectual property.

Intellectual property provides business entities with the opportunity to realize revenue from innovation and provides an incentive to invest in research and development. Intellectual property has intrinsic value and is the most valuable asset of many business entities.

The claims of an issued patent are frequently different from the claims of the application as-filed. During prosecution, an amendment may be necessary when an examiner rejects a claim or when an issue material to patentability otherwise arises. Generally the disclosure is the foundation for available claim amendments that meet the requirements for patentability. Support for such amendments is often introduced into the disclosure by considering the broader embodiments and creating fall-back positions featuring various modifications to the original claims.

The disclosure also plays an important role in establishing that other requirements for patentability are met. Claims must be enabled in order to be valid. In many cases examples in the disclosure form the basis for establishing whether prospective claims are enabled over the scope of the subject matter they encompass. In chemical compound practice, in many cases the species and experimental examples in the disclosure form the basis for establishing the patentability of prospective claims.

For the forgoing reasons, there is a need for a method and computer software that can be used to add value to intellectual property by introducing a plurality of embodiments, genera, and/or examples. Furthermore, there is a need for a business method directed to novel means for using, acquiring, and adding value to intellectual property.

### SUMMARY

The present invention is directed to a method and computer program that can be used to create, lower the time and/or cost of obtaining, strengthen, and/or otherwise add value to intellectual property, and that can be used to provide strategies for creating, increasing the value of, and/or using intellectual property.

In one embodiment, the invention is directed to a business method; the method includes creating intellectual property; the method of creating the intellectual property includes using a computer to create a group of chemical compound names; the group of chemical compound names includes several chemical compound names; the chemical compound names are created by combining phrases.

In one embodiment, the invention is directed to a method, using a computer, of creating a set of descriptions containing one or more descriptions; the set of descriptions is created starting with a group of segments; the group of segments contains two or more segments; each segment corresponds to a set of phrases, and each set of phrases contains one or more phrases; each description is created by joining one phrase for each segment from the set of phrases corresponding to that segment.

In one embodiment, the invention is directed to a method, in a data processing system comprising one or more CPUs, of creating a set of data objects, wherein said set of data objects comprises one or more data objects, comprising the steps of:

providing data-object-creation data, wherein said data-object-creation data comprises a set of variable strings, wherein the set of variable strings comprises one or more subsets of variable strings, and wherein each subset of variable strings of the set of variable strings comprises one or more variable strings, and

creating each of the data objects of the set of data objects, using the data-object-creation data, such that each of the data objects of the set of data objects comprises one or more variable strings of the set of variable strings.

In one embodiment, the invention is directed to a method, in a data processing system comprising one or more CPUs, of creating a set of chemical compound names comprising one or more chemical compound names, comprising the steps of:

providing a template string comprising a set of variable-directing strings, wherein such set of variable-directing strings comprises one or more variable-directing strings, wherein each of such variable-directing strings comprises information,

providing a set of variable strings comprising one or more variable strings, and

creating each of the chemical compound names of the set of chemical compound names, using the template string as a template, by using the information contained within each of the variable-directing strings of the set of variable-directing strings of the template string to direct the replacement of that variable-directing string with one of the variable strings of the set of variable strings.

In one embodiment, the invention is directed to a method, in a data processing system comprising one or more CPUs, of creating a set of chemical compound preparations comprising one or more chemical compound preparations, wherein each such chemical compound preparation comprises information pertaining to a procedure for synthesizing a chemical compound, wherein the information of the chemical compound preparations of the set of chemical compound preparations pertains to either: preparations of the same chemical compound, or to preparations of two or more different chemical compounds; comprising:

providing a template string, wherein the template string comprises characters that are common to all of the chemical compound preparations of the set of chemical compound preparations, and wherein said template string further comprises a set of variable-directing strings comprising one or more variable-directing strings,

providing a set of variable strings comprising one or more subsets of variable strings, wherein each of such subsets of variable strings comprises one or more variable strings, and wherein each of such subsets of variable strings corresponds to one or more variable-directing strings of the set of variable-directing strings, such that each variable-directing string of the set of variable-directing strings has a corresponding subset of variable strings of the set of variable strings,

wherein each chemical compound preparation of the set of chemical compound preparations is created, using the template string as a template, by replacing each of the variable-directing strings of the set of variable-directing strings of the template string with one of the variable strings of the subset of variable strings corresponding to that variable-directing string, such that the set of chemical compound preparations so created comprises all of the chemical compound preparations representing all of the permutations of replacements of each of the variable-directing strings of the set of variable-directing strings in the template string with one of the variable strings of the subset of variable strings corresponding to that variable-directing string.

In one embodiment, the invention is directed to a computer program article of manufacture having a computer readable medium having computer program logic recorded thereon for creating a set of data objects comprising one or more data objects, said computer program article of manufacture comprising:

instruction means for receiving data-object-creation data, wherein said data-object-creation data comprises a set of variable strings, wherein said set of variable strings comprises one or more subsets of variable strings, and wherein each subset of variable strings comprises one or more variable strings, and

instruction means for using the data-object-creation data to create each one of the data objects of the set of data objects, such that each one of the data objects of the set of data objects comprises one or more variable strings of the set of variable strings.

In one embodiment, the invention is directed to a business method for acquiring intellectual property comprising the steps, performed in a data processing system comprising one or more CPUs, of:

providing a set of chemical data, wherein the set of chemical data comprises one or more items of chemical data,

using the set of chemical data to create a set of chemical information, wherein said set of chemical information comprises one or more items of chemical information; and

outputting one or more items of chemical information of the set of chemical data to a file.

In one embodiment, the invention is directed to a method, in a data processing system comprising one or more CPUs, of creating a set of data objects, wherein said set of data objects comprises one or more data objects, comprising the steps of:

providing data-object-creation data, wherein said data-object-creation data comprises a set of variable strings, wherein the set of variable strings comprises one or more subsets of variable strings, and wherein each subset of variable strings of the set of variable strings comprises one or more variable strings, and

creating each of the data objects of the set of data objects, using the data-object-creation data, such that each of the data objects of the set of data objects comprises one or more variable strings of the set of variable strings;

wherein one or more of the data objects of the set of data objects is a chemical compound name, wherein each chemical compound name represents a chemical compound.

In one embodiment, the invention is directed to a method, in a data processing system comprising one or more CPUs, of creating a set of data objects, wherein said set of data objects comprises one or more data objects, comprising the steps of:

providing data-object-creation data, wherein said data-object-creation data comprises a set of variable strings, wherein the set of variable strings comprises one or more subsets of variable strings, and wherein each subset of variable strings of the set of variable strings comprises one or more variable strings, and

creating each of the data objects of the set of data objects, using the data-object-creation data, such that each of the data objects of the set of data objects comprises one or more variable strings of the set of variable strings;

wherein one or more of the data objects of the set of data objects are chemical compound preparations.

In one embodiment, the invention is directed to a method, in a data processing system comprising one or more CPUs, of creating a set of data objects, wherein said set of data objects comprises one or more data objects, comprising the steps of:

providing data-object-creation data, wherein said data-object-creation data comprises a set of variable strings, wherein the set of variable strings comprises one or more subsets of variable strings, and wherein each subset of variable strings of the set of variable strings comprises one or more variable strings; and wherein the data-object-creation data comprises a set of variable-directing strings comprising one or more variable-directing strings; and

creating each of the data objects of the set of data objects, using the data-object-creation data, such that each of the data objects of the set of data objects comprises one or more variable strings of the set of variable strings; and using the variable-directing stings of the set of variable-directing strings to direct the placement of the variable strings within such data objects.

In one embodiment, the invention is directed to a method, in a data processing system comprising one or more CPUs, of creating a set of data objects, wherein said set of data objects comprises one or more data objects, comprising the steps of:

providing data-object-creation data, wherein said data-object-creation data comprises a set of variable strings, wherein the set of variable strings comprises one or more subsets of variable strings, and wherein each subset of variable strings of the set of variable strings comprises one or more variable strings, and

creating each of the data objects of the set of data objects, using the data-object-creation data, such that each of the data objects of the set of data objects comprises one or more variable strings of the set of variable strings;

wherein the data-object-creation data comprises a template string, wherein said template string comprises a set of variable-directing strings, wherein said set of variable-directing strings comprises one or more variable-directing strings, and wherein said template string further comprises a set of exon strings, wherein the set of exon strings comprises one or more exon strings,

wherein each of the subsets of variable strings corresponds to one or more variable-directing strings of the set of variable-directing strings, such that each variable-directing string of the set of variable-directing strings has a corresponding subset of variable strings of the set of variable strings,

wherein the template string is used in the creation of each of the data objects of the set of data objects such that:

each of the data objects of the set of data objects comprises: every one of the exon strings of the set of exon strings; and one variable string of the corresponding subset of variable strings for each variable-directing string of the set of variable-directing strings;

wherein each of the variable-directing strings corresponds to a different variable-string locus within the data objects of the set of data objects, such that the number of variable-string loci within each of the data objects of the set of data objects is equal to the number of variable-directing strings of the set of variable-directing strings,

wherein each of the variable-string loci corresponds to the subset of variable strings that corresponds to that variable-string locus' variable-directing string,

and each of the variable-directing strings of the set of variable-directing strings is used to direct the placement of one of the variable strings from the corresponding subset of variable strings, at the variable-string locus corresponding to that variable-directing string, within each of the data objects of the set of data objects;

such that the set of data objects so created comprises all of the data objects representing all of the permutations of placements, at each of the variable-string loci, of each of the variable strings of the subset of variable strings corresponding to that variable-string locus.

In one embodiment, the invention is directed to a business method for acquiring intellectual property comprising the steps, performed in a data processing system comprising one or more CPUs, of:

providing data-object-creation data, wherein said data-object-creation data comprises a set of variable strings, wherein the set of variable strings comprises one or more subsets of variable strings, and wherein each subset of variable strings of the set of variable strings comprises one or more variable strings,

creating a set of data objects, wherein the set of data objects comprises one or more data objects, using the data-object-creation data, such that each of the data objects of the set of data objects comprises one or more variable strings of the set of variable strings; wherein the data objects of the set of data objects are inventive embodiments; and comprising the step, performed by a user, of:

creating the intellectual property using one or more of the inventive embodiments.

In one embodiment, the invention is directed to a business method, wherein said business method comprises the steps, performed by a user, of:

providing a set of chemical compound names, wherein the set of chemical compound names comprises one thousand or more chemical compound names, wherein each chemical compound name represents a chemical compound,

providing enablement information pertaining to the chemical compounds represented by the chemical compound names, and

creating intellectual property using the chemical compound names and the enablement information.

In one embodiment, the invention is directed to a method of adding value to intellectual property comprising the steps, performed by a user, of:

providing an intellectual property instrument,

providing a set of inventive embodiments comprising one or more inventive embodiments, and

using the intellectual property instrument and one or more of the inventive embodiments of the set of inventive embodiments to create a value-added intellectual property instrument, wherein the value-added intellectual property instrument comprises one or more of the inventive embodiments of the set of inventive embodiments.

In one embodiment, the invention is directed to a method of adding value to intellectual property comprising the steps, performed by a user, of:

providing an intellectual property instrument,

providing a set of inventive embodiments comprising one or more inventive embodiments, and

using the intellectual property instrument and one or more of the inventive embodiments of the set of inventive embodiments to create a value-added intellectual property instrument, wherein the value-added intellectual property instrument comprises one or more of the inventive embodiments of the set of inventive embodiments, wherein the set of inventive embodiments is a set of data objects, and wherein each inventive embodiment of the set of inventive embodiments is a data object of the set of data objects, wherein the set of data objects is created by the steps, performed by a data processing system comprising one or more CPUs, of:

providing data-object-creation data, wherein said data-object-creation data comprises a set of variable strings, wherein the set of variable strings comprises one or more subsets of variable strings, and wherein each subset of variable strings of the set of variable strings comprises one or more variable strings, and

creating each of the data objects of the set of data objects, using the data-object-creation data, such that each of the data objects of the set of data objects comprises one or more variable strings of the set of variable strings.

In one embodiment, the invention is directed to a method of adding value to intellectual property, comprising:

a step for providing an intellectual property instrument,

a step for providing inventive embodiments, and

a step for creating value-added intellectual property using the intellectual property instrument and inventive embodiments.

In one embodiment, the invention is directed to a method, in a data processing system comprising one or more CPUs, of creating a set of data objects, wherein said set of data objects comprises one or more data objects, comprising:

a step for providing data-object-creation data, wherein the data-object-creation data comprises a set of variable strings, wherein the set of variable strings comprises one or more subsets of variable strings, and wherein each subset of variable strings of the set of variable strings comprises one or more variable strings, and

a step for creating each of the data objects of the set of data objects using the data-object-creation data such that each of the data objects of the set of data objects comprises one or more variable strings of the set of variable strings.

In one embodiment, the invention is directed to a method of creating intellectual property comprising:

a step for providing a set of inventive embodiments, wherein the set of inventive embodiments comprises one thousand or more inventive embodiments,

a step for providing enablement information, and

a step for providing utility information, and

a step for combining the set of inventive embodiments, the enablement information, and the utility information to produce the intellectual property.

### BRIEF DESCRIPTION OF THE DRAWINGS

These and other features, aspects, and advantages of the present invention will become better understood with regard to the following description, embodiments, appended claims, and accompanying drawings where:

FIG. 1 is a flowchart illustrating one embodiment of a method of creating data objects.

FIG. 2 is a flowchart illustrating one embodiment of a method of creating chemical compound names.

FIG. 3 is a flowchart illustrating one embodiment of a method of creating a file comprising one or more data objects.

FIG. 4 is a flowchart illustrating one embodiment of a method of creating and using intellectual property comprising one or more chemical compound names.

FIG. 5 is a flowchart illustrating one embodiment of a method of creating and using intellectual property comprising one or more chemical compound names.

FIG. 6 is a flowchart illustrating one embodiment of a method of creating and using intellectual property comprising a method, using a computer program article of manufacture, of creating a file comprising chemical compound names.

### DEFINITIONS

The following definitions are not intended to limit the scope of the present invention, but rather are intended to clarify terms that are used in describing the present invention. It should be appreciated that the defined terms may also have other meanings to persons having ordinary skill in the art, and other meanings defined through the context of their use herein. These and other terms are used in the detailed description below. The present invention will be described with a certain degree of particularity, however those of skill in the art will appreciate that various modifications and alterations may be carried out without departing from either the spirit or scope, as hereinafter described.

The designated order of method and process steps disclosed herein should by no means be regarded as imposing particular order in any method or process steps unless otherwise indicated.

As used in the specification, “a” and “an” mean one or more. As used in the claim(s), when used in conjunction with the words “comprising”, the words “a” and “an” mean one or more. As used herein, “another” means at least a second or more.

As used herein, the terms “include” and “comprise,” as well as derivatives thereof, mean inclusion without limitation. As used in method and process claims, such terms do not preclude additional steps.

As used herein, the term “enablement information”, when used as an element of a claim or embodiment, means information pertaining to enablement of the relevant subject matter. “Enablement information” can be information pertaining directly to enablement of the relevant subject matter, or one or more incorporations by reference or other references to such information, or some combination.

As used herein, the term “intellectual property” refers to patents, patent applications, trade secrets, statutory invention registrations and the equivalent, statutory invention registration applications and the equivalent, statutory invention registration applications and the equivalent and patent applications that are ready for filing, statutory invention registration applications and the equivalent and patent applications that are in-preparation, and filings otherwise submitted in the course of prosecution or otherwise in-preparation or ready for filing. Intellectual property may be published or unpublished, secret or made-public.

As used herein, the term “user” refers to one or more persons. Where different steps in a method or process are performed by “a user” or “the user”, the steps are not necessarily performed by the same person or persons in each step.

As used herein, the term “performed by a user”, when used in the context of a step in a method or process, indicates that the step comprises an act performed by one or more persons. The term does not preclude the use of a processor or data processing system by the user in performing the step.

As used herein, the term “providing”, when used in the context of a step in a method or process performed by a processor or data processing system, means making available in a form usable by the processor or data processing system, and does not preclude acts performed by a user regarding that which is provided.

As used herein, the term “providing”, when used in the context of a step in a method or process performed by a user, means making available in a form usable by the user, and does not preclude acts performed by a processor or data processing system regarding that which is provided.

As used herein, the term “processor” means one or more computers each comprising one or more CPUs. Where different steps in a method or process are performed in “a processor” or “the processor”, the steps are not necessarily performed in the same computer/s and CPU/s used in other steps.

As used herein, the term “data processing system” means one or more computers each comprising one or more CPUs. Where different steps in a method or process are performed in “a data processing system” or “the data processing system”, the steps are not necessarily performed in the same computer/s and CPU/s used in other steps.

As used herein, the term “chemical compound” refers to inorganic and organic compounds and polymers and salts and complexes and ions and fragments and radicals thereof, and can be charged or neutral. One of skill in the art will appreciate that some classes and subclasses of chemical compounds can exist in various isomeric and/or conformational forms. A “chemical compound” can be a single enantiomer, a racemic mixture, a mixture of enantiomers, a single diastereomer, a mixture of diastereomers, a single stereoisomer, a mixture of stereoisomers, a single tautomer, a mixture of tautomers, a single conformer, or a mixture of conformers. The term “chemical compound” refers to other meanings of the term as understood by one of skill in the art.

As used herein, the term “chemical compound name” refers to a representation of a chemical compound via data, characters, symbols, or other computer-based, textual, or pictographic representation, or some combination thereof. Unless otherwise indicated, chemical compound names as they are ultimately represented in: documents, files, intellectual property, computer-based media, computer memory, or other media in which they are represented; need not appear according to their form or orientation or conformation or arrangement or representation as-created.

One of skill in the art will recognize that methods and processes that comprise the creation of chemical compound names may be carried out in a number of different ways, including: creating a group of chemical compound names such that each chemical compound name is created one at a time; creating a group of chemical compound names such that the creation of one or more chemical compound names commences while one or more other chemical compound names is partially completed; creating a group of chemical compound names in parallel; creating a group of chemical compound names such that one feature of each chemical compound name is established for each chemical compound name, followed by establishing a second feature of each chemical compound name for each chemical compound name, and repeating for the third and subsequent features as-necessary; changing one or more features of one or more chemical compound names; changing one or more chemical compound names into one or more different chemical compound names; rearranging the order of components of one or more chemical compound names; converting one or more chemical compound names into different representations of such chemical compound names; as well as other ways of carrying out the methods and processes that comprise the creation of chemical compound names.

One of skill in the art will recognize other ways of carrying out the steps of methods and processes that comprise the creation of chemical compound names, including: commencing the output of one or more chemical compound names before one or more other chemical compound names have been completed; commencing the output of the chemical compound names after all of the chemical compound names have been completed; outputting each chemical compound name as it is created; eliminating one or more chemical compound names; eliminating one or more chemical compound names after all of the chemical compound names have been created; eliminating one or more chemical compound names before all of the chemical compound names have been completed; eliminating each of one or more chemical compound names before that chemical compound name has been completed; eliminating one or more chemical compound names after having been output; as well as other ways of carrying out the methods and processes that comprise the creation of chemical compound names.

As used herein, the term “data object” refers to a set of data, characters, symbols, or other computer-based, textual, or pictographic representation, or some combination thereof. Unless otherwise indicated, data objects as they are ultimately represented in: documents, files, intellectual property, computer-based media, computer memory, or other media in which they are represented; need not appear according to their form as-created.

One of skill in the art will recognize that methods and processes that comprise the creation of data objects may be carried out in a number of different ways, including: creating a group of data objects such that each data object is created one at a time; creating a group of data objects such that the creation of one or more data objects commences while one or more other data objects is partially completed; creating a group of data objects in parallel; creating a group of data objects such that one feature of each data object is established for each data object, followed by establishing a second feature of each data object for each data object, and repeating for the third and subsequent features as-necessary; changing one or more features of one or more data objects; changing one or more data objects into one or more different data objects; rearranging the order of components of one or more data objects; converting one or more data objects into different representations of such data objects; as well as other ways of carrying out the methods and processes that comprise the creation of data objects.

One of skill in the art will recognize other ways of carrying out the steps of methods and processes that comprise the creation of data objects, including: commencing the output of one or more data objects before one or more other data objects have been completed; commencing the output of the data objects after all of the data objects have been completed; outputting each data object as it is created; eliminating one or more data objects; eliminating one or more data objects after all of the data objects have been created; eliminating one or more data objects before all of the data objects have been completed; eliminating each of one or more data objects before that data object has been completed; eliminating one or more data objects after having been output; as well as other ways of carrying out the methods and processes that comprise the creation of data objects.

As used herein, the phrase “in one embodiment” indicates that the embodiment described is to be construed as an independent claim would be construed.

As used herein, the phrase “in another embodiment” indicates that the embodiment described includes the limitations of and is to be construed as though it were a dependent claim of the immediately preceding embodiment having the introductory words “in one embodiment.”

As used herein, the phrases “in a further embodiment” and “in another further embodiment” indicate that the embodiment described includes the limitations of and is to be construed as though it were a dependent claim of the immediately preceding embodiment having the introductory words “in another embodiment.”

As used herein, the phrases “in a further further embodiment” and “in another further further embodiment” indicate that the embodiment described includes the limitations of and is to be construed as though it were a dependent claim of the immediately preceding embodiment having either the introductory words “in a further embodiment” or “in another further embodiment.”

As used herein, the phrases “in a further further further embodiment” and “in another further further further embodiment” indicate that the embodiment described includes the limitations of and is to be construed as though it were a dependent claim of the immediately preceding embodiment having either the introductory words “in a further further embodiment” or “in another further further embodiment.”

As used herein, the phrases “in a further further further further embodiment” and “in another further further further further embodiment” indicate that the embodiment described includes the limitations of and is to be construed as though it were a dependent claim of the immediately preceding embodiment having either the introductory words “in a further further further embodiment” or “in another further further further embodiment.”

As used herein, the phrases “in a further further further further further embodiment” and “in another further further further further further embodiment” indicate that the embodiment described includes the limitations of and is to be construed as though it were a dependent claim of the immediately preceding embodiment having either the introductory words “in a further further further further embodiment” or “in another further further further further embodiment.”

One of skill in the art will recognize that each dependent claim can be recast in independent claim form by incorporating into the language thereof the limitations of the claim from which it depends.

One of skill in the art will recognize that each embodiment can be recast as an independent claim by rewriting the embodiment as a claim and incorporating into the language thereof the limitations of the embodiment which it narrows.

With regard to claims and embodiments comprising an “instruction means” limitation, applicant intends to encompass within the language any computer-based algorithm presently existing or developed in the future that performs the same function.

With regard to claims and embodiments comprising a “step for” limitation, applicant intends to encompass within the language any method presently existing or developed in the future that performs the same function.

### Overview

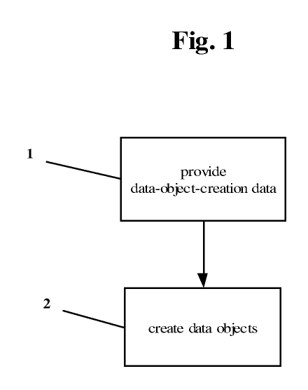

FIG. 1 is a flowchart illustrating one embodiment of a method of creating data objects. Data object creation data is provided (1) comprising data used by a computer to create data objects (2). It is possible to create many such data objects via the computer-based process.

The process has utility because it is an intermediate process that can be used to create elements that can be used in creating intellectual property. The process also has utility because it can be used to create a database of chemical compound names and methods of making them, and can be used to add value to intellectual property and business entities by generating genera and species of embodiments including chemical compound names, methods of preparing chemical compounds, range parameters for methods and articles of manufacture, permutations of claim limitations, and pharmaceutical formulations, among other uses. Other utilities are disclosed elsewhere herein. The utilities for this process disclosed herein should not be interpreted to impose limitations on the scope of the claims.

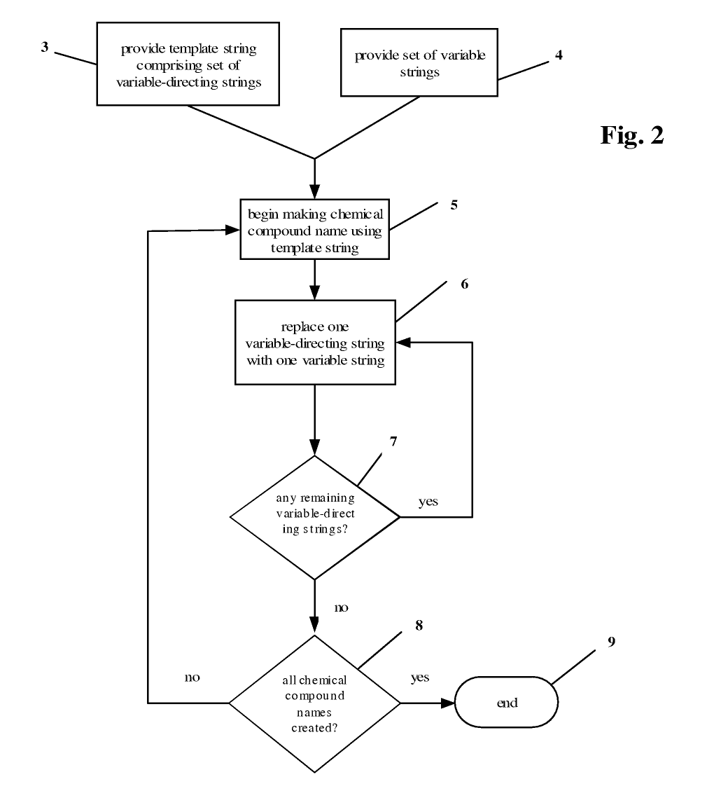

FIG. 2 is a flowchart illustrating one embodiment of a method of creating chemical compound names. Template strings are provided (3) comprising variable directing strings which direct the placement of variable strings (4) within the resulting chemical compound names. Chemical compound names are then created (5) using the template string. A process is commenced to create chemical compound names by replacing one variable-directing string (6) with one variable string. A check is then performed to determine if any variable-directing strings remain (7). If variable-directing strings remain, the process is repeated by replacing another variable-directing string with a variable string (6) until no variable-directing strings remain. A check is then performed to determine whether any further chemical compound names remain to be created (8). If there are still chemical compound names to be created, the process is repeated, creating another chemical compound name from the template string (6) until all of the chemical compound names have been created, at which point the process is complete (9).

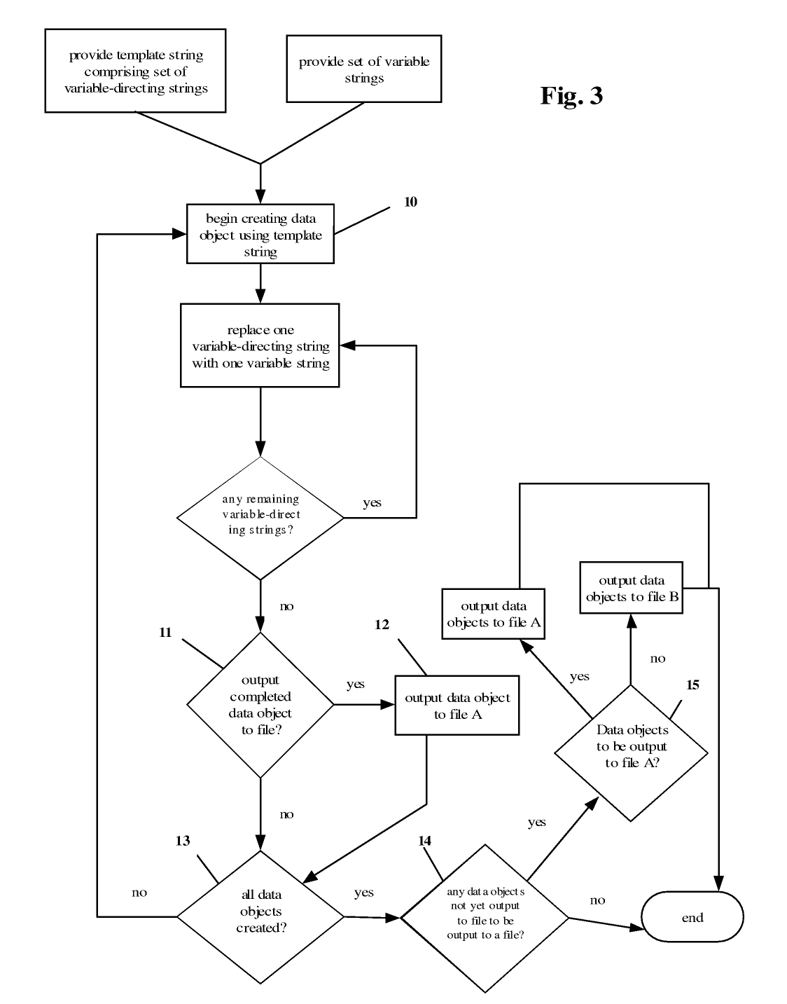

FIG. 3 is a flowchart illustrating one embodiment of a method of creating a file comprising one or more data objects. A process is commenced wherein a provided set of variable strings and a provided template string comprising a set of variable-directing strings are used to create data objects (10). A process is used to replace one variable-directing string with one variable string until there are no remaining variable-directing strings, followed by a check to determine whether the completed data object is to be output to a file (11) and, if yes, the data object is output to file A (12). After the data object is output to the file, or if the data object is not to be out put to the file, there is a check to determine whether all of the data objects have been created (13). If no, further data objects are created until all data objects have been created. Once all data objects have been created, a check is performed to determine whether any remaining data objects which have not yet been output to a file are to be output to a file (14). If no, the process is terminated. If yes, a check is made to determine whether the data objects are to be output to file A or to file B (15). Those data objects to be output to file A are output to file A, and those data objects to be output to file B are output to file B, followed by termination of the process.

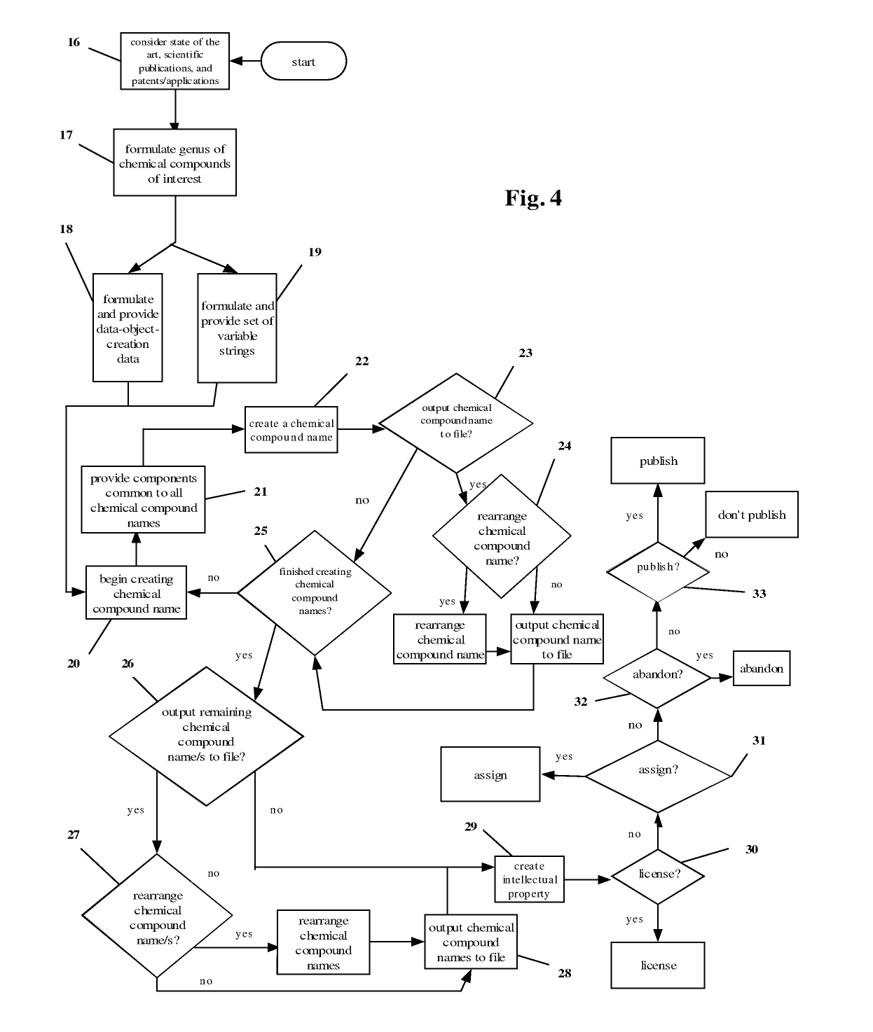

FIG. 4 is a flowchart illustrating one embodiment of a method of creating and using intellectual property comprising one or more chemical compound names. The state of the relevant art, scientific papers, patents, and patent applications are considered (16) and used to formulate a genus of chemical compounds (17). Data object creation data (18) and a set of variable strings (19) are formulated and provided and the process of creating the chemical compound names commences (20). Those portions of the chemical compound names that are common to all of the chemical compound names are then provided (21) followed by the creation of a chemical compound name (22) using the common portions, the data-object creation data, and the variable strings. After creation of the chemical compound name, a test is performed to determine whether the chemical compound name is to be output to a file (23). If yes, a test is performed to determine whether the chemical compound name is to be rearranged before being output to the file (24). The chemical compound name is then rearranged if appropriate. A test is then performed to determine whether all of the chemical compound names have been created (25). If more chemical compound names remain to be created, the process of creating another chemical compound name commences (20). If all of the chemical compound names have been created, a test is performed to determine whether any remaining chemical compound names are to be output to the file (26). If no further chemical compound names are to be output to the file, the intellectual property is created (29). If further chemical compound names are to be output to the file, another test is performed to determine if the chemical compounds are to be rearranged before output to the file (27). If yes, the chemical compound names are rearranged before output to the file (28). If not, the chemical compound names are added to the file without rearrangement and the intellectual property is created (29) such that the total number of chemical compound names in the file is greater than or equal to one.

Intellectual property is created by providing enablement and utility information, optionally derived from the information appearing in the state of the art or the publications, patents, or patent applications that were considered in formulating the genus of chemical compounds of interest, followed by filing as a patent application. Fees can either be paid upon filing or can be paid later. The patent application is then offered for license (30), (31). If either an agreement to license or assign is executed, the process terminates. If no agreement to license or assign is reached, a decision is made regarding whether to abandon the application (32). If yes, the application is abandoned. If no, a decision is made whether to publish or not publish the application (33), assuming that it has not already been published.

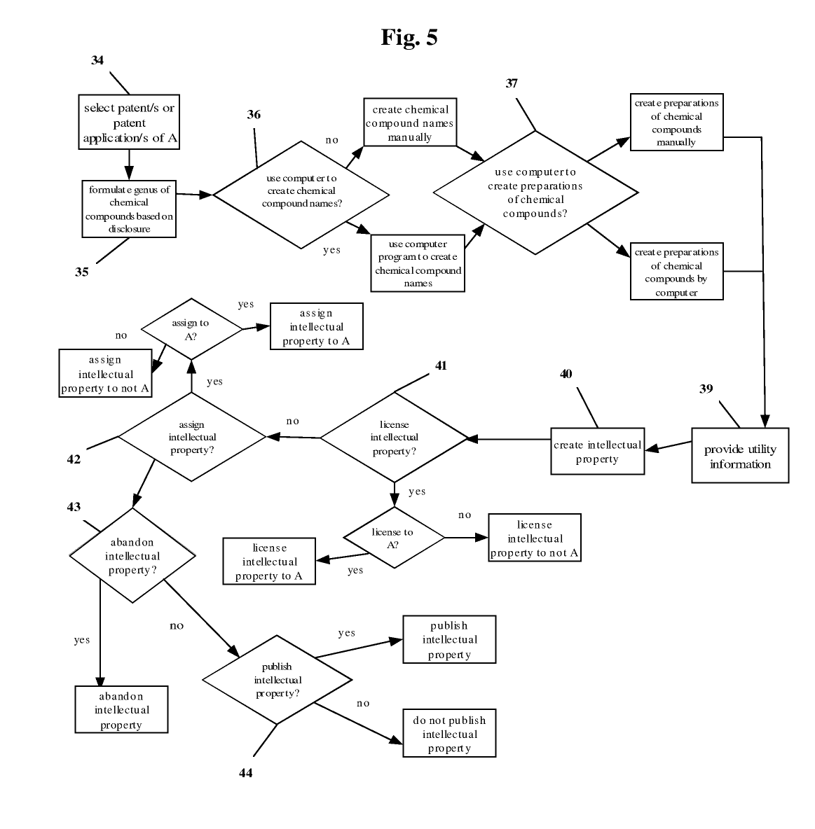

FIG. 5 is a flowchart illustrating one embodiment of a method of creating and using intellectual property comprising one or more chemical compound names. One or more patents and/or patent applications belonging to a first assignee are selected (34) and used to formulate a genus of chemical compounds of interest based on the disclosure (35). A decision is then made between creating the chemical compound names by a user or by computer (36). Another decision is also made between creating preparations of chemical compounds by hand or by computer (37). Utility information is also provided (39) and the intellectual property is created (40). A decision is then made whether to license the intellectual property (41). If the intellectual property is to be licensed, another decision is made regarding whether to license the intellectual property to the first assignee or to another business entity. If the intellectual property is not to be licensed, a decision is also made regarding whether to assign the intellectual property (42). If the intellectual property is to be assigned, another decision is made regarding whether to assign the intellectual property to the first inventor or to another business entity. If the intellectual property is not assigned, a decision is made whether to abandon the intellectual property (43). If yes, the intellectual property is abandoned. If not, a decision is made regarding whether to publish the intellectual property

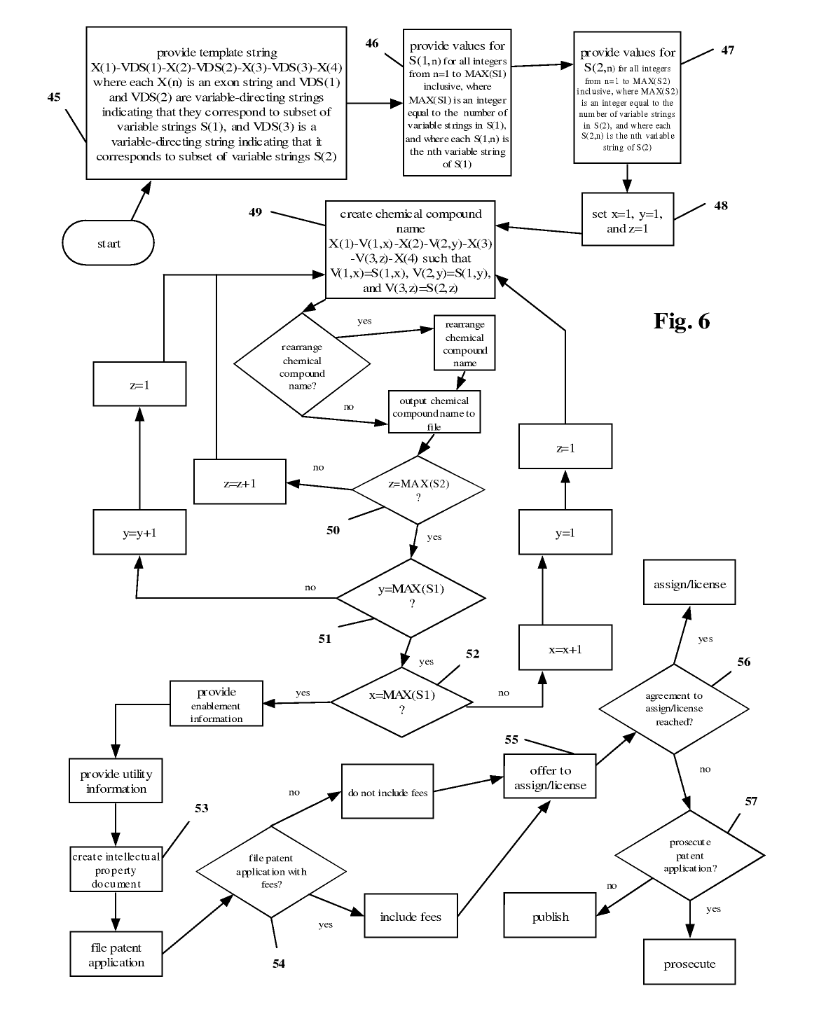

FIG. 6 is a flowchart illustrating one embodiment of a method of creating and using intellectual property, comprising a method, using a computer program article of manufacture, of creating a file comprising chemical compound names. The example illustrated in the figure is included for demonstration purposes and is not intended to imply essential features or to impose any additional limitations on the claims. One of skill in the art will recognize that the computer program article of manufacture can be configured without undue experimentation to accommodate a variety of parameters and applications.

A template string is provided that establishes the order of variable-directing strings and exon strings (45). In this example, variable-directing strings VDS(1) and VDS(2) correspond to subset of variable strings S(1), and VDS(3) corresponds to S(2). Values are then provided for each variable string of each of the subsets of variable strings (46 and 47). The variable strings can each be fixed or the computer program article of manufacture can be configured such that a given variable string can be defined such that it does not always have the same value depending on other factors or if the variable string represents the result of a mathematical function. Variables x, y, and z are then each set to 1 (48). A chemical compound name is created such that one variable string takes the place of each one of the variable-directing strings of the template string (49), where each variable string is selected from the subset of variable strings corresponding to that variable-directing string. In this example, for each chemical compound name created, the variables x, y, and z determine which variable string from each subset of variable strings is to be incorporated into each of the chemical compound names. V(1,x) is S(1,x), the xth variable string of subset of variable strings S(1), and it takes the place of variable-directing string VDS(1). Furthermore, V(2,y) is S(1,y), the yth variable string of subset of variable strings S(1), and it takes the place of variable-directing string VDS(2). Furthermore, V(3,z) is S(2,z), the zth variable string of subset of variable strings S(2), and it takes the place of variable-directing string VDS(3). The values of MAX(S1) and MAX(S2) are defined as the number of variable strings in subset of variable strings S(1) and S(2) respectively.

A test is then performed to determine whether the chemical compound name is to be rearranged. Alternatively, the computer program article of manufacture can be configured so that the chemical compound names can be arranged in a different order from that of the template string as they are created by including instruction steps to determine the order of components of the chemical compound names. The computer program article of manufacture can be configured so that all of the chemical compound names have their components in the same order as the other chemical compound names, or such that the order varies between chemical compound names.

The chemical compound name is then output to a file. A test is then performed to determine whether z=MAX(S2) (50). If not, the value of z is increased by 1 and the process reverts to (49) to create the next chemical compound name. If yes, a test is then performed to determine whether y=MAX(S1) (51). If no, the value of y is increased by 1 and the value of z is set to 1 and the process reverts to (49) to create the next chemical compound name. If yes, a test is then performed to determine whether x=MAX(S1) (52). If no, the value of x is increased by 1, and the value of y and z are each set to 1 and the process reverts to (49) to create the next chemical compound name. If yes, an intellectual property document is created by providing enablement and utility information (53). This may be accomplished in a variety of alternative ways and the intellectual property document can be completed by outputting the chemical compound names to a file comprising the other necessary information. After output to the file, one or more of the chemical compound names can optionally be removed before filing of the patent application. A decision is then made whether to file the patent application with or without fees (54). The patent application can then be offered for assignment or license (55). If an agreement to license or assign is reached (56), the patent application is licensed or assigned as appropriate. If not, a decision is made whether to prosecute or publish the patent application (57) assuming it has not already published.

### DETAILED DESCRIPTION OF THE ELEMENTS

The present invention is directed to a method and computer program that can be used to add value to intellectual property, strengthen intellectual property, lower the cost of obtaining intellectual property, or provide strategies for obtaining and using intellectual property.

In one embodiment, the invention is directed to a business method; the method includes creating intellectual property; the method of creating the intellectual property includes using a computer to create a group of chemical compound names; the group of chemical compound names includes several chemical compound names; the chemical compound names are created by combining phrases.

In one embodiment, the invention is directed to a method, using a computer, of creating a set of descriptions containing one or more descriptions; the set of descriptions is created starting with a group of segments; the group of segments contains two or more segments; each segment corresponds to a set of phrases, and each set of phrases contains one or more phrases; each description is created by joining one phrase for each segment from the set of phrases corresponding to that segment.

In one embodiment, the invention is directed to a method, in a data processing system comprising one or more CPUs, of creating a set of data objects, wherein said set of data objects comprises one or more data objects, comprising the steps of:

providing data-object-creation data, wherein said data-object-creation data comprises a set of variable strings, wherein the set of variable strings comprises one or more subsets of variable strings, and wherein each subset of variable strings of the set of variable strings comprises one or more variable strings, and

creating each of the data objects of the set of data objects, using the data-object-creation data, such that each of the data objects of the set of data objects comprises one or more variable strings of the set of variable strings.

In another embodiment, each of the variable strings of the set of variable strings comprises more than one letter. In another embodiment, one or more of the variable strings of the set of variable strings each comprise more than one letter. In another embodiment, each variable string of the set of variable strings is other than a single character representing one of the letters selected from a, t, g, c, and u. In another embodiment, each of one or more variable strings of the set of variable strings are other than a single character representing one of the letters selected from a, t, g, c, and u. In another embodiment, each of the variable strings of the set of variable strings comprises other than a single letter. In another embodiment, one or more of the variable strings of the set of variable strings each comprise more than one letter. In another embodiment, one or more of the variable strings of the set of variable strings represent other than a nucleic acid moiety. In another embodiment, one or more of the variable strings of the set of variable strings represent other than an amino acid moiety. In another embodiment, one or more of the variable strings of the set of variable strings represent other than a carbohydrate moiety.

In another embodiment, the data-object-creation data resides in computer memory. In another embodiment, the method comprises altering the physical composition of the data processing system. In another embodiment, one or more variable strings of the set of variable strings are the products of functions. In another embodiment, one or more variable strings of the set of variable strings are the products of functions in a spreadsheet. In another embodiment, one or more variable strings of the set of variable strings occupy cells in a spreadsheet. In another embodiment, one or more variable strings of the set of variable strings represent molecular weights.

In another embodiment, at least one of the data objects of the set of data objects comprises text.

In a further embodiment, each data object of the set of data objects comprises text.

In another embodiment, at least one of the data objects of the set of data objects comprises graphics.

In a further embodiment, each data object of the set of data objects comprises graphics.

In a further further embodiment, such graphics represent chemical structure.

In another embodiment, at least one of the data objects of the set of data objects comprises text and graphics.

In a further embodiment, each data object of the set of data objects comprises text and graphics.

In a further further embodiment, such graphics represent chemical structure.

In another embodiment, the method further comprises the step, performed in a data processing system comprising one or more CPUs, of: outputting one or more of the data objects of the set of data objects to a table.

In another embodiment, the invention is directed to a table comprising one or more of the data objects of the set of data objects.

In a further embodiment, said table comprises each data object of the set of data objects. In another further embodiment, said table comprises one or more of the data objects of the set of data objects such that each data object of the data objects comprised within the table is arranged in a different row of the table, and each variable string of each such data object is arranged in a different column in the row corresponding to that data object. In another further embodiment, said table comprises one or more of the data objects of the set of data objects such that each data object of the data objects comprised within the table is arranged in a different column of the table, and each variable string of each such data object is arranged in a different row in the column corresponding to that data object. In another further embodiment, said table comprises one or more items of graphics representing chemical structure. In another further embodiment, said table comprises one or more textual representations of chemical structure. In another further embodiment, the table resides in computer memory.

In another embodiment, the method further comprises the step, performed in a data processing system comprising one or more CPUs, of: outputting one or more data objects of the set of data objects to a document.

In a further embodiment, the order of components of one or more of the data objects so output to the document differs from the order of components of the corresponding data objects as-created. In another further embodiment, the order of components of the data objects so output to the document is the same as the order of components of the corresponding data objects as-created.

In another embodiment, the invention is directed to a document comprising one or more data objects of the set of data objects.

In a further embodiment, said document comprises each data object of the set of data objects. In another further embodiment, said document is published. In another further embodiment, said document is unpublished. In another further embodiment, said document is a printed document.

In another further embodiment, said document is an electronic document.

In a further further embodiment, the invention is directed to a method of creating a printed document, performed in a data processing system comprising one or more CPUs, comprising: providing the electronic document; and printing the electronic document using computer instructions to direct the physical process of printing the electronic document using a printer.

In another further embodiment, said document resides in computer memory. In another further embodiment, the invention is directed to computer storage media in which is stored said document.

In another further embodiment, the document is stored in a computer data base.

In a further further embodiment, the invention is directed to said computer data base.

In another further embodiment, the document is available via the internet.

In a further further embodiment, the document is a printed document available via the internet. In another further further embodiment, the document is an electronic document available via the internet. In another further further embodiment, the document is available over the internet using a password.

In another embodiment, the invention is directed to intellectual property comprising one or more data objects of the set of data objects.

In a further embodiment, the intellectual property is a patent application.

In a further further embodiment, the patent application is an unfiled patent application. In another further further embodiment, the patent application is a filed patent application. In another further further embodiment, the patent application is a provisional application. In another further further embodiment, the patent application is a non-provisional application. In another further further embodiment, the patent application is a statutory invention registration application.

In another further embodiment, the intellectual property is a patent. In another further embodiment, the intellectual property is a statutory invention registration. In another further embodiment, the intellectual property is a trade secret. In another further embodiment, the intellectual property is licensed intellectual property. In another further embodiment, the intellectual property is enforced. In another further embodiment, the one or more data objects of the set of data objects comprised within the intellectual property represent inventive embodiments, and the intellectual property further comprises information regarding the enablement and utility of one or more of such inventive embodiments.

In another further embodiment, the one or more data objects of the set of data objects comprised within the intellectual property represent inventive embodiments, and the intellectual property further comprises information regarding enabling one of skill in the relevant art to make one or more of such inventive embodiments.

In a further further embodiment, said intellectual property is offered for license or assignment. In another further further embodiment, the intellectual property is enforced. In another further further embodiment, said intellectual property is a filed, unpublished patent application that is offered for license or assignment. In another further further embodiment, said intellectual property is a trade secret that is offered for license.

In another further further embodiment, one or more of the inventive embodiments are chemical compound names, and the intellectual property is a patent application comprising the chemical compound names, and one or more incorporations by reference to a previously-published reference.

In a further further further embodiment, the previously-published reference is a published patent application. In another further further further embodiment, the previously-published reference is an issued patent.

In another further further embodiment, one or more of the inventive embodiments are chemical compound names, wherein each of the chemical compound names represents a chemical compound, and wherein one or more of said chemical compounds represented by the chemical compound names are encompassed by a prior art genus of chemical compounds.

In a further further further embodiment, the prior art genus of chemical compounds is represented as a Markush group.

In another further further embodiment, the intellectual property is a blocking patent.

In a further further further embodiment, one or more of the inventive embodiments of the blocking patent are chemical compound names, and one or more of the chemical compound names of the blocking patent are embraced by a genus disclosed in a different patent or patent application.

In a further further further further embodiment, the genus is represented as a Markush group.

In another embodiment, the invention is directed to a business method, wherein said business method comprises the steps, performed by a user, of:

providing one or more of said data objects of said set of data objects, wherein one or more of the data objects so provided are inventive embodiments,

providing information related to enabling one of skill in the art to make one or more of such inventive embodiments, and

creating intellectual property using such provided data objects and information related to enabling one of skill in the art to make one or more of such inventive embodiments.

In a further embodiment, one or more of the provided data objects are chemical compound names.

In a further further embodiment, the chemical compounds represented by the chemical compound names are other than DNA compounds. In another further further embodiment, the chemical compounds represented by the chemical compound names are other than RNA compounds. In another further further embodiment, the chemical compounds represented by the chemical compound names are other than compounds having one or more mononucleotide moieties. In another further further embodiment, the chemical compounds represented by the chemical compound names are other than compounds having two or more mononucleotide moieties.

In another further further embodiment, the chemical compounds represented by the chemical compound names are other than polypeptides. In another further further embodiment, the chemical compounds represented by the chemical compound names are other than compounds having one or more peptide-linked amino acid moieties. In another further further embodiment, the chemical compounds represented by the chemical compound names are other than compounds having two or more peptide-linked amino acid moieties. In another further further embodiment, the chemical compounds represented by the chemical compound names are other than enzymes.

In another further further embodiment, the chemical compounds represented by the chemical compound names are other than sugars. In another further further embodiment, the chemical compounds represented by the chemical compound names are other than carbohydrates. In another further further embodiment, the chemical compounds represented by the chemical compound names are other than polysaccharides. In another further further embodiment, the chemical compounds represented by the chemical compound names are other than compounds having one or more monosaccharide moieties. In another further further embodiment, the chemical compounds represented by the chemical compound names are other than compounds having two or more glycoside-bond-linked monosaccharide moieties.

In another further further embodiment, the chemical compounds represented by the chemical compound names are other than polymers. In another further further embodiment, the chemical compounds represented by the chemical compound names are other than dendrimers.

In another further further embodiment, the chemical compounds represented by the chemical compound names are other than chemical compounds containing a sequence of subunits.

In a further further further embodiment, the sequence of subunits is linear, and each internal subunit comprises a first site of attachment to a first adjacent subunit, and a second site of attachment to a second adjacent subunit. In a further further further embodiment, each of the subunits is one of twenty possible subunits. In a further further further embodiment, each of the subunits is one of four possible subunits. In a further further further embodiment, each of the subunits is one of two or more possible subunits. In a further further further embodiment, each of the subunits is one of ten or more possible subunits. In a further further further embodiment, each of the subunits is one of twenty or more possible subunits. In a further further further embodiment, the sequence of subunits is branched.

In another further embodiment, the intellectual property comprises information regarding the utility of the inventive embodiments.

In a further further embodiment, the inventive embodiments represent chemical compound names.

In another further embodiment, the business method comprises the step, performed by a user, of licensing the intellectual property.

In a further further embodiment, the invention is directed to said license.

In another further embodiment, the business method comprises the step, performed by a user, of enforcing the intellectual property.

In a further further embodiment, the invention is directed to a settlement or award resulting from enforcing the intellectual property.

In another further embodiment, the business method comprises the step, performed by a user, of assigning the intellectual property.

In a further further embodiment, the invention is directed to revenue realized from assigning the intellectual property.

In another further embodiment, the business method has the improvement of producing intellectual property comprising a large number of inventive embodiments in less time than by previous methods. In another further embodiment, the business method has the improvement of producing intellectual property comprising a large number of inventive embodiments at lower cost than by previous methods.

In a further further embodiment, the inventive embodiments fall within the scope of a genus disclosed within the intellectual property.

In a further further further embodiment, the genus is represented as a Markush group.

In another embodiment, the invention is directed to a business method, wherein said business method comprises the steps, performed in a data processing system comprising one or more CPUs, of:

creating a first set of data objects using the method of creating a set of data objects, such that the first set of data objects is a set of chemical-compound-name data objects, wherein said set of chemical-compound-name data objects comprises one or more chemical-compound-name data objects, and wherein each chemical-compound-name data object is a chemical compound name, wherein each chemical compound name represents a chemical compound; and

creating a second set of data objects using the method of creating a set of data objects, such that the second set of data objects is a set of chemical-compound-preparation data objects, wherein said set of chemical-compound-preparation data objects comprises one or more chemical-compound-preparation data objects, and wherein each chemical-compound-preparation data object is a chemical compound preparation, wherein one or more of the chemical compound preparations comprise information regarding the preparation of one or more of the chemical compounds represented by the chemical-compound-name data objects; and comprising the step, performed by a user, of:

creating intellectual property using one or more of the chemical compound names and one or more of the chemical compound preparations.

In a further embodiment, the intellectual property is licensed. In another further embodiment, the intellectual property is assigned. In another further embodiment, the intellectual property is a patent. In another further embodiment, the intellectual property is a statutory invention registration. In another further embodiment, the intellectual property is a patent application. In another further embodiment, the intellectual property is a trade secret. In another further embodiment, the business method has the improvement of producing intellectual property comprising a large number of chemical compound names and chemical compound preparations in less time than by previous methods. In another further embodiment, the business method has the improvement of producing intellectual property comprising a large number of chemical compound names and chemical compound preparations at lower cost than by previous methods.

In another further embodiment, the chemical compounds represented by the chemical compound names are other than DNA compounds. In another further embodiment, the chemical compounds represented by the chemical compound names are other than RNA compounds. In another further embodiment, the chemical compounds represented by the chemical compound names are other than compounds having one or more mononucleotide moieties. In another further embodiment, the chemical compounds represented by the chemical compound names are other than compounds having two or more mononucleotide moieties.

In another further embodiment, the chemical compounds represented by the chemical compound names are other than polypeptides. In another further embodiment, the chemical compounds represented by the chemical compound names are other than compounds having one or more peptide-linked amino acid moieties. In another further embodiment, the chemical compounds represented by the chemical compound names are other than compounds having two or more peptide-linked amino acid moieties. In another further embodiment, the chemical compounds represented by the chemical compound names are other than enzymes.

In another further embodiment, the chemical compounds represented by the chemical compound names are other than sugars. In another further embodiment, the chemical compounds represented by the chemical compound names are other than carbohydrates. In another further embodiment, the chemical compounds represented by the chemical compound names are other than polysaccharides. In another further embodiment, the chemical compounds represented by the chemical compound names are other than compounds having one or more monosaccharide moieties. In another further embodiment, the chemical compounds represented by the chemical compound names are other than compounds having two or more glycoside-bond-linked monosaccharide moieties.

In another further embodiment, the chemical compounds represented by the chemical compound names are other than polymers. In another further embodiment, the chemical compounds represented by the chemical compound names are other than dendrimers.

In another further embodiment, the chemical compounds represented by the chemical compound names are other than chemical compounds containing a sequence of subunits.

In a further further embodiment, the sequence of subunits is linear, and each internal subunit comprises a first site of attachment to a first adjacent subunit, and a second site of attachment to a second adjacent subunit. In a further further embodiment, each of the subunits is one of twenty possible subunits. In a further further embodiment, each of the subunits is one of four possible subunits. In a further further embodiment, each of the subunits is one of two or more possible subunits. In a further further embodiment, each of the subunits is one of ten or more possible subunits. In a further further embodiment, each of the subunits is one of twenty or more possible subunits. In a further further embodiment, the sequence of subunits is branched.

In another further embodiment, the business method comprises the step, performed by a user, of licensing the intellectual property.

In a further further embodiment, the invention is directed to said license.

In another further embodiment, the business method comprises the step, performed by a user, of enforcing the intellectual property.

In a further further embodiment, the invention is directed to a settlement or award resulting from enforcing the intellectual property.

In another further embodiment, the business method comprises the step, performed by a user, of assigning the intellectual property.

In a further further embodiment, the invention is directed to revenue realized from assigning the intellectual property.

In another embodiment, the invention is directed to a business method, wherein said business method comprises the steps, performed by a user, of:

providing one or more of the data objects of said set of data objects, wherein one or more of the data objects so provided are chemical compound names, wherein each of the chemical compound names represents a chemical compound, and

providing enablement information, wherein said enablement information is information related to enabling one of skill in the art to make one or more of such chemical compounds.

In a further embodiment, the chemical compounds represented by the chemical compound names are other than DNA compounds. In another further embodiment, the chemical compounds represented by the chemical compound names are other than RNA compounds. In another further embodiment, the chemical compounds represented by the chemical compound names are other than compounds having one or more mononucleotide moieties. In another further embodiment, the chemical compounds represented by the chemical compound names are other than compounds having two or more mononucleotide moieties.

In another further embodiment, the chemical compounds represented by the chemical compound names are other than polypeptides. In another further embodiment, the chemical compounds represented by the chemical compound names are other than compounds having one or more peptide-linked amino acid moieties. In another further embodiment, the chemical compounds represented by the chemical compound names are other than compounds having two or more peptide-linked amino acid moieties. In another further embodiment, the chemical compounds represented by the chemical compound names are other than enzymes.

In another further embodiment, the chemical compounds represented by the chemical compound names are other than sugars. In another further embodiment, the chemical compounds represented by the chemical compound names are other than carbohydrates. In another further embodiment, the chemical compounds represented by the chemical compound names are other than polysaccharides. In another further embodiment, the chemical compounds represented by the chemical compound names are other than compounds having one or more monosaccharide moieties. In another further embodiment, the chemical compounds represented by the chemical compound names are other than compounds having two or more glycoside-bond-linked monosaccharide moieties.

In another further embodiment, the chemical compounds represented by the chemical compound names are other than polymers. In another further embodiment, the chemical compounds represented by the chemical compound names are other than dendrimers.

In another further embodiment, the chemical compounds represented by the chemical compound names are other than chemical compounds containing a sequence of subunits.

In a further further embodiment, the sequence of subunits is linear, and each internal subunit comprises a first site of attachment to a first adjacent subunit, and a second site of attachment to a second adjacent subunit. In a further further embodiment, each of the subunits is one of twenty possible subunits. In a further further embodiment, each of the subunits is one of four possible subunits. In a further further embodiment, each of the subunits is one of two or more possible subunits. In a further further embodiment, each of the subunits is one of ten or more possible subunits. In a further further embodiment, each of the subunits is one of twenty or more possible subunits. In a further further embodiment, the sequence of subunits is branched.

In another further embodiment, the enablement information comprises one or more references. In another further embodiment, the enablement information comprises one or more chemical compound preparations. In another further embodiment, the enablement information is provided by the chemical compound names, such that one of skill in the art is able to make the chemical compounds without undue experimentation given the chemical compound names.

In another further embodiment, the business method comprises the step, performed by a user, of licensing the intellectual property.

In a further further embodiment, the invention is directed to said license.

In another further embodiment, the business method comprises the step, performed by a user, of enforcing the intellectual property.

In a further further embodiment, the invention is directed to a settlement or award resulting from enforcing the intellectual property.

In another further embodiment, the business method comprises the step, performed by a user, of assigning the intellectual property.

In a further further embodiment, the invention is directed to revenue realized from assigning the intellectual property.

In another further embodiment, the business method has the improvement of producing intellectual property comprising a large number of chemical compound names at lower cost and in less time than by previous methods.

In another further embodiment, the business method comprises the step, performed by a user, of providing utility information, where said utility information is used to establish the utility of one or more of the chemical compounds.

In a further further embodiment, one or more of the chemical compounds are structurally related to a biologically active chemical compound, and the utility information comprises information related to the utility of the biologically active chemical compound.

In a further further further embodiment, one or more of the chemical compounds and the biologically active chemical compound share a common utility.

In another further further embodiment, the utility information comprises information regarding two or more utilities.

In another further further embodiment, one or more of the chemical compounds have utility as a pharmaceutical and as a compound that is able to absorb ultraviolet light.

In a further further further embodiment, one or more of the chemical compounds have utility as an ultraviolet light absorbing dye.

In another further embodiment, the business method further comprises the step, performed by a user, of providing a file, wherein the file comprises the chemical compound names so provided and the enablement information. In another further embodiment, the number of data objects in the set of data objects is equal to or greater than one hundred. In another further embodiment, the number of data objects in the set of data objects is equal to or greater than one thousand. In another further embodiment, the number of data objects in the set of data objects is equal to or greater than one hundred thousand.

In another further embodiment, the business method further comprises the steps, performed by a user, of:

providing the structure of a biologically active chemical compound,

analyzing the structure of said biologically active chemical compound in order to postulate a genus of structurally related target chemical compounds, such that the names of each of the structurally related target chemical compounds of such genus each share one or more common chemical compound name fragments, and

analyzing the genus of structurally related target chemical compounds in order to select variable strings which are able to be used to create the chemical compound names, such that each chemical compound name represents one of the names of a structurally related target chemical compound embraced by the genus of structurally related target chemical compounds.

In a further further embodiment, the genus is represented as a Markush group. In another further further embodiment, the genus of structurally related chemical compounds does not embrace the biologically active chemical compound. In another further further embodiment, the genus of structurally related chemical compounds embraces the biologically active chemical compound. In another further further embodiment, the biologically active compound is a drug compound. In another further further embodiment, the biologically active chemical compound is a patented chemical compound.

In another further further embodiment, the business method further comprises the step, performed by a user, of analyzing the structure of said biologically active chemical compound, wherein said biologically active chemical compound is a patented pharmaceutical compound, in order to postulate the genus of structurally related target chemical compounds, such that one or more of the structurally related target chemical compounds of said genus are embraced by a patented genus of chemical compounds.

In a further further further embodiment, the business method comprises the steps, performed by a user, of: creating intellectual property using the chemical compound names and the enablement information; and offering the intellectual property for license or assignment to one or more licensees or assignees of one or more patents covering said patented pharmaceutical compound.

In a further further further further embodiment, the business method comprises the step, performed by a user, of publishing the intellectual property.

In another further embodiment, the business method comprises the step, performed by a user, of creating intellectual property by analyzing a biologically active chemical compound in order to create the data-object-creation data, such that said data-object-creation data is able to be used to create chemical compound names representing chemical compounds that are structurally similar to the biologically active chemical compound.

In a further further embodiment, the intellectual property is created inexpensively.

In a further further further embodiment, the cost of creating the intellectual property is less than one quarter of the revenue generated by the intellectual property. In another further further further embodiment, the cost of creating the intellectual property is less than five percent of the revenue generated by the intellectual property.

In another further further embodiment, the business method comprises the step, performed by a user, of providing utility information, where said utility information is used to establish the utility of one or more of the chemical compounds.

In a further further further embodiment, the utility information comprises information related to the utility of the biologically active chemical compound.

In another further further embodiment, the intellectual property comprises chemical compound species embraced by a chemical compound genus claimed in a competing patent or competing patent application.

In a further further further embodiment, the genus is represented as a Markush group. In another further further further embodiment, the intellectual property is an unfiled patent application. In another further further further embodiment, the intellectual property is a patent or patent application. In another further further further embodiment, the intellectual property is a statutory invention registration. In another further further further embodiment, the intellectual property is a trade secret.

In another further further embodiment, the intellectual property is blocking intellectual property, and the biologically active chemical compound is a prior-art chemical compound, and the business method further comprises the step, performed by a user, of offering to assign or license the blocking intellectual property; wherein the chemical compound names of the blocking intellectual property are chemical compound names of compounds structurally related to the prior-art chemical compound.

In a further further further embodiment, the business method comprises the step, performed by a user, of publishing the intellectual property.

In another embodiment, the set of data objects comprises more than twenty-five data objects. In another embodiment, the set of data objects comprises more than one hundred data objects. In another embodiment, the set of data objects comprises more than two hundred and fifty data objects. In another embodiment, the set of data objects comprises more than one thousand data objects. In another embodiment, the set of data objects comprises more than ten thousand data objects. In another embodiment, the set of data objects comprises more than fifty thousand data objects. In another embodiment, the set of data objects comprises more than one hundred thousand data objects. In another embodiment, the set of data objects comprises more than one million data objects. In another embodiment, the set of data objects comprises more than ten million data objects. In another embodiment, the set of data objects comprises more than one billion data objects. In another embodiment, the number of data objects in the set of data objects is greater than or equal to twenty-five and less than one hundred. In another embodiment, the number of data objects in the set of data objects is greater than or equal to one hundred and less than five hundred. In another embodiment, the number of data objects in the set of data objects is greater than or equal to five hundred and less than one thousand. In another embodiment, the number of data objects in the set of data objects is greater than or equal to one thousand and less than ten thousand. In another embodiment, the number of data objects in the set of data objects is greater than or equal to ten thousand and less than one hundred thousand. In another embodiment, the number of data objects in the set of data objects is greater than or equal to one hundred thousand and less than one million. In another embodiment, the number of data objects in the set of data objects is greater than or equal to one million and less than one billion.

In another embodiment, the set of variable strings resides in computer memory. In another embodiment, the set of variable strings is input by a user. In another embodiment, the set of variable strings has one subset of variable strings. In another embodiment, the set of variable strings has two subsets of variable strings. In another embodiment, the set of variable strings has at least three and no more than five subsets of variable strings. In another embodiment, the set of variable strings comprises six or more subsets of variable strings. In another embodiment, one or more of the variable strings of the set of variable strings are null strings.

In another embodiment, each of the data objects of the set of data objects has the same number of variable strings.

In a further embodiment, the data objects of the set of data objects each have the same number of variable strings from each subset of variable strings as every other data object of the set of data objects.

In a further further embodiment, each of the data objects of the set of data objects has one variable string from each of two subsets of variable strings. In another further further embodiment, each of the data objects of the set of data objects has one variable string from a first subset of variable strings, one variable string from a second subset of variable strings, and two variable strings from a third subset of variable strings.

In another further further embodiment, the variable strings within each subset of variable strings are ranked within that subset, and each subset of variable strings of the set of variable strings is ranked within the set of variable strings, such that, for the purpose of ranking the subsets of variable strings, where the data objects of the set of data objects have more than one variable string from a given subset of variable strings, that subset of variable strings is considered to be a different subset of variable strings for each occurrence of a variable string from that subset of variable strings within each data object of the set of data objects; and wherein:

the data objects of the set of data objects are created using an iterative process, whereby the first data object of the set of data objects is created using the first variable string of the first-ranked subset of variable strings, and the first variable string of each other ranked subset of variable strings used in creating said first data object; and the second data object of the set of data objects is created using the second variable string of the first-ranked subset of variable strings, and the first variable strings of each of the other ranked subsets of variable strings used in creating said second data object, such that the set of data objects so created comprises data objects representing all of the possible permutations of inclusions of variable strings within said data objects.

In a further further further embodiment, each of the data objects of the set of data objects has one variable string, wherein said variable string is from a subset of variable strings having twenty variable strings, and the number of data objects in the set of data objects so created is twenty.

In another further further further embodiment, each of the data objects of the set of data objects has three variable strings, wherein one of the variable strings is from a first subset of variable strings having ten variable strings, and where the first subset of variable strings is the first-ranked subset of variable strings, and the other two variable strings are from a second subset of variable strings having five variable strings, and where the second subset of variable strings is the second-ranked and third-ranked subsets of variable strings, and the number of data objects in the set of data objects so created is two hundred and fifty.

In another further further embodiment, the variable strings within each subset of variable strings are ranked within that subset, and each subset of variable strings of the set of variable strings is ranked within the set of variable strings, such that, for the purpose of ranking the subsets of variable strings, where the data objects of the set of data objects have more than one variable string from a given subset of variable strings, that subset of variable strings is considered to be a different subset of variable strings for each occurrence of a variable string from that subset of variable strings within each data object of the set of data objects; and wherein:

the data objects of the set of data objects are created using an iterative process, whereby a first prospective data object contains the first variable string of the first-ranked subset of variable strings, and the first variable string of each other ranked subset of variable strings used in creating said first prospective data object; and a second prospective data object contains the second variable string of the first-ranked subset of variable strings, and the first variable strings of each of the other ranked subsets of variable strings used in creating said second prospective data object; and continuing said iterative process such that all of the prospective data objects together comprise prospective data objects representing all of the possible permutations of inclusions of variable strings within said prospective data objects; and wherein said method further comprises the step, performed in a data processing system comprising one or more CPUs, of:

testing each prospective data object to determine whether the combination of variable strings within that prospective data object is a valid combination of such variable strings: where if the combination of variable strings is not a valid combination of variable strings, that prospective data object is not one of the data objects of the set of data objects; and where if the combination of variable strings is a valid combination of variable strings, that prospective data object is one of the data objects of the set of data objects.

In a further further further embodiment, a prospective data object is determined to contain an invalid combination of variable strings before all of the variable strings have been assigned to that prospective data object. In another further further further embodiment, all of the prospective data objects are created before the test is performed to determine which prospective data objects have an invalid combination of variable strings. In another further further further embodiment, a prospective data object is determined to comprise an invalid combination of variable strings based on a single variable string.

In another embodiment, the set of variable strings is input by a user. In another embodiment, one or more of the variable strings are input by a user. In another embodiment, one or more of the variable strings are input by a user and one or more of the variable strings are located in a file. In another embodiment, a user selects one or more of the variable strings of the set of variable strings from a group of variable strings located in a file.

In another embodiment, the set of variable strings is located in a file.

In a further embodiment, the file is a spreadsheet.

In a further further embodiment, each subset of variable strings of the set of variable strings is organized in a separate column in the spreadsheet.

In a further further further embodiment, each variable string of each subset of variable strings is organized in a different row in the spreadsheet.

In another further embodiment, the set of variable strings is incorporated into computer software.

In a further further embodiment, the computer software comprises a set of computer instructions used in making the data objects of the set of data objects.

In another embodiment, each of the data objects of the set of data objects has one variable string from each subset of variable strings of the set of variable strings. In another embodiment, one or more of the subsets of variable strings of the set of variable strings have one variable string. In another embodiment each data object of the set of data objects is created such that the variable strings within each data object are valid variable strings for that data object, such that no data object of the set of data objects is created that has one or more variable strings that are invalid for that data object.

In another embodiment, no input from a user occurs for the duration of the process of creating each of the data objects of the set of data objects. In another embodiment, the data processing system creates each of the data objects of the set of data objects using the data-object-creation data without input from a user.

In another embodiment, the duration of the process of creating the set of data objects using the data-object-creation data is less than one second. In another embodiment, the duration of the process of creating the set of data objects is greater than or equal to one second and less than one minute. In another embodiment, the duration of the process of creating the set of data objects is greater than or equal to one minute and less than ten minutes. In another embodiment, the duration of the process of creating the set of data objects is greater than or equal to ten minutes and less than one hour. In another embodiment, the duration of the process of creating the set of data objects is greater than or equal to one hour and less than one day. In another embodiment, the duration of the process of creating the set of data objects is greater than or equal to one day.

In another embodiment, one or more of the variable strings of the set of variable strings are excluded from one or more data objects of the set of data objects.

In a further embodiment, the data-object-creation data comprises information used in determining which variable strings are to be excluded from each of the data objects of the set of data objects.

In a further further embodiment, one or more of the variable strings of the set of variable strings are excluded from one or more of the data objects of the set of data objects, but not from all of the data objects of the set of data objects.

In another further embodiment, one or more of the variable strings of one or more of the subsets of variable strings of the set of variable strings are excluded from one or more of the data objects of the set of data objects.

In another further embodiment, the data-object-creation data comprises information used in determining which variable strings are to be excluded from each of the data objects of the set of data objects.

In a further further embodiment, one or more of the variable strings of the set of variable strings are excluded from one or more of the data objects of the set of data objects, but not from all of the data objects of the set of data objects.

In another embodiment, one or more of the data objects of the set of data objects are chemical compound names.

In another embodiment, the invention is directed to a file, wherein said file comprises:

a file-set of data objects, wherein said file-set of data objects comprises one or more of the data objects of said set of data objects, and wherein one or more of the data objects of the file-set of data objects are chemical compound names, and where each of such chemical compound names represents a chemical compound;

and information related to the preparation of one or more of such chemical compounds.

In another embodiment, one or more of the data objects of the set of data objects are genera of chemical compounds.

In another embodiment, one or more of the data objects of the set of data objects are chemical compound preparations.

In another embodiment, the invention is directed to a file, wherein said file comprises a file-set of data objects, wherein the file-set of data objects comprises one or more of said data objects of the set of data objects.

In another embodiment, the invention is directed to an item of intellectual property, where said item of intellectual property comprises one or more of said data objects of the set of data objects.

In another embodiment, the invention is directed to a computer file, wherein said computer file comprises one or more of said data objects.

In another embodiment, the invention is directed to a printed document, wherein said printed document comprises one or more of said data objects of the set of data objects.

In another embodiment, the invention is directed to a method of preparing a file, comprising the steps, performed in a data processing system comprising one or more CPUs, of:

providing an initial file,

providing a file-set of data objects wherein said file-set of data objects comprises one or more of the data objects of said set of data objects, and

outputting the file-set of data objects to the initial file.

In another embodiment, the invention is directed to a method of preparing a document, comprising the steps, performed in a data processing system comprising one or more CPUs, of:

providing an initial file,

providing a file-set of data objects comprising one or more of said data objects of the set of data objects,

creating an intermediate file by outputting the file-set of data objects to the initial file, and

printing the intermediate file using a printer.

In another embodiment, the data-object-creation data comprises a set of variable-directing strings comprising one or more variable-directing strings, wherein the variable-directing strings of the set of variable-directing strings comprise information used in creating each of the data objects of the set of data objects by directing the placement of the variable strings within such data objects.

In a further embodiment, one or more of the data objects of the set of data objects are chemical compound names.

In another further embodiment, the invention is directed to a file, wherein said file comprises:

a file-set of data objects, wherein said file-set of data objects comprises one or more of the data objects of said set of data objects, and wherein one or more of the data objects of the file-set of data objects are chemical compound names, and where each of such chemical compound names represents a chemical compound;

and information related to the preparation of one or more of such chemical compounds.

In another further embodiment, one or more of the data objects of the set of data objects are genera of chemical compounds.

In another further embodiment, one or more of the data objects of the set of data objects are chemical compound preparations.

In another further embodiment, the invention is directed to a file, wherein said file comprises a file-set of data objects, wherein the file-set of data objects comprises one or more of said data objects of the set of data objects.

In another further embodiment, the invention is directed to an item of intellectual property, where said item of intellectual property comprises one or more of said data objects of the set of data objects.

In another further embodiment, the invention is directed to a computer file, wherein said computer file comprises one or more of said data objects.

In another further embodiment, the invention is directed to a printed document, wherein said printed document comprises one or more of said data objects of the set of data objects.

In another further embodiment, the invention is directed to a method of preparing a file, comprising the steps, performed in a data processing system comprising one or more CPUs, of:

providing an initial file,

providing a file-set of data objects wherein said file-set of data objects comprises one or more of the data objects of said set of data objects, and

outputting the file-set of data objects to the initial file.

In another further embodiment, the invention is directed to a method of preparing a document, comprising the steps, performed in a data processing system comprising one or more CPUs, of:

providing an initial file,

providing a file-set of data objects comprising one or more of said data objects of the set of data objects,

creating an intermediate file by outputting the file-set of data objects to the initial file, and

printing the intermediate file using a printer.

In another embodiment, the data-object-creation data comprises a template string, wherein said template string comprises a set of variable-directing strings, wherein said set of variable-directing strings comprises one or more variable-directing strings, and wherein said template string further comprises a set of exon strings, wherein the set of exon strings comprises one or more exon strings,

wherein each of the subsets of variable strings corresponds to one or more variable-directing strings of the set of variable-directing strings, such that each variable-directing string of the set of variable-directing strings has a corresponding subset of variable strings of the set of variable strings,

wherein the template string is used in the creation of each of the data objects of the set of data objects such that:

each of the data objects of the set of data objects comprises: every one of the exon strings of the set of exon strings; and one variable string of the corresponding subset of variable strings for each variable-directing string of the set of variable-directing strings;

wherein each of the variable-directing strings corresponds to a different variable-string locus within the data objects of the set of data objects, such that the number of variable-string loci within each of the data objects of the set of data objects is equal to the number of variable-directing strings of the set of variable-directing strings,

wherein each of the variable-string loci corresponds to the subset of variable strings that corresponds to that variable-string locus' variable-directing string,

and each of the variable-directing strings of the set of variable-directing strings is used to direct the placement of one of the variable strings from the corresponding subset of variable strings, at the variable-string locus corresponding to that variable-directing string, within each of the data objects of the set of data objects;

such that the set of data objects so created comprises all of the data objects representing all of the permutations of placements, at each of the variable-string loci, of each of the variable strings of the subset of variable strings corresponding to that variable-string locus.

In a further embodiment, one or more of the data objects of the set of data objects are chemical compound names.

In another further embodiment, the invention is directed to a file, wherein said file comprises:

a file-set of data objects, wherein said file-set of data objects comprises one or more of said data objects of the set of data objects, and wherein one or more of the data objects of the file-set of data objects are chemical compound names, and where each of such chemical compound names represents a chemical compound;

and information related to the preparation of one or more of such chemical compounds.

In another further embodiment, one or more of the data objects of the set of data objects are genera of chemical compounds.

In another further embodiment, one or more of the data objects of the set of data objects are chemical compound preparations.

In another further embodiment, the invention is directed to a file, wherein said file comprises a file-set of data objects, wherein the file-set of data objects comprises one or more of said data objects of the set of data objects.

In another further embodiment, the invention is directed to an item of intellectual property, where said item of intellectual property comprises one or more of said data objects of the set of data objects.

In another further embodiment, the invention is directed to a computer file, wherein said computer file comprises one or more of said data objects.

In another further embodiment, the invention is directed to a printed document, wherein said printed document comprises one or more of said data objects of the set of data objects.

In another further embodiment, the invention is directed to a method of preparing a file, comprising the steps, performed in a data processing system comprising one or more CPUs, of:

providing an initial file,

providing a file-set of data objects wherein said file-set of data objects comprises one or more of said data objects of the set of data objects, and

outputting the file-set of data objects to the initial file.

In another further embodiment, the invention is directed to a method of preparing a document, comprising the steps, performed in a data processing system comprising one or more CPUs, of:

providing an initial file,

providing a file-set of data objects comprising one or more of said data objects of the set of data objects,

creating an intermediate file by outputting the file-set of data objects to the initial file, and

printing the intermediate file using a printer.

In one embodiment, the invention is directed to a method, in a data processing system comprising one or more CPUs, of creating a set of chemical compound names comprising one or more chemical compound names, wherein each chemical compound name represents a chemical compound, comprising the steps of:

providing a template string comprising a set of variable-directing strings, wherein such set of variable-directing strings comprises one or more variable-directing strings, wherein each of such variable-directing strings comprises information,

providing a set of variable strings comprising one or more variable strings, and

creating each of the chemical compound names of the set of chemical compound names, using the template string as a template, by using the information contained within each of the variable-directing strings of the set of variable-directing strings of the template string to direct the replacement of that variable-directing string with one of the variable strings of the set of variable strings.

In another embodiment, each of the variable strings of the set of variable strings comprises more than one letter. In another embodiment, one or more of the variable strings of the set of variable strings each comprise more than one letter. In another embodiment, each variable string of the set of variable strings is other than a single character representing one of the letters selected from a, t, g, c, and u. In another embodiment, each of one or more variable strings of the set of variable strings are other than a single character representing one of the letters selected from a, t, g, c, and u. In another embodiment, each of the variable strings of the set of variable strings comprises other than a single letter. In another embodiment, one or more of the variable strings of the set of variable strings each comprise more than one letter. In another embodiment, one or more of the variable strings of the set of variable strings represent other than a nucleic acid moiety. In another embodiment, one or more of the variable strings of the set of variable strings represent other than an amino acid moiety. In another embodiment, one or more of the variable strings of the set of variable strings represent other than a carbohydrate moiety.

In another embodiment, the set of variable strings comprises one or more subsets of variable strings, wherein each of the subsets of variable strings of the set of variable strings comprises one or more variable strings; such that each of the subsets of variable strings of the set of variable strings corresponds to one or more variable-directing strings of the set of variable-directing strings, and such that each variable-directing string of the set of variable-directing strings has a corresponding subset of variable strings of the set of variable strings, and

wherein each chemical compound name of the set of chemical compound names is created, using the template string as a template, by replacing each of the variable-directing strings in the template string with one of the variable strings of the subset of variable strings corresponding to that variable-directing string, such that the set of chemical compound names so created comprises all of the chemical compound names representing all of the permutations of replacements of each of the variable-directing strings of the set of variable-directing strings of the template string with one of the variable strings of the subset of variable strings corresponding to that variable-directing string.

In one embodiment, the invention is directed to a method, in a data processing system comprising one or more CPUs, of creating a set of chemical compound preparations comprising one or more chemical compound preparations, wherein each such chemical compound preparation comprises information pertaining to a procedure for synthesizing a chemical compound, wherein the information of the chemical compound preparations of the set of chemical compound preparations pertains to either: preparations of the same chemical compound, or to preparations of two or more different chemical compounds; comprising:

providing a template string, wherein the template string comprises characters that are common to all of the chemical compound preparations of the set of chemical compound preparations, and wherein said template string further comprises a set of variable-directing strings comprising one or more variable-directing strings,

providing a set of variable strings comprising one or more subsets of variable strings, wherein each of such subsets of variable strings comprises one or more variable strings, and wherein each of such subsets of variable strings corresponds to one or more variable-directing strings of the set of variable-directing strings, such that each variable-directing string of the set of variable-directing strings has a corresponding subset of variable strings of the set of variable strings,

wherein each chemical compound preparation of the set of chemical compound preparations is created, using the template string as a template, by replacing each of the variable-directing strings of the set of variable-directing strings of the template string with one of the variable strings of the subset of variable strings corresponding to that variable-directing string, such that the set of chemical compound preparations so created comprises all of the chemical compound preparations representing all of the permutations of replacements of each of the variable-directing strings of the set of variable-directing strings in the template string with one of the variable strings of the subset of variable strings corresponding to that variable-directing string.

In another embodiment, each of the variable strings of the set of variable strings comprises more than one letter. In another embodiment, one or more of the variable strings of the set of variable strings each comprise more than one letter. In another embodiment, each variable string of the set of variable strings is other than a single character representing one of the letters selected from a, t, g, c, and u. In another embodiment, each of one or more variable strings of the set of variable strings are other than a single character representing one of the letters selected from a, t, g, c, and u. In another embodiment, each of the variable strings of the set of variable strings comprises other than a single letter. In another embodiment, one or more of the variable strings of the set of variable strings each comprise more than one letter. In another embodiment, one or more of the variable strings of the set of variable strings represent other than a nucleic acid moiety. In another embodiment, one or more of the variable strings of the set of variable strings represent other than an amino acid moiety. In another embodiment, one or more of the variable strings of the set of variable strings represent other than a carbohydrate moiety.

In one embodiment, the invention is directed to a business method for acquiring intellectual property comprising the steps, performed in a data processing system comprising one or more CPUs, of:

providing a set of chemical data, wherein the set of chemical data comprises one or more items of chemical data,

using the set of chemical data to create a set of chemical information, wherein said set of chemical information comprises one or more items of chemical information; and

outputting one or more items of chemical information of the set of chemical data to a file.

In another embodiment, the order of components of one or more of the items of chemical information so output to the file differs from the order of components of the corresponding items of chemical information as-created. In another further embodiment, the order of components of the items of chemical information so output to the file is the same as the order of components of the corresponding items of chemical information as-created.

In another embodiment, the business method comprises the step, performed by a user, of licensing the intellectual property.

In a further embodiment, the invention is directed to said license.

In another embodiment, the business method comprises the step, performed by a user, of enforcing the intellectual property.

In a further embodiment, the invention is directed to a settlement or award resulting from enforcing the intellectual property.

In another embodiment, the business method comprises the step, performed by a user, of assigning the intellectual property.

In a further embodiment, the invention is directed to revenue realized from assigning the intellectual property.

In another embodiment, one or more of the items of chemical information of the set of chemical information are chemical compound names, wherein such chemical compound names are comprised within a set of chemical compound names, wherein such chemical compound names represent chemical compounds, and

wherein the set of chemical data comprises a set of variable data, wherein said set of variable data comprises one or more subsets of variable data, wherein each subset of variable data of the set of variable data comprises one or more items of variable data, and

wherein one or more items of variable data from each subset of variable data of the set of variable data are comprised within each one of the items of chemical information of the set of chemical information.

In a further embodiment, the set of chemical data comprises a set of common-chemical-name segments, wherein the set of common-chemical-name segments comprises one or more common-chemical-name segments, and wherein each one of the common-chemical-name segments of the set of common-chemical-name segments is comprised within each one of the chemical compound names of the set of chemical compound names;

wherein the set of common-chemical-name segments corresponds to a set of common chemical fragments, wherein the set of common chemical fragments comprises one or more common chemical fragments, and wherein each one of the common-chemical-name segments of the set of common-chemical-name segments corresponds to a different common chemical fragment of the set of common chemical fragments, and wherein each one of the common chemical fragments is present within the structure of each one of the chemical compounds of the set of chemical compounds; and wherein

each of the subsets of variable data comprises two or more items of variable data, and wherein one of the items of variable data of each one of the subsets of variable data is comprised within each one of the chemical compound names of the set of chemical compound names,

wherein the set of variable data corresponds to a set of variable-chemical loci, wherein the set of variable-chemical loci comprises one or more variable-chemical locus, and wherein each one of the subsets of variable data of the set of variable data corresponds to a different variable-chemical locus of the set of variable-chemical loci,

wherein each one of the variable-chemical loci of the set of variable-chemical loci corresponds to a structure-feature of the chemical compounds of the set of chemical compounds that varies between two or more chemical compounds of the set of chemical compounds, and

wherein each one of the variable data of a given subset of variable data corresponds to a valid variant for the structure-feature corresponding to the variable-chemical locus corresponding to that subset of variable data.

In another further embodiment, the business method further comprises the steps, performed by a user, of

identifying a group of chemical compounds of interest, wherein said group of chemical compounds of interest comprises one or more chemical compounds of interest,

formulating a genus of structurally related target chemical compounds, wherein said genus of structurally related target chemical compounds encompasses two or more structurally related target chemical compounds, and wherein said genus of structurally related target chemical compounds is formulated by analyzing the group of chemical compounds of interest and considering factors including utility, structural analogs, and availability of synthetic methods for preparing the structurally related target chemical compounds of the genus of structurally related target chemical compounds,

formulating the set of chemical data such that the set of chemical compound names created using the set of chemical data comprises the names of two or more structurally related target chemical compounds of the set of structurally related target chemical compounds,

formulating chemical synthesis information, wherein the chemical synthesis information comprises information pertaining to one or more methods for preparing one or more of the structurally related target chemical compounds named within the set of chemical compound names, and

outputting the chemical synthesis information to the file.

In a further further embodiment, the genus is represented as a Markush group.

In another further embodiment, the business method further comprises the steps, performed by a user, of:

identifying a biologically active chemical compound,

identifying a substructure of the biologically active chemical compound, wherein such substructure has one or more variation sites, wherein each one of the variation sites of such substructure represents a different one of the sites in the substructure of the biologically active chemical compound that varies from the structure of the biologically active chemical compound,

creating the set of chemical data, such that each one of the subsets of variable data corresponds to one or more variation sites, and wherein each one of the variation sites corresponds to one subset of variable data, and wherein the set of chemical compound names is a set of names of analogs of the biologically active chemical compound, wherein each chemical compound name is a name of an analog of the biologically active chemical compound, such that each one of the names of analogs of the biologically active chemical compound comprises one item of variable data, for each one of the variation sites, from the subset of variable data corresponding to that variation site; and wherein the method further comprises the step, performed by a user, of

including information in the file pertaining to the preparation of one or more of the compounds represented by such names of analogs of the biologically active chemical compound.

In a further further embodiment, the invention is directed to said intellectual property of said business method.

In one embodiment, the invention is directed to a method, in a data processing system comprising one or more CPUs, of creating a set of data objects, wherein said set of data objects comprises one or more data objects, comprising the steps of:

providing data-object-creation data, wherein said data-object-creation data comprises a set of variable strings, wherein the set of variable strings comprises one or more subsets of variable strings, and wherein each subset of variable strings of the set of variable strings comprises one or more variable strings, and

creating each of the data objects of the set of data objects, using the data-object-creation data, such that each of the data objects of the set of data objects comprises one or more variable strings of the set of variable strings;

wherein one or more of the data objects of the set of data objects is a chemical compound name, wherein each chemical compound name represents a chemical compound.

In another embodiment, each of the variable strings of the set of variable strings comprises more than one letter. In another embodiment, one or more of the variable strings of the set of variable strings each comprise more than one letter. In another embodiment, each variable string of the set of variable strings is other than a single character representing one of the letters selected from a, t, g, c, and u. In another embodiment, each of one or more variable strings of the set of variable strings are other than a single character representing one of the letters selected from a, t, g, c, and u. In another embodiment, each of the variable strings of the set of variable strings comprises other than a single letter. In another embodiment, one or more of the variable strings of the set of variable strings each comprise more than one letter. In another embodiment, one or more of the variable strings of the set of variable strings represent other than a nucleic acid moiety. In another embodiment, one or more of the variable strings of the set of variable strings represent other than an amino acid moiety. In another embodiment, one or more of the variable strings of the set of variable strings represent other than a carbohydrate moiety.

In another embodiment, the chemical compounds represented by the chemical compound names are other than DNA compounds. In another embodiment, the chemical compounds represented by the chemical compound names are other than RNA compounds. In another embodiment, the chemical compounds represented by the chemical compound names are other than compounds having one or more mononucleotide moieties. In another embodiment, the chemical compounds represented by the chemical compound names are other than compounds having two or more mononucleotide moieties.

In another embodiment, the chemical compounds represented by the chemical compound names are other than polypeptides. In another embodiment, the chemical compounds represented by the chemical compound names are other than compounds having one or more peptide-linked amino acid moieties. In another embodiment, the chemical compounds represented by the chemical compound names are other than compounds having two or more peptide-linked amino acid moieties. In another embodiment, the chemical compounds represented by the chemical compound names are other than enzymes.

In another embodiment, the chemical compounds represented by the chemical compound names are other than sugars. In another embodiment, the chemical compounds represented by the chemical compound names are other than carbohydrates. In another embodiment, the chemical compounds represented by the chemical compound names are other than polysaccharides. In another embodiment, the chemical compounds represented by the chemical compound names are other than compounds having one or more monosaccharide moieties. In another embodiment, the chemical compounds represented by the chemical compound names are other than compounds having two or more glycoside-bond-linked monosaccharide moieties.

In another embodiment, the chemical compounds represented by the chemical compound names are other than polymers. In another embodiment, the chemical compounds represented by the chemical compound names are other than dendrimers.

In another embodiment, the chemical compounds represented by the chemical compound names are other than chemical compounds containing a sequence of subunits.

In a further embodiment, the sequence of subunits is linear, and each internal subunit comprises a first site of attachment to a first adjacent subunit, and a second site of attachment to a second adjacent subunit. In a further embodiment, each of the subunits is one of twenty possible subunits. In a further embodiment, each of the subunits is one of four possible subunits. In a further embodiment, each of the subunits is one of two or more possible subunits. In a further embodiment, each of the subunits is one of ten or more possible subunits. In a further embodiment, each of the subunits is one of twenty or more possible subunits. In a further embodiment, the sequence of subunits is branched.

In another embodiment, the data-object-creation data resides in computer memory. In another embodiment, the method comprises altering the physical composition of the data processing system. In another embodiment, one or more variable strings of the set of variable strings are the products of functions. In another embodiment, one or more variable strings of the set of variable strings are the products of functions in a spreadsheet. In another embodiment, one or more variable strings of the set of variable strings occupy cells in a spreadsheet. In another embodiment, one or more variable strings of the set of variable strings represent molecular weights.

In another embodiment, at least one of the chemical compound names comprises text.

In a further embodiment, each chemical compound name comprises text.

In another embodiment, at least one of the chemical compound names comprises graphics.

In a further embodiment, each chemical compound name comprises graphics.

In a further further embodiment, such graphics represent chemical structure.

In another embodiment, at least one of the chemical compound names comprises text and graphics.

In a further embodiment, each chemical compound name comprises text and graphics.

In a further further embodiment, such graphics represent chemical structure.

In another embodiment, the method further comprises the step, performed in a data processing system comprising one or more CPUs, of outputting one or more of the chemical compound names to a table.

In another embodiment, the invention is directed to a table comprising one or more of the chemical compound names.

In a further embodiment, said table comprises each chemical compound name. In another further embodiment, said table comprises one or more of the chemical compound names such that chemical compound name comprised within the table is arranged in a different row of the table, and each variable string of each such chemical compound name is arranged in a different column in the row corresponding to that chemical compound name. In another further embodiment, said table comprises one or more of the chemical compound names such that each chemical compound name comprised within the table is arranged in a different column of the table, and each variable string of each such chemical compound name is arranged in a different row in the column corresponding to that chemical compound name. In another further embodiment, said table comprises one or more items of graphics representing chemical structure. In another further embodiment, said table comprises one or more textual representations of chemical structure. In another further embodiment, the table resides in computer memory.

In another embodiment, the method further comprises the step, performed in a data processing system comprising one or more CPUs, of outputting one or more chemical compound names to a document.

In a further embodiment, the order of components of one or more of the chemical compound names so output to the document differs from the order of components of the corresponding chemical compound names as-created. In another further embodiment, the order of components of the chemical compound names so output to the document is the same as the order of components of the corresponding chemical compound names as-created.

In another embodiment, the invention is directed to a document comprising one or more chemical compound names.

In a further embodiment, said document comprises each chemical compound name. In another further embodiment, said document is published. In another further embodiment, said document is unpublished. In another further embodiment, said document is a printed document.

In another further embodiment, said document is an electronic document.

In a further further embodiment, the invention is directed to a method of creating a printed document, performed in a data processing system comprising one or more CPUs, comprising: providing the electronic document; and printing the electronic document using computer instructions to direct the physical process of printing the electronic document using a printer.

In another further embodiment, said document resides in computer memory. In another further embodiment, the invention is directed to computer storage media in which is stored said document.

In another further embodiment, the document is stored in a computer data base.

In a further further embodiment, the invention is directed to said computer data base.

In another further embodiment, the document is available via the internet.

In a further further embodiment, the document is a printed document available via the internet. In another further further embodiment, the document is an electronic document available via the internet. In another further further embodiment, the document is available over the internet using a password.

In another embodiment, the invention is directed to intellectual property comprising one or more chemical compound names.

In a further embodiment, the intellectual property is a patent application.

In a further further embodiment, the patent application is an unfiled patent application. In another further further embodiment, the patent application is a filed patent application. In another further further embodiment, the patent application is a provisional application. In another further further embodiment, the patent application is a non-provisional application. In another further further embodiment, the patent application is a statutory invention registration application.

In another further embodiment, the intellectual property is a patent. In another further embodiment, the intellectual property is a statutory invention registration. In another further embodiment, the intellectual property is a trade secret. In another further embodiment, the intellectual property is licensed intellectual property. In another further embodiment, the intellectual property further comprises information regarding the enablement and utility of one or more of the chemical compounds represented by the chemical compound names comprised within the intellectual property.

In another further embodiment, the intellectual property further comprises information regarding enabling one of skill in the relevant art to make one or more of the chemical compounds represented by the chemical compound names comprised within the intellectual property.

In a further further embodiment, said intellectual property is offered for license or assignment. In another further further embodiment, said intellectual property is a filed, unpublished patent application that is offered for license or assignment. In another further further embodiment, said intellectual property is a trade secret that is offered for license.

In another further further embodiment, the intellectual property is a blocking patent.

In another embodiment, the invention is directed to a business method, wherein said business method comprises the steps, performed by a user, of:

providing one or more of said chemical compound names,

providing information related to enabling one of skill in the art to make one or more of the chemical compounds represented by such chemical compound names, and

creating intellectual property using such provided chemical compound names and the provided information related to enabling one of skill in the art to make one or more of the chemical compounds represented by the chemical compound names.

In a further embodiment, the intellectual property comprises information regarding the utility of the chemical compounds represented by the chemical compound names.

In another further embodiment, the business method comprises the step, performed by a user, of licensing the intellectual property.

In a further further embodiment, the invention is directed to said license.

In another further embodiment, the business method comprises the step, performed by a user, of enforcing the intellectual property.

In a further further embodiment, the invention is directed to a settlement or award resulting from enforcing the intellectual property.

In another further embodiment, the business method comprises the step, performed by a user, of assigning the intellectual property.

In a further further embodiment, the invention is directed to revenue realized from assigning the intellectual property.

In another further embodiment, the business method has the improvement of producing intellectual property comprising a large number of inventive embodiments in less time than by previous methods. In another further embodiment, the business method has the improvement of producing intellectual property comprising a large number of inventive embodiments at lower cost than by previous methods.

In a further further embodiment, the inventive embodiments fall within the scope of a genus disclosed within the intellectual property.

In a further further further embodiment, the genus is represented as a Markush group.

In another embodiment, the number of chemical compound names is greater than twenty-five. In another embodiment, the number of chemical compound names is greater than one hundred. In another embodiment, the number of chemical compound names is greater than two hundred and fifty. In another embodiment, the number of chemical compound names is greater than one thousand. In another embodiment, the number of chemical compound names is greater than ten thousand. In another embodiment, the number of chemical compound names is greater than fifty thousand. In another embodiment, the number of chemical compound names is greater than one hundred thousand. In another embodiment, the number of chemical compound names is greater than one million. In another embodiment, the number of chemical compound names is greater than ten million. In another embodiment, the number of chemical compound names is greater than one billion. In another embodiment, the number of chemical compound names is greater than or equal to twenty-five and less than one hundred. In another embodiment, the number of chemical compound names is greater than or equal to one hundred and less than five hundred. In another embodiment, the number of chemical compound names is greater than or equal to five hundred and less than one thousand. In another embodiment, the number of chemical compound names is greater than or equal to one thousand and less than ten thousand. In another embodiment, the number of chemical compound names is greater than or equal to ten thousand and less than one hundred thousand. In another embodiment, the number of chemical compound names is greater than or equal to one hundred thousand and less than one million. In another embodiment, the number of chemical compound names is greater than or equal to one million and less than one billion.

In another embodiment, the set of variable strings resides in computer memory. In another embodiment, the set of variable strings is input by a user. In another embodiment, the set of variable strings has one subset of variable strings. In another embodiment, the set of variable strings has two subsets of variable strings. In another embodiment, the set of variable strings has at least three and no more than five subsets of variable strings. In another embodiment, the set of variable strings comprises six or more subsets of variable strings. In another embodiment, one or more of the variable strings of the set of variable strings are null strings.

In another embodiment, each of the chemical compound names has the same number of variable strings.

In a further embodiment, the chemical compound names each have the same number of variable strings from each subset of variable strings as every other chemical compound name.

In a further further embodiment, each of the chemical compound names has one variable string from each of two subsets of variable strings. In another further further embodiment, each of the chemical compound names objects has one variable string from a first subset of variable strings, one variable string from a second subset of variable strings, and two variable strings from a third subset of variable strings.

In another further further embodiment, the variable strings within each subset of variable strings are ranked within that subset, and each subset of variable strings of the set of variable strings is ranked within the set of variable strings, such that, for the purpose of ranking the subsets of variable strings, where the chemical compound names have more than one variable string from a given subset of variable strings, that subset of variable strings is considered to be a different subset of variable strings for each occurrence of a variable string from that subset of variable strings within each chemical compound name, and wherein

the chemical compound names are created using an iterative process, whereby the first chemical compound name is created using the first variable string of the first-ranked subset of variable strings, and the first variable string of each other ranked subset of variable strings used in creating said first chemical compound name; and the second chemical compound name is created using the second variable string of the first-ranked subset of variable strings, and the first variable strings of each of the other ranked subsets of variable strings used in creating said second chemical compound name, such that the set of chemical compound names so created comprises chemical compound names representing all of the possible permutations of inclusions of variable strings within said chemical compound names.

In a further further further embodiment, each of the chemical compound names has one variable string, wherein said variable string is from a subset of variable strings having twenty variable strings, and the number of chemical compound names so created is twenty.

In another further further further embodiment, each of the chemical compound names has three variable strings, wherein one of the variable strings is from a first subset of variable strings having ten variable strings, and where the first subset of variable strings is the first-ranked subset of variable strings, and the other two variable strings are from a second subset of variable strings having five variable strings, and where the second subset of variable strings is the second-ranked and third-ranked subsets of variable strings, and the number of chemical compound names objects so created is two hundred and fifty.

In another further further embodiment, the variable strings within each subset of variable strings are ranked within that subset, and each subset of variable strings of the set of variable strings is ranked within the set of variable strings, such that, for the purpose of ranking the subsets of variable strings, where the chemical compound names have more than one variable string from a given subset of variable strings, that subset of variable strings is considered to be a different subset of variable strings for each occurrence of a variable string from that subset of variable strings within each chemical compound name; and wherein

the chemical compound names are created using an iterative process, whereby a first prospective chemical compound name contains the first variable string of the first-ranked subset of variable strings, and the first variable string of each other ranked subset of variable strings used in creating said first prospective chemical compound name; and a second prospective chemical compound name contains the second variable string of the first-ranked subset of variable strings, and the first variable strings of each of the other ranked subsets of variable strings used in creating said second prospective chemical compound name; and continuing said iterative process such that all of the prospective chemical compound names together comprise prospective chemical compound names representing all of the possible permutations of inclusions of variable strings within said prospective chemical compound names; wherein said method further comprises the step, performed in a data processing system comprising one or more CPUs, of

testing each prospective chemical compound name to determine whether the combination of variable strings within that prospective chemical compound name is a valid combination of such variable strings, and if the combination of variable strings is not a valid combination of variable strings, that prospective chemical compound name is not one of the chemical compound names.

In a further further further embodiment, the step of testing each prospective chemical compound name to determine whether the combination of variable strings within that prospective chemical compound name is a valid combination of such variable strings is performed before all of the variable strings have been assigned to that prospective chemical compound name. In another further further further embodiment, the step of testing each prospective chemical compound name to determine whether the combination of variable strings within that prospective chemical compound name is a valid combination of such variable strings is performed after all of the prospective chemical compound names are created. In another further further further embodiment, a prospective chemical compound name is determined to comprise an invalid combination of variable strings based on a single variable string.

In another embodiment, the set of variable strings is input by a user. In another embodiment, one or more of the variable strings are input by a user. In another embodiment, one or more of the variable strings are input by a user and one or more of the variable strings are located in a file. In another embodiment, a user selects one or more of the variable strings of the set of variable strings from a group of variable strings located in a file.

In another embodiment, the set of variable strings is located in a file.

In a further embodiment, the file is a spreadsheet.

In a further further embodiment, each subset of variable strings of the set of variable strings is organized in a separate column in the spreadsheet.

In a further further further embodiment, each variable string of each subset of variable strings is organized in a different row in the spreadsheet.

In another further embodiment, the set of variable strings is incorporated into computer software.

In a further further embodiment, the computer software comprises a set of computer instructions used in making the chemical compound names.

In another embodiment, each of the chemical compound names has one variable string from each subset of variable strings of the set of variable strings. In another embodiment, one or more of the subsets of variable strings of the set of variable strings have one variable string. In another embodiment each chemical compound name is created such that the variable strings within each chemical compound name are valid variable strings for that chemical compound name, such that no chemical compound name is created that has one or more variable strings that are invalid for that chemical compound name.

In another embodiment, no input from a user occurs for the duration of the process of creating each of the chemical compound names. In another embodiment, the data processing system creates each of the chemical compound names using the data-object-creation data without input from a user.

In another embodiment, the duration of the process of creating the set of chemical compound names using the data-object-creation data is less than one second. In another embodiment, the duration of the process of creating the chemical compound names is greater than or equal to one second and less than one minute. In another embodiment, the duration of the process of creating the chemical compound names is greater than or equal to one minute and less than ten minutes. In another embodiment, the duration of the process of creating the chemical compound names is greater than or equal to ten minutes and less than one hour. In another embodiment, the duration of the process of creating the chemical compound names is greater than or equal to one hour and less than one day. In another embodiment, the duration of the process of creating the chemical compound names is greater than or equal to one day.

In another embodiment, one or more of the variable strings of the set of variable strings are excluded from one or more of the chemical compound names.

In a further embodiment, the data-object-creation data comprises information used in determining which variable strings are to be excluded from each of the chemical compound names.

In a further further embodiment, one or more of the variable strings of the set of variable strings are excluded from one or more of the chemical compound names, but not from all of the chemical compound names.

In another further embodiment, one or more of the variable strings of one or more of the subsets of variable strings of the set of variable strings are excluded from one or more of the chemical compound names.

In another further embodiment, the data-object-creation data comprises information used in determining which variable strings are to be excluded from each of the chemical compound names.

In a further further embodiment, one or more of the variable strings of the set of variable strings are excluded from one or more of the chemical compound names, but not from all of the chemical compound names.

In one embodiment, the invention is directed to a method, in a data processing system comprising one or more CPUs, of creating a set of data objects, wherein said set of data objects comprises one or more data objects, comprising the steps of:

providing data-object-creation data, wherein said data-object-creation data comprises a set of variable strings, wherein the set of variable strings comprises one or more subsets of variable strings, and wherein each subset of variable strings of the set of variable strings comprises one or more variable strings, and

creating each of the data objects of the set of data objects, using the data-object-creation data, such that each of the data objects of the set of data objects comprises one or more variable strings of the set of variable strings;

wherein one or more of the data objects of the set of data objects are chemical compound preparations.

In another embodiment, each of the variable strings of the set of variable strings comprises more than one letter. In another embodiment, one or more of the variable strings of the set of variable strings each comprise more than one letter. In another embodiment, each variable string of the set of variable strings is other than a single character representing one of the letters selected from a, t, g, c, and u. In another embodiment, each of one or more variable strings of the set of variable strings are other than a single character representing one of the letters selected from a, t, g, c, and u. In another embodiment, each of the variable strings of the set of variable strings comprises other than a single letter. In another embodiment, one or more of the variable strings of the set of variable strings each comprise more than one letter. In another embodiment, one or more of the variable strings of the set of variable strings represent other than a nucleic acid moiety. In another embodiment, one or more of the variable strings of the set of variable strings represent other than an amino acid moiety. In another embodiment, one or more of the variable strings of the set of variable strings represent other than a carbohydrate moiety.

In another embodiment, the data-object-creation data resides in computer memory. In another embodiment, the method comprises altering the physical composition of the data processing system. In another embodiment, one or more variable strings of the set of variable strings are the products of functions. In another embodiment, one or more variable strings of the set of variable strings are the products of functions in a spreadsheet. In another embodiment, one or more variable strings of the set of variable strings occupy cells in a spreadsheet. In another embodiment, one or more variable strings of the set of variable strings represent molecular weights.

In another embodiment, at least one of the chemical compound preparations comprises text.

In a further embodiment, each of the chemical compound preparations comprises text.

In another embodiment, at least one of the chemical compound preparations comprises graphics.

In a further embodiment, each of the chemical compound preparations comprises graphics.

In a further further embodiment, such graphics represent chemical structure.

In another embodiment, at least one of the chemical compound preparations comprises text and graphics.

In a further embodiment, each of the chemical compound preparations comprises text and graphics.

In a further further embodiment, such graphics represent chemical structure.

In another embodiment, the method further comprises the step, performed in a data processing system comprising one or more CPUs, of outputting one or more of the chemical compound preparations to a table.

In another embodiment, the invention is directed to a table comprising one or more of the chemical compound preparations.

In a further embodiment, said table comprises each of the chemical compound preparations. In another further embodiment, said table comprises one or more of the chemical compound preparations such that each of the chemical compound preparations comprised within the table is arranged in a different row of the table, and each variable string of each of the chemical compound preparations is arranged in a different column in the row corresponding to that chemical compound preparation. In another further embodiment, said table comprises one or more of the chemical compound preparations such that each of the chemical compound preparations comprised within the table is arranged in a different column of the table, and each variable string of each of the chemical compound preparations is arranged in a different row in the column corresponding to that data object. In another further embodiment, said table comprises one or more items of graphics representing chemical structure. In another further embodiment, said table comprises one or more textual representations of chemical structure. In another further embodiment, the table resides in computer memory.

In another embodiment, the method further comprises the step, performed in a data processing system comprising one or more CPUs, of outputting one or more chemical compound preparations to a document.

In a further embodiment, the order of components of one or more of the chemical compound preparations so output to the document differs from the order of components of the corresponding chemical compound preparations as-created. In another further embodiment, the order of components of the chemical compound preparations so output to the document is the same as the order of components of the corresponding chemical compound preparations as-created.

In another embodiment, the invention is directed to a document comprising one or more of the chemical compound preparations.

In a further embodiment, said document comprises each of the chemical compound preparations. In another further embodiment, said document is published. In another further embodiment, said document is unpublished. In another further embodiment, said document is a printed document.

In another further embodiment, said document is an electronic document.

In a further further embodiment, the invention is directed to a method of creating a printed document, performed in a data processing system comprising one or more CPUs, comprising: providing the electronic document; and printing the electronic document using computer instructions to direct the physical process of printing the electronic document using a printer.

In another further embodiment, said document resides in computer memory. In another further embodiment, the invention is directed to computer storage media in which is stored said document.

In another further embodiment, the document is stored in a computer data base.

In a further further embodiment, the invention is directed to said computer data base.

In another further embodiment, the document is available via the internet.

In a further further embodiment, the document is a printed document available via the internet. In another further further embodiment, the document is an electronic document available via the internet. In another further further embodiment, the document is available over the internet using a password.

In another embodiment, the invention is directed to intellectual property comprising one or more chemical compound preparations.

In a further embodiment, the intellectual property is a patent application.

In a further further embodiment, the patent application is an unfiled patent application. In another further further embodiment, the patent application is a filed patent application. In another further further embodiment, the patent application is a provisional application. In another further further embodiment, the patent application is a non-provisional application. In another further further embodiment, the patent application is a statutory invention registration application.

In another further embodiment, the intellectual property is a patent. In another further embodiment, the intellectual property is a statutory invention registration. In another further embodiment, the intellectual property is a trade secret. In another further embodiment, the intellectual property is licensed intellectual property.

In another further embodiment, the intellectual property further comprises information regarding the enablement and utility of one or more of the chemical compound preparations.

In a further further embodiment, said intellectual property is offered for license or assignment. In another further further embodiment, said intellectual property is a filed, unpublished patent application that is offered for license or assignment. In another further further embodiment, said intellectual property is a trade secret that is offered for license.

In another further further embodiment, the intellectual property is a patent application comprising the chemical compound preparations, and one or more incorporations by reference to a previously-published reference.

In a further further further embodiment, the previously-published reference is a published patent application. In another further further further embodiment, the previously-published reference is an issued patent.

In another further further embodiment, the intellectual property is a blocking patent.

In another embodiment, the number of chemical compound preparations is greater than twenty-five. In another embodiment, the number of chemical compound preparations is greater than one hundred. In another embodiment, the number of chemical compound preparations is greater than two hundred and fifty. In another embodiment, the number of chemical compound preparations is greater than one thousand. In another embodiment, the number of chemical compound preparations is greater than ten thousand. In another embodiment, the number of chemical compound preparations is greater than fifty thousand. In another embodiment, the number of chemical compound preparations is greater than one hundred thousand. In another embodiment, the number of chemical compound preparations is greater than one million. In another embodiment, the number of chemical compound preparations is greater than ten million. In another embodiment, the number of chemical compound preparations is greater than one billion. In another embodiment, the number of chemical compound preparations is greater than or equal to twenty-five and less than one hundred. In another embodiment, the number of chemical compound preparations is greater than or equal to one hundred and less than five hundred. In another embodiment, the number of chemical compound preparations is greater than or equal to five hundred and less than one thousand. In another embodiment, the number of chemical compound preparations is greater than or equal to one thousand and less than ten thousand. In another embodiment, the number of chemical compound preparations is greater than or equal to ten thousand and less than one hundred thousand. In another embodiment, the number of chemical compound preparations is greater than or equal to one hundred thousand and less than one million. In another embodiment, the number of chemical compound preparations is greater than or equal to one million and less than one billion.

In another embodiment, the set of variable strings resides in computer memory. In another embodiment, the set of variable strings is input by a user. In another embodiment, the set of variable strings has one subset of variable strings. In another embodiment, the set of variable strings has two subsets of variable strings. In another embodiment, the set of variable strings has at least three and no more than five subsets of variable strings. In another embodiment, the set of variable strings comprises six or more subsets of variable strings. In another embodiment, one or more of the variable strings of the set of variable strings are null strings.

In another embodiment, each of the chemical compound preparations has the same number of variable strings.

In a further embodiment, the chemical compound preparations each have the same number of variable strings from each subset of variable strings as every other of the chemical compound preparations.

In a further further embodiment, each of the chemical compound preparations has one variable string from each of two subsets of variable strings. In another further further embodiment, each of the chemical compound preparations has one variable string from a first subset of variable strings, one variable string from a second subset of variable strings, and two variable strings from a third subset of variable strings.

In another further further embodiment, the variable strings within each subset of variable strings are ranked within that subset, and each subset of variable strings of the set of variable strings is ranked within the set of variable strings, such that, for the purpose of ranking the subsets of variable strings, where the chemical compound preparations have more than one variable string from a given subset of variable strings, that subset of variable strings is considered to be a different subset of variable strings for each occurrence of a variable string from that subset of variable strings within each chemical compound preparation, and wherein

the chemical compound preparations are created using an iterative process, whereby the first chemical compound preparation is created using the first variable string of the first-ranked subset of variable strings, and the first variable string of each other ranked subset of variable strings used in creating said first chemical compound preparation; and the second chemical compound preparation is created using the second variable string of the first-ranked subset of variable strings, and the first variable strings of each of the other ranked subsets of variable strings used in creating said second chemical compound preparation, such that the set of chemical compound preparations so created comprises chemical compound preparations representing all of the possible permutations of inclusions of variable strings within said chemical compound preparations.

In a further further further embodiment, each of the chemical compound preparations has one variable string, wherein said variable string is from a subset of variable strings having twenty variable strings, and the number of chemical compound preparations so created is twenty.

In another further further further embodiment, each of the chemical compound preparations has three variable strings, wherein one of the variable strings is from a first subset of variable strings having ten variable strings, and where the first subset of variable strings is the first-ranked subset of variable strings, and the other two variable strings are from a second subset of variable strings having five variable strings, and where the second subset of variable strings is the second-ranked and third-ranked subsets of variable strings, and the number of chemical compound preparations so created is two hundred and fifty.

In another further further embodiment, the variable strings within each subset of variable strings are ranked within that subset, and each subset of variable strings of the set of variable strings is ranked within the set of variable strings, such that, for the purpose of ranking the subsets of variable strings, where the chemical compound preparations of the set of chemical compound preparations have more than one variable string from a given subset of variable strings, that subset of variable strings is considered to be a different subset of variable strings for each occurrence of a variable string from that subset of variable strings within each chemical compound preparation of the set of chemical compound preparations; and wherein:

the chemical compound preparations of the set of chemical compound preparations are created using an iterative process, whereby a first prospective chemical compound preparation contains the first variable string of the first-ranked subset of variable strings, and the first variable string of each other ranked subset of variable strings used in creating said first prospective chemical compound preparation; and a second prospective chemical compound preparation contains the second variable string of the first-ranked subset of variable strings, and the first variable strings of each of the other ranked subsets of variable strings used in creating said second prospective chemical compound preparation; and continuing said iterative process such that all of the prospective chemical compound preparations together comprise prospective chemical compound preparations representing all of the possible permutations of inclusions of variable strings within said prospective chemical compound preparations; and wherein said method further comprises the step, performed in a data processing system comprising one or more CPUs, of:

testing each prospective chemical compound preparation to determine whether the combination of variable strings within that prospective chemical compound preparation is a valid combination of such variable strings: where if the combination of variable strings is not a valid combination of variable strings, that prospective chemical compound preparation is not one of the chemical compound preparations of the set of chemical compound preparations; and where if the combination of variable strings is a valid combination of variable strings, that prospective chemical compound preparation is one of the chemical compound preparations of the set of chemical compound preparations.

In a further further further embodiment, a prospective chemical compound preparation is determined to contain an invalid combination of variable strings before all of the variable strings have been assigned to that prospective chemical compound preparation. In another further further further embodiment, all of the prospective chemical compound preparations are created before the test is performed to determine which prospective chemical compound preparations have an invalid combination of variable strings. In another further further further embodiment, a prospective chemical compound preparation is determined to comprise an invalid combination of variable strings based on a single variable string.

In another embodiment, the set of variable strings is input by a user. In another embodiment, one or more of the variable strings are input by a user. In another embodiment, one or more of the variable strings are input by a user and one or more of the variable strings are located in a file. In another embodiment, a user selects one or more of the variable strings of the set of variable strings from a group of variable strings located in a file.

In another embodiment, the set of variable strings is located in a file.

In a further embodiment, the file is a spreadsheet.

In a further further embodiment, each subset of variable strings of the set of variable strings is organized in a separate column in the spreadsheet.

In a further further further embodiment, each variable string of each subset of variable strings is organized in a different row in the spreadsheet.

In another further embodiment, the set of variable strings is incorporated into computer software.

In a further further embodiment, the computer software comprises a set of computer instructions used in making the chemical compound preparations.

In another embodiment, each of the chemical compound preparations has one variable string from each subset of variable strings of the set of variable strings. In another embodiment, one or more of the subsets of variable strings of the set of variable strings have one variable string. In another embodiment each chemical compound preparation of the set of chemical compound preparations is created such that the variable strings within each chemical compound preparation are valid variable strings for that chemical compound preparation, such that no chemical compound preparation of the set of chemical compound preparations is created that has one or more variable strings that are invalid for that chemical compound preparation.

In another embodiment, no input from a user occurs for the duration of the process of creating each of the chemical compound preparations. In another embodiment, the data processing system creates each of the chemical compound preparations using the data-object-creation data without input from a user.

In another embodiment, the duration of the process of creating the chemical compound preparations using the data-object-creation data is less than one second. In another embodiment, the duration of the process of creating the chemical compound preparations is greater than or equal to one second and less than one minute. In another embodiment, the duration of the process of creating the chemical compound preparations is greater than or equal to one minute and less than ten minutes. In another embodiment, the duration of the process of creating the chemical compound preparations is greater than or equal to ten minutes and less than one hour. In another embodiment, the duration of the process of creating the chemical compound preparations is greater than or equal to one hour and less than one day. In another embodiment, the duration of the process of creating the chemical compound preparations is greater than or equal to one day.

In another embodiment, one or more of the variable strings of the set of variable strings are excluded from one or more chemical compound preparations.

In a further embodiment, the data-object-creation data comprises information used in determining which variable strings are to be excluded from each of the chemical compound preparations.

In a further further embodiment, one or more of the variable strings of the set of variable strings are excluded from one or more of the chemical compound preparations, but not from all of the chemical compound preparations.

In another further embodiment, one or more of the variable strings of one or more of the subsets of variable strings of the set of variable strings are excluded from one or more of the chemical compound preparations.

In another further embodiment, the data-object-creation data comprises information used in determining which variable strings are to be excluded from each of the chemical compound preparations.

In a further further embodiment, one or more of the variable strings of the set of variable strings are excluded from one or more of the chemical compound preparations, but not from all of the chemical compound preparations.

In another embodiment, the invention is directed to an item of intellectual property, wherein said item of intellectual property comprises one or more data objects, wherein said data objects are created by a method comprising the steps, performed in a data processing system comprising one or more CPUs, of:

providing data-object-creation data, wherein said data-object-creation data comprises a set of variable strings, wherein the set of variable strings comprises one or more subsets of variable strings, and wherein each subset of variable strings of the set of variable strings comprises one or more variable strings, and

creating a set of data objects, wherein said set of data objects comprises one or more data objects, using the data-object-creation data, such that each of the data objects of the set of data objects comprises one or more variable strings of the set of variable strings;

such that the item of intellectual property comprises one or more of the data objects of the set of data objects.

In another embodiment, the item of intellectual property comprises all of the data objects of the set of data objects. In another embodiment, the item of intellectual property comprises some of the data objects of the set of data objects. In another embodiment, the data-object-creation data resides in computer memory.

In another embodiment, at least one of the data objects of the set of data objects comprises text.

In a further embodiment, each data object of the set of data objects comprises text.

In another embodiment, at least one of the data objects of the set of data objects comprises graphics.

In a further embodiment, each data object of the set of data objects comprises graphics.

In a further further embodiment, such graphics represent chemical structure.

In another embodiment, at least one of the data objects of the set of data objects comprises text and graphics.

In a further embodiment, each data object of the set of data objects comprises text and graphics.

In a further further embodiment, such graphics represent chemical structure.

In another embodiment, the method further comprises the step, performed in a data processing system comprising one or more CPUs, of: outputting one or more data objects of the set of data objects to a document.

In a further embodiment, said document comprises each data object of the set of data objects. In another further embodiment, said document is published. In another further embodiment, said document is unpublished. In another further embodiment, said document is a printed document.

In another further embodiment, said document is an electronic document.

In a further further embodiment, the invention is directed to a method of creating a printed document, performed in a data processing system comprising one or more CPUs, comprising: providing the electronic document; and printing the electronic document using computer instructions to direct the physical process of printing the electronic document using a printer.

In another further embodiment, said document resides in computer memory. In another further embodiment, the invention is directed to computer storage media in which is stored said document.

In another further embodiment, the document is stored in a computer data base.

In a further further embodiment, the invention is directed to said computer data base.

In another further embodiment, the document is available via the internet.

In a further further embodiment, the document is a printed document available via the internet. In another further further embodiment, the document is an electronic document available via the internet. In another further further embodiment, the document is available over the internet using a password.

In another embodiment, the intellectual property comprises more than twenty-five data objects. In another embodiment, the intellectual property comprises more than one hundred data objects. In another embodiment, the intellectual property comprises more than two hundred and fifty data objects. In another embodiment, the intellectual property comprises more than one thousand data objects. In another embodiment, the intellectual property comprises more than ten thousand data objects. In another embodiment, the intellectual property comprises more than fifty thousand data objects. In another embodiment, the intellectual property comprises more than one hundred thousand data objects. In another embodiment, the intellectual property comprises more than one million data objects. In another embodiment, the intellectual property comprises more than ten million data objects. In another embodiment, the intellectual property comprises more than one billion data objects. In another embodiment, the number of data objects comprised within the intellectual property is greater than or equal to twenty-five and less than one hundred. In another embodiment, the number of data objects comprised within the intellectual property is greater than or equal to one hundred and less than five hundred. In another embodiment, the number of data objects comprised within the intellectual property is greater than or equal to five hundred and less than one thousand. In another embodiment, the number of data objects comprised within the intellectual property is greater than or equal to one thousand and less than ten thousand. In another embodiment, the number of data objects comprised within the intellectual property is greater than or equal to ten thousand and less than one hundred thousand. In another embodiment, the number of data objects comprised within the intellectual property is greater than or equal to one hundred thousand and less than one million. In another embodiment, the number of data objects comprised within the intellectual property is greater than or equal to one million and less than one billion.

In another embodiment, the set of variable strings resides in computer memory. In another embodiment, the set of variable strings is input by a user. In another embodiment, the set of variable strings has one subset of variable strings. In another embodiment, the set of variable strings has two subsets of variable strings. In another embodiment, the set of variable strings has at least three and no more than five subsets of variable strings. In another embodiment, the set of variable strings comprises six or more subsets of variable strings. In another embodiment, one or more of the variable strings of the set of variable strings are null strings.

In another embodiment, each of the data objects of the set of data objects has the same number of variable strings.

In a further embodiment, the data objects of the set of data objects each have the same number of variable strings from each subset of variable strings as every other data object of the set of data objects.

In a further further embodiment, each of the data objects of the set of data objects has one variable string from each of two subsets of variable strings. In another further further embodiment, each of the data objects of the set of data objects has one variable string from a first subset of variable strings, one variable string from a second subset of variable strings, and two variable strings from a third subset of variable strings.

In another further further embodiment, the variable strings within each subset of variable strings are ranked within that subset, and each subset of variable strings of the set of variable strings is ranked within the set of variable strings, such that, for the purpose of ranking the subsets of variable strings, where the data objects of the set of data objects have more than one variable string from a given subset of variable strings, that subset of variable strings is considered to be a different subset of variable strings for each occurrence of a variable string from that subset of variable strings within each data object of the set of data objects; and wherein:

the data objects of the set of data objects are created using an iterative process, whereby the first data object of the set of data objects is created using the first variable string of the first-ranked subset of variable strings, and the first variable string of each other ranked subset of variable strings used in creating said first data object; and the second data object of the set of data objects is created using the second variable string of the first-ranked subset of variable strings, and the first variable strings of each of the other ranked subsets of variable strings used in creating said second data object, such that the set of data objects so created comprises data objects representing all of the possible permutations of inclusions of variable strings within said data objects.

In a further further further embodiment, each of the data objects of the set of data objects has one variable string, wherein said variable string is from a subset of variable strings having twenty variable strings, and the number of data objects in the set of data objects so created is twenty.

In another further further further embodiment, each of the data objects of the set of data objects has three variable strings, wherein one of the variable strings is from a first subset of variable strings having ten variable strings, and where the first subset of variable strings is the first-ranked subset of variable strings, and the other two variable strings are from a second subset of variable strings having five variable strings, and where the second subset of variable strings is the second-ranked and third-ranked subsets of variable strings, and the number of data objects in the set of data objects so created is two hundred and fifty.

In another further further embodiment, the variable strings within each subset of variable strings are ranked within that subset, and each subset of variable strings of the set of variable strings is ranked within the set of variable strings, such that, for the purpose of ranking the subsets of variable strings, where the data objects of the set of data objects have more than one variable string from a given subset of variable strings, that subset of variable strings is considered to be a different subset of variable strings for each occurrence of a variable string from that subset of variable strings within each data object of the set of data objects; and wherein:

the data objects of the set of data objects are created using an iterative process, whereby a first prospective data object contains the first variable string of the first-ranked subset of variable strings, and the first variable string of each other ranked subset of variable strings used in creating said first prospective data object; and a second prospective data object contains the second variable string of the first-ranked subset of variable strings, and the first variable strings of each of the other ranked subsets of variable strings used in creating said second prospective data object; and continuing said iterative process such that all of the prospective data objects together comprise prospective data objects representing all of the possible permutations of inclusions of variable strings within said prospective data objects; and wherein said method further comprises the step, performed in a data processing system comprising one or more CPUs, of:

testing each prospective data object to determine whether the combination of variable strings within that prospective data object is a valid combination of such variable strings: where if the combination of variable strings is not a valid combination of variable strings, that prospective data object is not one of the data objects of the set of data objects; and where if the combination of variable strings is a valid combination of variable strings, that prospective data object is one of the data objects of the set of data objects.

In a further further further embodiment, a prospective data object is determined to contain an invalid combination of variable strings before all of the variable strings have been assigned to that prospective data object. In another further further further embodiment, all of the prospective data objects are created before the test is performed to determine which prospective data objects have an invalid combination of variable strings. In another further further further embodiment, a prospective data object is determined to comprise an invalid combination of variable strings based on a single variable string.

In another embodiment, the set of variable strings is input by a user. In another embodiment, one or more of the variable strings are input by a user. In another embodiment, one or more of the variable strings are input by a user and one or more of the variable strings are located in a file. In another embodiment, a user selects one or more of the variable strings of the set of variable strings from a group of variable strings located in a file.

In another embodiment, the set of variable strings is located in a file.

In a further embodiment, the file is a spreadsheet.

In a further further embodiment, each subset of variable strings of the set of variable strings is organized in a separate column in the spreadsheet.

In a further further further embodiment, each variable string of each subset of variable strings is organized in a different row in the spreadsheet.

In another further embodiment, the set of variable strings is incorporated into computer software.

In a further further embodiment, the computer software comprises a set of computer instructions used in making the data objects of the set of data objects.

In another embodiment, each of the data objects of the set of data objects has one variable string from each subset of variable strings of the set of variable strings. In another embodiment, one or more of the subsets of variable strings of the set of variable strings have one variable string. In another embodiment each data object of the set of data objects is created such that the variable strings within each data object are valid variable strings for that data object, such that no data object of the set of data objects is created that has one or more variable strings that are invalid for that data object.

In another embodiment, no input from a user occurs for the duration of the process of creating each of the data objects of the set of data objects. In another embodiment, the data processing system creates each of the data objects of the set of data objects using the data-object-creation data without input from a user.

In another embodiment, the duration of the process of creating the set of data objects using the data-object-creation data is less than one second. In another embodiment, the duration of the process of creating the set of data objects is greater than or equal to one second and less than one minute. In another embodiment, the duration of the process of creating the set of data objects is greater than or equal to one minute and less than ten minutes. In another embodiment, the duration of the process of creating the set of data objects is greater than or equal to ten minutes and less than one hour. In another embodiment, the duration of the process of creating the set of data objects is greater than or equal to one hour and less than one day. In another embodiment, the duration of the process of creating the set of data objects is greater than or equal to one day.

In another embodiment, one or more of the variable strings of the set of variable strings are excluded from one or more data objects of the set of data objects.

In a further embodiment, the data-object-creation data comprises information used in determining which variable strings are to be excluded from each of the data objects of the set of data objects.

In a further further embodiment, one or more of the variable strings of the set of variable strings are excluded from one or more of the data objects of the set of data objects, but not from all of the data objects of the set of data objects.

In another further embodiment, one or more of the variable strings of one or more of the subsets of variable strings of the set of variable strings are excluded from one or more of the data objects of the set of data objects.

In another further embodiment, the data-object-creation data comprises information used in determining which variable strings are to be excluded from each of the data objects of the set of data objects.

In a further further embodiment, one or more of the variable strings of the set of variable strings are excluded from one or more of the data objects of the set of data objects, but not from all of the data objects of the set of data objects.

In one embodiment, the invention is directed to a method, in a data processing system comprising one or more CPUs, of creating a set of data objects, wherein said set of data objects comprises one or more data objects, comprising the steps of:

providing data-object-creation data, wherein said data-object-creation data comprises a set of variable strings, wherein the set of variable strings comprises one or more subsets of variable strings, and wherein each subset of variable strings of the set of variable strings comprises one or more variable strings; and wherein the data-object-creation data comprises a set of variable-directing strings comprising one or more variable-directing strings; and

creating each of the data objects of the set of data objects, using the data-object-creation data, such that each of the data objects of the set of data objects comprises one or more variable strings of the set of variable strings; and using the variable-directing stings of the set of variable-directing strings to direct the placement of the variable strings within such data objects.

In another embodiment, each of the variable strings of the set of variable strings comprises more than one letter. In another embodiment, one or more of the variable strings of the set of variable strings each comprise more than one letter. In another embodiment, each variable string of the set of variable strings is other than a single character representing one of the letters selected from a, t, g, c, and u. In another embodiment, each of one or more variable strings of the set of variable strings are other than a single character representing one of the letters selected from a, t, g, c, and u. In another embodiment, each of the variable strings of the set of variable strings comprises other than a single letter. In another embodiment, one or more of the variable strings of the set of variable strings each comprise more than one letter. In another embodiment, one or more of the variable strings of the set of variable strings represent other than a nucleic acid moiety. In another embodiment, one or more of the variable strings of the set of variable strings represent other than an amino acid moiety. In another embodiment, one or more of the variable strings of the set of variable strings represent other than a carbohydrate moiety.

In another embodiment, one or more variable strings of the set of variable strings are the product of a function. In another embodiment, one or more variable strings of the set of variable strings are the product of a function in a spreadsheet. In another embodiment, one or more variables of the set of variables occupy a cell in a spreadsheet. In another embodiment, one or more variables of the set of variables represent a molecular weight.

In another embodiment, each of the variable-directing strings of the set of variable-directing strings directs the placement of one variable string within each of the data objects of the set of data objects such that the number of variable strings within each of the data objects of the set of data objects is equal to the number of variable-directing strings of the set of variable-directing strings.

In a further embodiment, each of the variable-directing strings of the set of variable directing strings corresponds to one of the subsets of variable strings, and each variable-directing string of the set of variable-directing strings directs the placement, within each of the data objects of the set of data objects, of one variable string from the subset of variable strings corresponding to that variable-directing string.

In another embodiment, the data-object-creation data comprises a template string, wherein the template string comprises each variable-directing string of the set of variable-directing strings, and wherein each data object of the set of data objects comprises the contents of the template string minus the variable-directing strings, and wherein each of the data objects of the set of data objects further comprises one variable string for each of the variable-directing strings.

In a further embodiment, each of the variable-directing strings of the set of variable directing strings corresponds to one of the subsets of variable strings, and each variable-directing string of the set of variable-directing strings directs the placement, within each of the data objects of the set of data objects, of one variable string from the subset of variable strings corresponding to that variable-directing string.

In another embodiment, the variable-directing strings are not incorporated into the data objects of the set of data objects. In another embodiment, the data-object-creation data resides in computer memory. In another embodiment, the method comprises altering the physical composition of the data processing system.

In another embodiment, at least one of the data objects of the set of data objects comprises text.

In a further embodiment, each data object of the set of data objects comprises text.

In another embodiment, at least one of the data objects of the set of data objects comprises graphics.

In a further embodiment, each data object of the set of data objects comprises graphics.

In a further further embodiment, such graphics represent chemical structure.

In another embodiment, at least one of the data objects of the set of data objects comprises text and graphics.

In a further embodiment, each data object of the set of data objects comprises text and graphics.

In a further further embodiment, such graphics represent chemical structure.

In another embodiment, the method further comprises the step, performed in a data processing system comprising one or more CPUs, of: outputting one or more of the data objects of the set of data objects to a table.

In another embodiment, the invention is directed to a table comprising one or more of the data objects of the set of data objects.

In a further embodiment, said table comprises each data object of the set of data objects. In another further embodiment, said table comprises one or more of the data objects of the set of data objects such that each data object of the data objects comprised within the table is arranged in a different row of the table, and each variable string of each such data object is arranged in a different column in the row corresponding to that data object. In another further embodiment, said table comprises one or more of the data objects of the set of data objects such that each data object of the data objects comprised within the table is arranged in a different column of the table, and each variable string of each such data object is arranged in a different row in the column corresponding to that data object. In another further embodiment, said table comprises one or more items of graphics representing chemical structure. In another further embodiment, said table comprises one or more textual representations of chemical structure. In another further embodiment, the table resides in computer memory.

In another embodiment, the method further comprises the step, performed in a data processing system comprising one or more CPUs, of: outputting one or more data objects of the set of data objects to a document.

In a further embodiment, the order of components of one or more of the data objects so output to the document differs from the order of components of the corresponding data objects as-created. In another further embodiment, the order of components of the data objects so output to the document is the same as the order of components of the corresponding data objects as-created.

In another embodiment, the invention is directed to a document comprising one or more data objects of the set of data objects.

In a further embodiment, said document comprises each data object of the set of data objects. In another further embodiment, said document is published. In another further embodiment, said document is unpublished. In another further embodiment, said document is a printed document.

In another further embodiment, said document is an electronic document.

In a further further embodiment, the invention is directed to a method of creating a printed document, performed in a data processing system comprising one or more CPUs, comprising: providing the electronic document; and printing the electronic document using computer instructions to direct the physical process of printing the electronic document using a printer.

In another further embodiment, said document resides in computer memory. In another further embodiment, the invention is directed to computer storage media in which is stored said document.

In another further embodiment, the document is stored in a computer data base.

In a further further embodiment, the invention is directed to said computer data base.

In another further embodiment, the document is available via the internet.

In a further further embodiment, the document is a printed document available via the internet. In another further further embodiment, the document is an electronic document available via the internet. In another further further embodiment, the document is available over the internet using a password.

In another embodiment, the invention is directed to intellectual property comprising one or more data objects of the set of data objects.

In a further embodiment, the intellectual property is a patent application.

In a further further embodiment, the patent application is an unfiled patent application. In another further further embodiment, the patent application is a filed patent application. In another further further embodiment, the patent application is a provisional application. In another further further embodiment, the patent application is a non-provisional application. In another further further embodiment, the patent application is a statutory invention registration application.

In another further embodiment, the intellectual property is a patent. In another further embodiment, the intellectual property is a statutory invention registration. In another further embodiment, the intellectual property is a trade secret. In another further embodiment, the intellectual property is licensed intellectual property. In another further embodiment, the one or more data objects of the set of data objects comprised within the intellectual property represent inventive embodiments, and the intellectual property further comprises information regarding the enablement and utility of one or more of such inventive embodiments.

In another further embodiment, the one or more data objects of the set of data objects comprised within the intellectual property represent inventive embodiments, and the intellectual property further comprises information regarding enabling one of skill in the relevant art to make one or more of such inventive embodiments.

In a further further embodiment, said intellectual property is offered for license or assignment. In another further further embodiment, said intellectual property is a filed, unpublished patent application that is offered for license or assignment. In another further further embodiment, said intellectual property is a trade secret that is offered for license.

In another further further embodiment, one or more of the inventive embodiments are chemical compound names, and the intellectual property is a patent application comprising the chemical compound names, and one or more incorporations by reference to a previously-published reference.

In a further further further embodiment, the previously-published reference is a published patent application. In another further further further embodiment, the previously-published reference is an issued patent.

In another further further embodiment, one or more of the inventive embodiments are chemical compound names, wherein each of the chemical compound names represents a chemical compound, and wherein one or more of said chemical compounds represented by the chemical compound names are encompassed by a prior art genus of chemical compounds.

In a further further further embodiment, the prior art genus of chemical compounds is represented as a Markush group.

In another further further embodiment, the intellectual property is a blocking patent.

In a further further further embodiment, one or more of the inventive embodiments of the blocking patent are chemical compound names, and one or more of the chemical compound names of the blocking patent are embraced by a genus disclosed in a different patent or patent application.

In a further further further further embodiment, the genus is represented as a Markush group.

In another embodiment, the invention is directed to a business method, wherein said business method comprises the steps, performed by a user, of:

providing one or more of said data objects of said set of data objects, wherein one or more of the data objects so provided are inventive embodiments,

providing information related to enabling one of skill in the art to make one or more of such inventive embodiments, and

creating intellectual property using such provided data objects and information related to enabling one of skill in the art to make one or more of such inventive embodiments.

In a further embodiment, one or more of the provided data objects are chemical compound names.

In a further further embodiment, the chemical compounds represented by the chemical compound names are other than DNA compounds. In another further further embodiment, the chemical compounds represented by the chemical compound names are other than RNA compounds. In another further further embodiment, the chemical compounds represented by the chemical compound names are other than compounds having one or more mononucleotide moieties. In another further further embodiment, the chemical compounds represented by the chemical compound names are other than compounds having two or more mononucleotide moieties.

In another further further embodiment, the chemical compounds represented by the chemical compound names are other than polypeptides. In another further further embodiment, the chemical compounds represented by the chemical compound names are other than compounds having one or more peptide-linked amino acid moieties. In another further further embodiment, the chemical compounds represented by the chemical compound names are other than compounds having two or more peptide-linked amino acid moieties. In another further further embodiment, the chemical compounds represented by the chemical compound names are other than enzymes.

In another further further embodiment, the chemical compounds represented by the chemical compound names are other than sugars. In another further further embodiment, the chemical compounds represented by the chemical compound names are other than carbohydrates. In another further further embodiment, the chemical compounds represented by the chemical compound names are other than polysaccharides. In another further further embodiment, the chemical compounds represented by the chemical compound names are other than compounds having one or more monosaccharide moieties. In another further further embodiment, the chemical compounds represented by the chemical compound names are other than compounds having two or more glycoside-bond-linked monosaccharide moieties.

In another further further embodiment, the chemical compounds represented by the chemical compound names are other than polymers. In another further further embodiment, the chemical compounds represented by the chemical compound names are other than dendrimers.

In another further further embodiment, the chemical compounds represented by the chemical compound names are other than chemical compounds containing a sequence of subunits.

In a further further further embodiment, the sequence of subunits is linear, and each internal subunit comprises a first site of attachment to a first adjacent subunit, and a second site of attachment to a second adjacent subunit. In a further further further embodiment, each of the subunits is one of twenty possible subunits. In a further further further embodiment, each of the subunits is one of four possible subunits. In a further further further embodiment, each of the subunits is one of two or more possible subunits. In a further further further embodiment, each of the subunits is one of ten or more possible subunits. In a further further further embodiment, each of the subunits is one of twenty or more possible subunits. In a further further further embodiment, the sequence of subunits is branched.

In another further embodiment, the intellectual property comprises information regarding the utility of the inventive embodiments.

In another further embodiment, the business method comprises the step, performed by a user, of licensing the intellectual property.

In a further further embodiment, the invention is directed to said license.

In another further embodiment, the business method comprises the step, performed by a user, of enforcing the intellectual property.

In a further further embodiment, the invention is directed to a settlement or award resulting from enforcing the intellectual property.

In another further embodiment, the business method comprises the step, performed by a user, of assigning the intellectual property.

In a further further embodiment, the invention is directed to revenue realized from assigning the intellectual property.

In another further embodiment, the business method has the improvement of producing intellectual property comprising a large number of inventive embodiments in less time than by previous methods. In another further embodiment, the business method has the improvement of producing intellectual property comprising a large number of inventive embodiments at lower cost than by previous methods.

In a further further embodiment, the inventive embodiments fall within the scope of a genus disclosed within the intellectual property.

In a further further further embodiment, the genus is represented as a Markush group.

In another embodiment, the invention is directed to a business method, wherein said business method comprises the steps, performed in a data processing system comprising one or more CPUs, of:

creating a first set of data objects using the method of creating a set of data objects, such that the first set of data objects is a set of chemical-compound-name data objects, wherein said set of chemical-compound-name data objects comprises one or more chemical-compound-name data objects, and wherein each chemical-compound-name data object is a chemical compound name, wherein each chemical compound name represents a chemical compound; and

creating a second set of data objects using the method of creating a set of data objects, such that the second set of data objects is a set of chemical-compound-preparation data objects, wherein said set of chemical-compound-preparation data objects comprises one or more chemical-compound-preparation data objects, and wherein each chemical-compound-preparation data object is a chemical compound preparation, wherein one or more of the chemical compound preparations comprise information regarding the preparation of one or more of the chemical compounds represented by the chemical-compound-name data objects; and comprising the step, performed by a user, of:

creating intellectual property using one or more of the chemical compound names and one or more of the chemical compound preparations.

In a further embodiment, the intellectual property is licensed. In another further embodiment, the intellectual property is assigned. In another further embodiment, the intellectual property is a patent. In another further embodiment, the intellectual property is a statutory invention registration. In another further embodiment, the intellectual property is a patent application. In another further embodiment, the intellectual property is a trade secret. In another further embodiment, the business method has the improvement of producing intellectual property comprising a large number of chemical compound names and chemical compound preparations in less time than by previous methods. In another further embodiment, the business method has the improvement of producing intellectual property comprising a large number of chemical compound names and chemical compound preparations at lower cost than by previous methods.

In another further embodiment, the chemical compounds represented by the chemical compound names are other than DNA compounds. In another further embodiment, the chemical compounds represented by the chemical compound names are other than RNA compounds. In another further embodiment, the chemical compounds represented by the chemical compound names are other than compounds having one or more mononucleotide moieties. In another further embodiment, the chemical compounds represented by the chemical compound names are other than compounds having two or more mononucleotide moieties.

In another further embodiment, the chemical compounds represented by the chemical compound names are other than polypeptides. In another further embodiment, the chemical compounds represented by the chemical compound names are other than compounds having one or more peptide-linked amino acid moieties. In another further embodiment, the chemical compounds represented by the chemical compound names are other than compounds having two or more peptide-linked amino acid moieties. In another further embodiment, the chemical compounds represented by the chemical compound names are other than enzymes.

In another further embodiment, the chemical compounds represented by the chemical compound names are other than sugars. In another further embodiment, the chemical compounds represented by the chemical compound names are other than carbohydrates. In another further embodiment, the chemical compounds represented by the chemical compound names are other than polysaccharides. In another further embodiment, the chemical compounds represented by the chemical compound names are other than compounds having one or more monosaccharide moieties. In another further embodiment, the chemical compounds represented by the chemical compound names are other than compounds having two or more glycoside-bond-linked monosaccharide moieties.

In another further embodiment, the chemical compounds represented by the chemical compound names are other than polymers. In another further embodiment, the chemical compounds represented by the chemical compound names are other than dendrimers.

In another further embodiment, the chemical compounds represented by the chemical compound names are other than chemical compounds containing a sequence of subunits.

In a further further embodiment, the sequence of subunits is linear, and each internal subunit comprises a first site of attachment to a first adjacent subunit, and a second site of attachment to a second adjacent subunit. In a further further embodiment, each of the subunits is one of twenty possible subunits. In a further further embodiment, each of the subunits is one of four possible subunits. In a further further embodiment, each of the subunits is one of two or more possible subunits. In a further further embodiment, each of the subunits is one of ten or more possible subunits. In a further further embodiment, each of the subunits is one of twenty or more possible subunits. In a further further embodiment, the sequence of subunits is branched.

In another further embodiment, the business method comprises the step, performed by a user, of licensing the intellectual property.

In a further further embodiment, the invention is directed to said license.

In another further embodiment, the business method comprises the step, performed by a user, of enforcing the intellectual property.

In a further further embodiment, the invention is directed to a settlement or award resulting from enforcing the intellectual property.

In another further embodiment, the business method comprises the step, performed by a user, of assigning the intellectual property.

In a further further embodiment, the invention is directed to revenue realized from assigning the intellectual property.

In another embodiment, the invention is directed to a business method, wherein said business method comprises the steps, performed by a user, of:

providing one or more of the data objects of said set of data objects, wherein one or more of the data objects so provided are chemical compound names, wherein each of the chemical compound names represents a chemical compound, and

providing enablement information, wherein said enablement information is information related to enabling one of skill in the art to make one or more of such chemical compounds.

In a further embodiment, the enablement information comprises one or more references. In another further embodiment, the enablement information comprises one or more chemical compound preparations. In another further embodiment, the enablement information is provided by the chemical compound names, such that one of skill in the art is able to make the chemical compounds without undue experimentation given the chemical compound names.

In another further embodiment, the business method comprises the step, performed by a user, of licensing the intellectual property.

In a further further embodiment, the invention is directed to said license.

In another further embodiment, the business method comprises the step, performed by a user, of enforcing the intellectual property.

In a further further embodiment, the invention is directed to a settlement or award resulting from enforcing the intellectual property.

In another further embodiment, the business method comprises the step, performed by a user, of assigning the intellectual property.

In a further further embodiment, the invention is directed to revenue realized from assigning the intellectual property.

In another further embodiment, the business method has the improvement of producing intellectual property comprising a large number of chemical compound names at lower cost and in less time than by previous methods.

In another further embodiment, the business method comprises the step, performed by a user, of providing utility information, where said utility information is used to establish the utility of one or more of the chemical compounds.

In a further further embodiment, one or more of the chemical compounds are structurally related to a biologically active chemical compound, and the utility information comprises information related to the utility of the biologically active chemical compound.

In a further further further embodiment, one or more of the chemical compounds and the biologically active chemical compound share a common utility.

In another further further embodiment, the utility information comprises information regarding two or more utilities.

In another further further embodiment, one or more of the chemical compounds have utility as a pharmaceutical and as a compound that is able to absorb ultraviolet light.

In a further further further embodiment, one or more of the chemical compounds have utility as an ultraviolet light absorbing dye.

In another further embodiment, the business method further comprises the step, performed by a user, of providing a file, wherein the file comprises the chemical compound names so provided and the enablement information. In another further embodiment, the number of data objects in the set of data objects is equal to or greater than one hundred. In another further embodiment, the number of data objects in the set of data objects is equal to or greater than one thousand. In another further embodiment, the number of data objects in the set of data objects is equal to or greater than one hundred thousand.

In another further embodiment, the business method further comprises the steps, performed by a user, of:

providing the structure of a biologically active chemical compound,

analyzing the structure of said biologically active chemical compound in order to postulate a genus of structurally related target chemical compounds, such that the names of each of the structurally related target chemical compounds of such genus each share one or more common chemical compound name fragments, and are able to be used to create the chemical compound names, such that each chemical compound name represents one of the names of a structurally related target chemical compound embraced by the genus of structurally related target chemical compounds.

In a further further embodiment, the genus is represented as a Markush group.

In another further further embodiment, the genus of structurally related chemical compounds does not embrace the biologically active chemical compound. In another further further embodiment, the genus of structurally related chemical compounds embraces the biologically active chemical compound. In another further further embodiment, the biologically active compound is a drug compound. In another further further embodiment, the biologically active chemical compound is a patented chemical compound.

In another further further embodiment, the business method further comprises the step, performed by a user, of analyzing the structure of said biologically active chemical compound, wherein said biologically active chemical compound is a patented pharmaceutical compound, in order to postulate the genus of structurally related target chemical compounds, such that one or more of the structurally related target chemical compounds of said genus are embraced by a patented genus of chemical compounds.

In a further further further embodiment, the business method comprises the steps, performed by a user, of: creating intellectual property using the chemical compound names and the enablement information; and offering the intellectual property for license or assignment to one or more licensees or assignees of one or more patents covering said patented pharmaceutical compound.

In a further further further further embodiment, the business method comprises the step, performed by a user, of publishing the intellectual property.

In another further embodiment, the business method comprises the step, performed by a user, of creating intellectual property by analyzing a biologically active chemical compound in order to create the data-object-creation data, such that said data-object-creation data is able to be used to create chemical compound names representing chemical compounds that are structurally similar to the biologically active chemical compound.

In a further further embodiment, the intellectual property is created inexpensively.

In a further further further embodiment, the cost of creating the intellectual property is less than one quarter of the revenue generated by the intellectual property. In another further further further embodiment, the cost of creating the intellectual property is less than five percent of the revenue generated by the intellectual property.

In another further further embodiment, the business method comprises the step, performed by a user, of providing utility information, where said utility information is used to establish the utility of one or more of the chemical compounds.

In a further further further embodiment, the utility information comprises information related to the utility of the biologically active chemical compound.

In another further further embodiment, the intellectual property comprises chemical compound species embraced by a chemical compound genus claimed in a competing patent or competing patent application.

In a further further further embodiment, the genus is represented as a Markush group. In another further further further embodiment, the intellectual property is an unfiled patent application. In another further further further embodiment, the intellectual property is a patent or patent application. In another further further further embodiment, the intellectual property is a statutory invention registration. In another further further further embodiment, the intellectual property is a trade secret.

In another further further embodiment, the intellectual property is blocking intellectual property, and the biologically active chemical compound is a prior-art chemical compound, and the business method further comprises the step, performed by a user, of offering to assign or license the blocking intellectual property; wherein the chemical compound names of the blocking intellectual property are chemical compound names of compounds structurally related to the prior-art chemical compound.

In a further further further embodiment, the business method comprises the step, performed by a user, of publishing the intellectual property.

In another embodiment, the set of data objects comprises more than twenty-five data objects. In another embodiment, the set of data objects comprises more than one hundred data objects. In another embodiment, the set of data objects comprises more than two hundred and fifty data objects. In another embodiment, the set of data objects comprises more than one thousand data objects. In another embodiment, the set of data objects comprises more than ten thousand data objects. In another embodiment, the set of data objects comprises more than fifty thousand data objects. In another embodiment, the set of data objects comprises more than one hundred thousand data objects. In another embodiment, the set of data objects comprises more than one million data objects. In another embodiment, the set of data objects comprises more than ten million data objects. In another embodiment, the set of data objects comprises more than one billion data objects. In another embodiment, the number of data objects in the set of data objects is greater than or equal to twenty-five and less than one hundred. In another embodiment, the number of data objects in the set of data objects is greater than or equal to one hundred and less than five hundred. In another embodiment, the number of data objects in the set of data objects is greater than or equal to five hundred and less than one thousand. In another embodiment, the number of data objects in the set of data objects is greater than or equal to one thousand and less than ten thousand. In another embodiment, the number of data objects in the set of data objects is greater than or equal to ten thousand and less than one hundred thousand. In another embodiment, the number of data objects in the set of data objects is greater than or equal to one hundred thousand and less than one million. In another embodiment, the number of data objects in the set of data objects is greater than or equal to one million and less than one billion.

In another embodiment, the set of variable strings resides in computer memory. In another embodiment, the set of variable strings is input by a user. In another embodiment, the set of variable strings has one subset of variable strings. In another embodiment, the set of variable strings has two subsets of variable strings. In another embodiment, the set of variable strings has at least three and no more than five subsets of variable strings. In another embodiment, the set of variable strings comprises six or more subsets of variable strings. In another embodiment, one or more of the variable strings of the set of variable strings are null strings.

In another embodiment, each of the data objects of the set of data objects has the same number of variable strings.

In a further embodiment, the data objects of the set of data objects each have the same number of variable strings from each subset of variable strings as every other data object of the set of data objects.

In a further further embodiment, each of the data objects of the set of data objects has one variable string from each of two subsets of variable strings. In another further further embodiment, each of the data objects of the set of data objects has one variable string from a first subset of variable strings, one variable string from a second subset of variable strings, and two variable strings from a third subset of variable strings.

In another further further embodiment, the variable strings within each subset of variable strings are ranked within that subset, and each subset of variable strings of the set of variable strings is ranked within the set of variable strings, such that, for the purpose of ranking the subsets of variable strings, where the data objects of the set of data objects have more than one variable string from a given subset of variable strings, that subset of variable strings is considered to be a different subset of variable strings for each occurrence of a variable string from that subset of variable strings within each data object of the set of data objects; and wherein:

the data objects of the set of data objects are created using an iterative process, whereby the first data object of the set of data objects is created using the first variable string of the first-ranked subset of variable strings, and the first variable string of each other ranked subset of variable strings used in creating said first data object; and the second data object of the set of data objects is created using the second variable string of the first-ranked subset of variable strings, and the first variable strings of each of the other ranked subsets of variable strings used in creating said second data object, such that the set of data objects so created comprises data objects representing all of the possible permutations of inclusions of variable strings within said data objects.

In a further further further embodiment, each of the data objects of the set of data objects has one variable string, wherein said variable string is from a subset of variable strings having twenty variable strings, and the number of data objects in the set of data objects so created is twenty.

In another further further further embodiment, each of the data objects of the set of data objects has three variable strings, wherein one of the variable strings is from a first subset of variable strings having ten variable strings, and where the first subset of variable strings is the first-ranked subset of variable strings, and the other two variable strings are from a second subset of variable strings having five variable strings, and where the second subset of variable strings is the second-ranked and third-ranked subsets of variable strings, and the number of data objects in the set of data objects so created is two hundred and fifty.

In another further further embodiment, the variable strings within each subset of variable strings are ranked within that subset, and each subset of variable strings of the set of variable strings is ranked within the set of variable strings, such that, for the purpose of ranking the subsets of variable strings, where the data objects of the set of data objects have more than one variable string from a given subset of variable strings, that subset of variable strings is considered to be a different subset of variable strings for each occurrence of a variable string from that subset of variable strings within each data object of the set of data objects; and wherein:

the data objects of the set of data objects are created using an iterative process, whereby a first prospective data object contains the first variable string of the first-ranked subset of variable strings, and the first variable string of each other ranked subset of variable strings used in creating said first prospective data object; and a second prospective data object contains the second variable string of the first-ranked subset of variable strings, and the first variable strings of each of the other ranked subsets of variable strings used in creating said second prospective data object; and continuing said iterative process such that all of the prospective data objects together comprise prospective data objects representing all of the possible permutations of inclusions of variable strings within said prospective data objects; and wherein said method further comprises the step, performed in a data processing system comprising one or more CPUs, of:

testing each prospective data object to determine whether the combination of variable strings within that prospective data object is a valid combination of such variable strings: where if the combination of variable strings is not a valid combination of variable strings, that prospective data object is not one of the data objects of the set of data objects; and where if the combination of variable strings is a valid combination of variable strings, that prospective data object is one of the data objects of the set of data objects.

In a further further further embodiment, a prospective data object is determined to contain an invalid combination of variable strings before all of the variable strings have been assigned to that prospective data object. In another further further further embodiment, all of the prospective data objects are created before the test is performed to determine which prospective data objects have an invalid combination of variable strings. In another further further further embodiment, a prospective data object is determined to comprise an invalid combination of variable strings based on a single variable string.

In another embodiment, the set of variable strings is input by a user. In another embodiment, one or more of the variable strings are input by a user. In another embodiment, one or more of the variable strings are input by a user and one or more of the variable strings are located in a file. In another embodiment, a user selects one or more of the variable strings of the set of variable strings from a group of variable strings located in a file.

In another embodiment, the set of variable strings is located in a file.

In a further embodiment, the file is a spreadsheet.

In a further further embodiment, each subset of variable strings of the set of variable strings is organized in a separate column in the spreadsheet.

In a further further further embodiment, each variable string of each subset of variable strings is organized in a different row in the spreadsheet.

In another further embodiment, the set of variable strings is incorporated into computer software.

In a further further embodiment, the computer software comprises a set of computer instructions used in making the data objects of the set of data objects.

In another embodiment, each of the data objects of the set of data objects has one variable string from each subset of variable strings of the set of variable strings. In another embodiment, one or more of the subsets of variable strings of the set of variable strings have one variable string. In another embodiment each data object of the set of data objects is created such that the variable strings within each data object are valid variable strings for that data object, such that no data object of the set of data objects is created that has one or more variable strings that are invalid for that data object.

In another embodiment, no input from a user occurs for the duration of the process of creating each of the data objects of the set of data objects. In another embodiment, the data processing system creates each of the data objects of the set of data objects using the data-object-creation data without input from a user.

In another embodiment, the duration of the process of creating the set of data objects using the data-object-creation data is less than one second. In another embodiment, the duration of the process of creating the set of data objects is greater than or equal to one second and less than one minute. In another embodiment, the duration of the process of creating the set of data objects is greater than or equal to one minute and less than ten minutes. In another embodiment, the duration of the process of creating the set of data objects is greater than or equal to ten minutes and less than one hour. In another embodiment, the duration of the process of creating the set of data objects is greater than or equal to one hour and less than one day. In another embodiment, the duration of the process of creating the set of data objects is greater than or equal to one day.

In another embodiment, one or more of the variable strings of the set of variable strings are excluded from one or more data objects of the set of data objects.

In a further embodiment, the data-object-creation data comprises information used in determining which variable strings are to be excluded from each of the data objects of the set of data objects.

In a further further embodiment, one or more of the variable strings of the set of variable strings are excluded from one or more of the data objects of the set of data objects, but not from all of the data objects of the set of data objects.

In another further embodiment, one or more of the variable strings of one or more of the subsets of variable strings of the set of variable strings are excluded from one or more of the data objects of the set of data objects.

In another further embodiment, the data-object-creation data comprises information used in determining which variable strings are to be excluded from each of the data objects of the set of data objects.

In a further further embodiment, one or more of the variable strings of the set of variable strings are excluded from one or more of the data objects of the set of data objects, but not from all of the data objects of the set of data objects.

In one embodiment, the invention is directed to a method, in a data processing system comprising one or more CPUs, of creating a set of data objects, wherein said set of data objects comprises one or more data objects, comprising the steps of:

providing data-object-creation data, wherein said data-object-creation data comprises a set of variable strings, wherein the set of variable strings comprises one or more subsets of variable strings, and wherein each subset of variable strings of the set of variable strings comprises one or more variable strings, and

creating each of the data objects of the set of data objects, using the data-object-creation data, such that each of the data objects of the set of data objects comprises one or more variable strings of the set of variable strings;

wherein the data-object-creation data comprises a template string, wherein said template string comprises a set of variable-directing strings, wherein said set of variable-directing strings comprises one or more variable-directing strings, and wherein said template string further comprises a set of exon strings, wherein the set of exon strings comprises one or more exon strings,

wherein each of the subsets of variable strings corresponds to one or more variable-directing strings of the set of variable-directing strings, such that each variable-directing string of the set of variable-directing strings has a corresponding subset of variable strings of the set of variable strings,

wherein the template string is used in the creation of each of the data objects of the set of data objects such that:

each of the data objects of the set of data objects comprises: every one of the exon strings of the set of exon strings; and one variable string of the corresponding subset of variable strings for each variable-directing string of the set of variable-directing strings;

wherein each of the variable-directing strings corresponds to a different variable-string locus within the data objects of the set of data objects, such that the number of variable-string loci within each of the data objects of the set of data objects is equal to the number of variable-directing strings of the set of variable-directing strings,

wherein each of the variable-string loci corresponds to the subset of variable strings that corresponds to that variable-string locus' variable-directing string,

and each of the variable-directing strings of the set of variable-directing strings is used to direct the placement of one of the variable strings from the corresponding subset of variable strings, at the variable-string locus corresponding to that variable-directing string, within each of the data objects of the set of data objects;

such that the set of data objects so created comprises all of the data objects representing all of the permutations of placements, at each of the variable-string loci, of each of the variable strings of the subset of variable strings corresponding to that variable-string locus.

In another embodiment, each of the variable strings of the set of variable strings comprises more than one letter. In another embodiment, one or more of the variable strings of the set of variable strings each comprise more than one letter. In another embodiment, each variable string of the set of variable strings is other than a single character representing one of the letters selected from a, t, g, c, and u. In another embodiment, each of one or more variable strings of the set of variable strings are other than a single character representing one of the letters selected from a, t, g, c, and u. In another embodiment, each of the variable strings of the set of variable strings comprises other than a single letter. In another embodiment, one or more of the variable strings of the set of variable strings each comprise more than one letter. In another embodiment, one or more of the variable strings of the set of variable strings represent other than a nucleic acid moiety. In another embodiment, one or more of the variable strings of the set of variable strings represent other than an amino acid moiety. In another embodiment, one or more of the variable strings of the set of variable strings represent other than a carbohydrate moiety.

In another embodiment, the data-object-creation data resides in computer memory. In another embodiment, the method comprises altering the physical composition of the data processing system. In another embodiment, one or more variable strings of the set of variable strings are the products of functions. In another embodiment, one or more variable strings of the set of variable strings are the products of functions in a spreadsheet. In another embodiment, one or more variable strings of the set of variable strings occupy cells in a spreadsheet. In another embodiment, one or more variable strings of the set of variable strings represent molecular weights.

In another embodiment, at least one of the data objects of the set of data objects comprises text.

In a further embodiment, each data object of the set of data objects comprises text.

In another embodiment, at least one of the data objects of the set of data objects comprises graphics.

In a further embodiment, each data object of the set of data objects comprises graphics.

In a further further embodiment, such graphics represent chemical structure.

In another embodiment, at least one of the data objects of the set of data objects comprises text and graphics.

In a further embodiment, each data object of the set of data objects comprises text and graphics.

In a further further embodiment, such graphics represent chemical structure.

In another embodiment, the method further comprises the step, performed in a data processing system comprising one or more CPUs, of: outputting one or more of the data objects of the set of data objects to a table.

In another embodiment, the invention is directed to a table comprising one or more of the data objects of the set of data objects.

In a further embodiment, said table comprises each data object of the set of data objects. In another further embodiment, said table comprises one or more of the data objects of the set of data objects such that each data object of the data objects comprised within the table is arranged in a different row of the table, and each variable string of each such data object is arranged in a different column in the row corresponding to that data object. In another further embodiment, said table comprises one or more of the data objects of the set of data objects such that each data object of the data objects comprised within the table is arranged in a different column of the table, and each variable string of each such data object is arranged in a different row in the column corresponding to that data object. In another further embodiment, said table comprises one or more items of graphics representing chemical structure. In another further embodiment, said table comprises one or more textual representations of chemical structure. In another further embodiment, the table resides in computer memory.

In another embodiment, the method further comprises the step, performed in a data processing system comprising one or more CPUs, of: outputting one or more data objects of the set of data objects to a document.

In a further embodiment, the order of components of one or more of the data objects so output to the document differs from the order of components of the corresponding data objects as-created. In another further embodiment, the order of components of the data objects so output to the document is the same as the order of components of the corresponding data objects as-created.

In another embodiment, the invention is directed to a document comprising one or more data objects of the set of data objects.

In a further embodiment, said document comprises each data object of the set of data objects. In another further embodiment, said document is published. In another further embodiment, said document is unpublished. In another further embodiment, said document is a printed document.

In another further embodiment, said document is an electronic document.

In a further further embodiment, the invention is directed to a method of creating a printed document, performed in a data processing system comprising one or more CPUs, comprising: providing the electronic document; and printing the electronic document using computer instructions to direct the physical process of printing the electronic document using a printer.

In another further embodiment, said document resides in computer memory. In another further embodiment, the invention is directed to computer storage media in which is stored said document.

In another further embodiment, the document is stored in a computer data base.

In a further further embodiment, the invention is directed to said computer data base.

In another further embodiment, the document is available via the internet.

In a further further embodiment, the document is a printed document available via the internet. In another further further embodiment, the document is an electronic document available via the internet. In another further further embodiment, the document is available over the internet using a password.

In another embodiment, the invention is directed to intellectual property comprising one or more data objects of the set of data objects.

In a further embodiment, the intellectual property is a patent application.

In a further further embodiment, the patent application is an unfiled patent application. In another further further embodiment, the patent application is a filed patent application. In another further further embodiment, the patent application is a provisional application. In another further further embodiment, the patent application is a non-provisional application. In another further further embodiment, the patent application is a statutory invention registration application.

In another further embodiment, the intellectual property is a patent. In another further embodiment, the intellectual property is a statutory invention registration. In another further embodiment, the intellectual property is a trade secret. In another further embodiment, the intellectual property is licensed intellectual property. In another further embodiment, the one or more data objects of the set of data objects comprised within the intellectual property represent inventive embodiments, and the intellectual property further comprises information regarding the enablement and utility of one or more of such inventive embodiments.

In another further embodiment, the one or more data objects of the set of data objects comprised within the intellectual property represent inventive embodiments, and the intellectual property further comprises information regarding enabling one of skill in the relevant art to make one or more of such inventive embodiments.

In a further further embodiment, said intellectual property is offered for license or assignment. In another further further embodiment, said intellectual property is a filed, unpublished patent application that is offered for license or assignment. In another further further embodiment, said intellectual property is a trade secret that is offered for license.

In another further further embodiment, one or more of the inventive embodiments are chemical compound names, and the intellectual property is a patent application comprising the chemical compound names, and one or more incorporations by reference to a previously-published reference.

In a further further further embodiment, the previously-published reference is a published patent application. In another further further further embodiment, the previously-published reference is an issued patent.

In another further further embodiment, one or more of the inventive embodiments are chemical compound names, wherein each of the chemical compound names represents a chemical compound, and wherein one or more of said chemical compounds represented by the chemical compound names are encompassed by a prior art genus of chemical compounds.

In a further further further embodiment, the prior art genus of chemical compounds is represented as a Markush group.

In another further further embodiment, the intellectual property is a blocking patent.

In a further further further embodiment, one or more of the inventive embodiments of the blocking patent are chemical compound names, and one or more of the chemical compound names of the blocking patent are embraced by a genus disclosed in a different patent or patent application.

In a further further further further embodiment, the genus is represented as a Markush group.

In another embodiment, the invention is directed to a business method, wherein said business method comprises the steps, performed by a user, of:

providing one or more of said data objects of said set of data objects, wherein one or more of the data objects so provided are inventive embodiments,

providing information related to enabling one of skill in the art to make one or more of such inventive embodiments, and

creating intellectual property using such provided data objects and information related to enabling one of skill in the art to make one or more of such inventive embodiments.

In a further embodiment, one or more of the provided data objects are chemical compound names.

In a further further embodiment, the chemical compounds represented by the chemical compound names are other than DNA compounds. In another further further embodiment, the chemical compounds represented by the chemical compound names are other than RNA compounds. In another further further embodiment, the chemical compounds represented by the chemical compound names are other than compounds having one or more mononucleotide moieties. In another further further embodiment, the chemical compounds represented by the chemical compound names are other than compounds having two or more mononucleotide moieties.

In another further further embodiment, the chemical compounds represented by the chemical compound names are other than polypeptides. In another further further embodiment, the chemical compounds represented by the chemical compound names are other than compounds having one or more peptide-linked amino acid moieties. In another further further embodiment, the chemical compounds represented by the chemical compound names are other than compounds having two or more peptide-linked amino acid moieties. In another further further embodiment, the chemical compounds represented by the chemical compound names are other than enzymes.

In another further further embodiment, the chemical compounds represented by the chemical compound names are other than sugars. In another further further embodiment, the chemical compounds represented by the chemical compound names are other than carbohydrates. In another further further embodiment, the chemical compounds represented by the chemical compound names are other than polysaccharides. In another further further embodiment, the chemical compounds represented by the chemical compound names are other than compounds having one or more monosaccharide moieties. In another further further embodiment, the chemical compounds represented by the chemical compound names are other than compounds having two or more glycoside-bond-linked monosaccharide moieties.

In another further further embodiment, the chemical compounds represented by the chemical compound names are other than polymers. In another further further embodiment, the chemical compounds represented by the chemical compound names are other than dendrimers.

In another further further embodiment, the chemical compounds represented by the chemical compound names are other than chemical compounds containing a sequence of subunits.

In a further further further embodiment, the sequence of subunits is linear, and each internal subunit comprises a first site of attachment to a first adjacent subunit, and a second site of attachment to a second adjacent subunit. In a further further further embodiment, each of the subunits is one of twenty possible subunits. In a further further further embodiment, each of the subunits is one of four possible subunits. In a further further further embodiment, each of the subunits is one of two or more possible subunits. In a further further further embodiment, each of the subunits is one of ten or more possible subunits. In a further further further embodiment, each of the subunits is one of twenty or more possible subunits. In a further further further embodiment, the sequence of subunits is branched.

In another further embodiment, the intellectual property comprises information regarding the utility of the inventive embodiments.

In another further embodiment, the business method comprises the step, performed by a user, of licensing the intellectual property.

In a further further embodiment, the invention is directed to said license.

In another further embodiment, the business method comprises the step, performed by a user, of enforcing the intellectual property.

In a further further embodiment, the invention is directed to a settlement or award resulting from enforcing the intellectual property.

In another further embodiment, the business method comprises the step, performed by a user, of assigning the intellectual property.

In a further further embodiment, the invention is directed to revenue realized from assigning the intellectual property.

In another further embodiment, the business method has the improvement of producing intellectual property comprising a large number of inventive embodiments in less time than by previous methods. In another further embodiment, the business method has the improvement of producing intellectual property comprising a large number of inventive embodiments at lower cost than by previous methods.

In a further further embodiment, the inventive embodiments fall within the scope of a genus disclosed within the intellectual property.

In a further further further embodiment, the genus is represented as a Markush group.

In another embodiment, the invention is directed to a business method, wherein said business method comprises the steps, performed in a data processing system comprising one or more CPUs, of:

creating a first set of data objects using the method of creating a set of data objects, such that the first set of data objects is a set of chemical-compound-name data objects, wherein said set of chemical-compound-name data objects comprises one or more chemical-compound-name data objects, and wherein each chemical-compound-name data object is a chemical compound name, wherein each chemical compound name represents a chemical compound; and

creating a second set of data objects using the method of creating a set of data objects, such that the second set of data objects is a set of chemical-compound-preparation data objects, wherein said set of chemical-compound-preparation data objects comprises one or more chemical-compound-preparation data objects, and wherein each chemical-compound-preparation data object is a chemical compound preparation, wherein one or more of the chemical compound preparations comprise information regarding the preparation of one or more of the chemical compounds represented by the chemical-compound-name data objects; and comprising the step, performed by a user, of:

creating intellectual property using one or more of the chemical compound names and one or more of the chemical compound preparations.

In a further embodiment, the intellectual property is licensed. In another further embodiment, the intellectual property is assigned. In another further embodiment, the intellectual property is a patent. In another further embodiment, the intellectual property is a statutory invention registration. In another further embodiment, the intellectual property is a patent application. In another further embodiment, the intellectual property is a trade secret. In another further embodiment, the business method has the improvement of producing intellectual property comprising a large number of chemical compound names and chemical compound preparations in less time than by previous methods. In another further embodiment, the business method has the improvement of producing intellectual property comprising a large number of chemical compound names and chemical compound preparations at lower cost than by previous methods.

In another further embodiment, the business method comprises the step, performed by a user, of licensing the intellectual property.

In a further further embodiment, the invention is directed to said license.

In another further embodiment, the business method comprises the step, performed by a user, of enforcing the intellectual property.

In a further further embodiment, the invention is directed to a settlement or award resulting from enforcing the intellectual property.

In another further embodiment, the business method comprises the step, performed by a user, of assigning the intellectual property.

In a further further embodiment, the invention is directed to revenue realized from assigning the intellectual property.

In another embodiment, the invention is directed to a business method, wherein said business method comprises the steps, performed by a user, of:

providing one or more of the data objects of said set of data objects, wherein one or more of the data objects so provided are chemical compound names, wherein each of the chemical compound names represents a chemical compound, and

providing enablement information, wherein said enablement information is information related to enabling one of skill in the art to make one or more of such chemical compounds.

In a further embodiment, the enablement information comprises one or more references. In another further embodiment, the enablement information comprises one or more chemical compound preparations. In another further embodiment, the enablement information is provided by the chemical compound names, such that one of skill in the art is able to make the chemical compounds without undue experimentation given the chemical compound names.

In another further embodiment, the business method comprises the step, performed by a user, of licensing the intellectual property.

In a further further embodiment, the invention is directed to said license.

In another further embodiment, the business method comprises the step, performed by a user, of enforcing the intellectual property.

In a further further embodiment, the invention is directed to a settlement or award resulting from enforcing the intellectual property.

In another further embodiment, the business method comprises the step, performed by a user, of assigning the intellectual property.

In a further further embodiment, the invention is directed to revenue realized from assigning the intellectual property.

In another further embodiment, the business method has the improvement of producing intellectual property comprising a large number of chemical compound names at lower cost and in less time than by previous methods.

In another further embodiment, the business method comprises the step, performed by a user, of providing utility information, where said utility information is used to establish the utility of one or more of the chemical compounds.

In a further further embodiment, one or more of the chemical compounds are structurally related to a biologically active chemical compound, and the utility information comprises information related to the utility of the biologically active chemical compound.

In a further further further embodiment, one or more of the chemical compounds and the biologically active chemical compound share a common utility.

In another further further embodiment, the utility information comprises information regarding two or more utilities.

In another further further embodiment, one or more of the chemical compounds have utility as a pharmaceutical and as a compound that is able to absorb ultraviolet light.

In a further further further embodiment, one or more of the chemical compounds have utility as an ultraviolet light absorbing dye.

In another further embodiment, the business method further comprises the step, performed by a user, of providing a file, wherein the file comprises the chemical compound names so provided and the enablement information. In another further embodiment, the number of data objects in the set of data objects is equal to or greater than one hundred. In another further embodiment, the number of data objects in the set of data objects is equal to or greater than one thousand. In another further embodiment, the number of data objects in the set of data objects is equal to or greater than one hundred thousand.

In another further embodiment, the business method further comprises the steps, performed by a user, of:

providing the structure of a biologically active chemical compound,

analyzing the structure of said biologically active chemical compound in order to postulate a genus of structurally related target chemical compounds, such that the names of each of the structurally related target chemical compounds of such genus each share one or more common chemical compound name fragments, and

analyzing the genus of structurally related target chemical compounds in order to select variable strings which are able to be used to create the chemical compound names, such that each chemical compound name represents one of the names of a structurally related target chemical compound embraced by the genus of structurally related target chemical compounds.

In a further further embodiment, the genus is represented as a Markush group. In another further further embodiment, the genus of structurally related chemical compounds does not embrace the biologically active chemical compound. In another further further embodiment, the genus of structurally related chemical compounds embraces the biologically active chemical compound. In another further further embodiment, the biologically active compound is a drug compound. In another further further embodiment, the biologically active chemical compound is a patented chemical compound.

In another further further embodiment, the business method further comprises the step, performed by a user, of analyzing the structure of said biologically active chemical compound, wherein said biologically active chemical compound is a patented pharmaceutical compound, in order to postulate the genus of structurally related target chemical compounds, such that one or more of the structurally related target chemical compounds of said genus are embraced by a patented genus of chemical compounds.

In a further further further embodiment, the business method comprises the steps, performed by a user, of: creating intellectual property using the chemical compound names and the enablement information; and offering the intellectual property for license or assignment to one or more licensees or assignees of one or more patents covering said patented pharmaceutical compound.

In a further further further further embodiment, the business method comprises the step, performed by a user, of publishing the intellectual property.

In another further embodiment, the business method comprises the step, performed by a user, of creating intellectual property by analyzing a biologically active chemical compound in order to create the data-object-creation data, such that said data-object-creation data is able to be used to create chemical compound names representing chemical compounds that are structurally similar to the biologically active chemical compound.

In a further further embodiment, the intellectual property is created inexpensively.

In a further further further embodiment, the cost of creating the intellectual property is less than one quarter of the revenue generated by the intellectual property. In another further further further embodiment, the cost of creating the intellectual property is less than five percent of the revenue generated by the intellectual property.

In another further further embodiment, the business method comprises the step, performed by a user, of providing utility information, where said utility information is used to establish the utility of one or more of the chemical compounds.

In a further further further embodiment, the utility information comprises information related to the utility of the biologically active chemical compound.

In another further further embodiment, the intellectual property comprises chemical compound species embraced by a chemical compound genus claimed in a competing patent or competing patent application.

In a further further further embodiment, the genus is represented as a Markush group. In another further further further embodiment, the intellectual property is an unfiled patent application. In another further further further embodiment, the intellectual property is a patent or patent application. In another further further further embodiment, the intellectual property is a statutory invention registration. In another further further further embodiment, the intellectual property is a trade secret.

In another further further embodiment, the intellectual property is blocking intellectual property, and the biologically active chemical compound is a prior-art chemical compound, and the business method further comprises the step, performed by a user, of offering to assign or license the blocking intellectual property; wherein the chemical compound names of the blocking intellectual property are chemical compound names of compounds structurally related to the prior-art chemical compound.

In a further further further embodiment, the business method comprises the step, performed by a user, of publishing the intellectual property.

In another embodiment, the set of data objects comprises more than twenty-five data objects. In another embodiment, the set of data objects comprises more than one hundred data objects. In another embodiment, the set of data objects comprises more than two hundred and fifty data objects. In another embodiment, the set of data objects comprises more than one thousand data objects. In another embodiment, the set of data objects comprises more than ten thousand data objects. In another embodiment, the set of data objects comprises more than fifty thousand data objects. In another embodiment, the set of data objects comprises more than one hundred thousand data objects. In another embodiment, the set of data objects comprises more than one million data objects. In another embodiment, the set of data objects comprises more than ten million data objects. In another embodiment, the set of data objects comprises more than one billion data objects. In another embodiment, the number of data objects in the set of data objects is greater than or equal to twenty-five and less than one hundred. In another embodiment, the number of data objects in the set of data objects is greater than or equal to one hundred and less than five hundred. In another embodiment, the number of data objects in the set of data objects is greater than or equal to five hundred and less than one thousand. In another embodiment, the number of data objects in the set of data objects is greater than or equal to one thousand and less than ten thousand. In another embodiment, the number of data objects in the set of data objects is greater than or equal to ten thousand and less than one hundred thousand. In another embodiment, the number of data objects in the set of data objects is greater than or equal to one hundred thousand and less than one million. In another embodiment, the number of data objects in the set of data objects is greater than or equal to one million and less than one billion.

In another embodiment, the set of variable strings resides in computer memory. In another embodiment, the set of variable strings is input by a user. In another embodiment, the set of variable strings has one subset of variable strings. In another embodiment, the set of variable strings has two subsets of variable strings. In another embodiment, the set of variable strings has at least three and no more than five subsets of variable strings. In another embodiment, the set of variable strings comprises six or more subsets of variable strings. In another embodiment, one or more of the variable strings of the set of variable strings are null strings.

In another embodiment, the set of variable strings is input by a user. In another embodiment, one or more of the variable strings are input by a user. In another embodiment, one or more of the variable strings are input by a user and one or more of the variable strings are located in a file. In another embodiment, a user selects one or more of the variable strings of the set of variable strings from a group of variable strings located in a file.

In another embodiment, the set of variable strings is located in a file.

In a further embodiment, the file is a spreadsheet.

In a further further embodiment, each subset of variable strings of the set of variable strings is organized in a separate column in the spreadsheet.

In a further further further embodiment, each variable string of each subset of variable strings is organized in a different row in the spreadsheet.

In another further embodiment, the set of variable strings is incorporated into computer software.

In a further further embodiment, the computer software comprises a set of computer instructions used in making the data objects of the set of data objects.

In another embodiment, each of the data objects of the set of data objects has one variable string from each subset of variable strings of the set of variable strings. In another embodiment, one or more of the subsets of variable strings of the set of variable strings have one variable string. In another embodiment each data object of the set of data objects is created such that the variable strings within each data object are valid variable strings for that data object, such that no data object of the set of data objects is created that has one or more variable strings that are invalid for that data object.

In another embodiment, no input from a user occurs for the duration of the process of creating each of the data objects of the set of data objects. In another embodiment, the data processing system creates each of the data objects of the set of data objects using the data-object-creation data without input from a user.

In another embodiment, the duration of the process of creating the set of data objects using the data-object-creation data is less than one second. In another embodiment, the duration of the process of creating the set of data objects is greater than or equal to one second and less than one minute. In another embodiment, the duration of the process of creating the set of data objects is greater than or equal to one minute and less than ten minutes. In another embodiment, the duration of the process of creating the set of data objects is greater than or equal to ten minutes and less than one hour. In another embodiment, the duration of the process of creating the set of data objects is greater than or equal to one hour and less than one day. In another embodiment, the duration of the process of creating the set of data objects is greater than or equal to one day.

In another embodiment, one or more of the variable strings of the set of variable strings are excluded from one or more data objects of the set of data objects.

In a further embodiment, the data-object-creation data comprises information used in determining which variable strings are to be excluded from each of the data objects of the set of data objects.

In a further further embodiment, one or more of the variable strings of the set of variable strings are excluded from one or more of the data objects of the set of data objects, but not from all of the data objects of the set of data objects.

In another further embodiment, one or more of the variable strings of one or more of the subsets of variable strings of the set of variable strings are excluded from one or more of the data objects of the set of data objects.

In another further embodiment, the data-object-creation data comprises information used in determining which variable strings are to be excluded from each of the data objects of the set of data objects.

In a further further embodiment, one or more of the variable strings of the set of variable strings are excluded from one or more of the data objects of the set of data objects, but not from all of the data objects of the set of data objects.

In one embodiment, the invention is directed to a computer program article of manufacture having a computer readable medium having computer program logic recorded thereon for creating a set of data objects comprising one or more data objects, said computer program article of manufacture comprising:

instruction means for receiving data-object-creation data, wherein said data-object-creation data comprises a set of variable strings, wherein said set of variable strings comprises one or more subsets of variable strings, and wherein each subset of variable strings comprises one or more variable strings, and

instruction means for using the data-object-creation data to create each one of the data objects of the set of data objects, such that each one of the data objects of the set of data objects comprises one or more variable strings of the set of variable strings.

In another embodiment, each of the variable strings of the set of variable strings comprises more than one letter. In another embodiment, one or more of the variable strings of the set of variable strings each comprise more than one letter. In another embodiment, each variable string of the set of variable strings is other than a single character representing one of the letters selected from a, t, g, c, and u. In another embodiment, each of one or more variable strings of the set of variable strings are other than a single character representing one of the letters selected from a, t, g, c, and u. In another embodiment, each of the variable strings of the set of variable strings comprises other than a single letter. In another embodiment, one or more of the variable strings of the set of variable strings each comprise more than one letter. In another embodiment, one or more of the variable strings of the set of variable strings represent other than a nucleic acid moiety. In another embodiment, one or more of the variable strings of the set of variable strings represent other than an amino acid moiety. In another embodiment, one or more of the variable strings of the set of variable strings represent other than a carbohydrate moiety.

In another embodiment, one or more variable strings of the set of variable strings are the product of a function. In another embodiment, one or more variable strings of the set of variable strings are the product of a function in a spreadsheet. In another embodiment, one or more variables of the set of variables occupy a cell in a spreadsheet. In another embodiment, one or more variables of the set of variables represent a molecular weight.

In another embodiment, at least one of the data objects of the set of data objects comprises text.

In a further embodiment, each data object of the set of data objects comprises text.

In another embodiment, at least one of the data objects of the set of data objects comprises graphics.

In a further embodiment, each data object of the set of data objects comprises graphics.

In a further further embodiment, such graphics represent chemical structure.

In another embodiment, at least one of the data objects of the set of data objects comprises text and graphics.

In a further embodiment, each data object of the set of data objects comprises text and graphics.

In a further further embodiment, such graphics represent chemical structure.

In another embodiment, the computer program article of manufacture further comprises an instruction means for outputting one or more of the data objects of the set of data objects to a table.

In another embodiment, the invention is directed to a table comprising one or more of the data objects created by the computer program article of manufacture.

In a further embodiment, said table comprises each data object of the set of data objects. In another further embodiment, said table comprises one or more of the data objects of the set of data objects such that each data object of the data objects comprised within the table is arranged in a different row of the table, and each variable string of each such data object is arranged in a different column in the row corresponding to that data object. In another further embodiment, said table comprises one or more of the data objects of the set of data objects such that each data object of the data objects comprised within the table is arranged in a different column of the table, and each variable string of each such data object is arranged in a different row in the column corresponding to that data object. In another further embodiment, said table comprises one or more items of graphics representing chemical structure. In another further embodiment, said table comprises one or more textual representations of chemical structure. In another further embodiment, the table resides in computer memory.

In another embodiment, the computer program article of manufacture further comprises an instruction means for outputting one or more data objects of the set of data objects to a document.

In a further embodiment, the order of components of one or more of the data objects so output to the document differs from the order of components of the corresponding data objects as-created. In another further embodiment, the order of components of the data objects so output to the document is the same as the order of components of the corresponding data objects as-created.

In another embodiment, the invention is directed to a document comprising one or more data objects of the set of data objects created using the computer program article of manufacture.

In a further embodiment, said document comprises each data object of the set of data objects. In another further embodiment, said document is published. In another further embodiment, said document is unpublished. In another further embodiment, said document is a printed document.

In another further embodiment, said document is an electronic document.

In a further further embodiment, the invention is directed to a method of creating a printed document, performed in a data processing system comprising one or more CPUs, comprising: providing the electronic document; and printing the electronic document using computer instructions to direct the physical process of printing the electronic document using a printer.

In another further embodiment, said document resides in computer memory. In another further embodiment, the invention is directed to computer storage media in which is stored said document.

In another further embodiment, the document is stored in a computer data base.

In a further further embodiment, the invention is directed to said computer data base.

In another further embodiment, the document is available via the internet.

In a further further embodiment, the document is a printed document available via the internet. In another further further embodiment, the document is an electronic document available via the internet. In another further further embodiment, the document is available over the internet using a password.

In another embodiment, the invention is directed to intellectual property comprising one or more data objects created using the computer program article of manufacture.

In a further embodiment, the intellectual property is a patent application.

In a further further embodiment, the patent application is an unfiled patent application. In another further further embodiment, the patent application is a filed patent application. In another further further embodiment, the patent application is a provisional application. In another further further embodiment, the patent application is a non-provisional application. In another further further embodiment, the patent application is a statutory invention registration application.

In another further embodiment, the intellectual property is a patent. In another further embodiment, the intellectual property is a statutory invention registration. In another further embodiment, the intellectual property is a trade secret. In another further embodiment, the intellectual property is licensed intellectual property. In another further embodiment, the one or more data objects of the set of data objects comprised within the intellectual property represent inventive embodiments, and the intellectual property further comprises information regarding the enablement and utility of one or more of such inventive embodiments.

In another further embodiment, the one or more data objects of the set of data objects comprised within the intellectual property represent inventive embodiments, and the intellectual property further comprises information regarding enabling one of skill in the relevant art to make one or more of such inventive embodiments.

In a further further embodiment, said intellectual property is offered for license or assignment. In another further further embodiment, said intellectual property is a filed, unpublished patent application that is offered for license or assignment. In another further further embodiment, said intellectual property is a trade secret that is offered for license.

In another further further embodiment, one or more of the inventive embodiments are chemical compound names, and the intellectual property is a patent application comprising the chemical compound names, and one or more incorporations by reference to a previously-published reference.

In a further further further embodiment, the previously-published reference is a published patent application. In another further further further embodiment, the previously-published reference is an issued patent.

In another further further embodiment, one or more of the inventive embodiments are chemical compound names, wherein each of the chemical compound names represents a chemical compound, and wherein one or more of said chemical compounds represented by the chemical compound names are encompassed by a prior art genus of chemical compounds.

In a further further further embodiment, the prior art genus of chemical compounds is represented as a Markush group.

In another further further embodiment, the intellectual property is a blocking patent.

In a further further further embodiment, one or more of the inventive embodiments of the blocking patent are chemical compound names, and one or more of the chemical compound names of the blocking patent are embraced by a genus disclosed in a different patent or patent application.

In a further further further further embodiment, the genus is represented as a Markush group.

In another embodiment, the invention is directed to a business method, wherein said business method comprises the steps, performed by a user, of:

providing one or more of said data objects of said set of data objects, wherein said data objects are created using the computer program article of manufacture, wherein one or more of the data objects so provided are inventive embodiments,

providing information related to enabling one of skill in the art to make one or more of such inventive embodiments, and

creating intellectual property using such provided data objects and information related to enabling one of skill in the art to make one or more of such inventive embodiments.

In a further embodiment, one or more of the provided data objects are chemical compound names.

In a further further embodiment, the chemical compounds represented by the chemical compound names are other than DNA compounds. In another further further embodiment, the chemical compounds represented by the chemical compound names are other than RNA compounds. In another further further embodiment, the chemical compounds represented by the chemical compound names are other than compounds having one or more mononucleotide moieties. In another further further embodiment, the chemical compounds represented by the chemical compound names are other than compounds having two or more mononucleotide moieties.

In another further further embodiment, the chemical compounds represented by the chemical compound names are other than polypeptides. In another further further embodiment, the chemical compounds represented by the chemical compound names are other than compounds having one or more peptide-linked amino acid moieties. In another further further embodiment, the chemical compounds represented by the chemical compound names are other than compounds having two or more peptide-linked amino acid moieties. In another further further embodiment, the chemical compounds represented by the chemical compound names are other than enzymes.

In another further further embodiment, the chemical compounds represented by the chemical compound names are other than sugars. In another further further embodiment, the chemical compounds represented by the chemical compound names are other than carbohydrates. In another further further embodiment, the chemical compounds represented by the chemical compound names are other than polysaccharides. In another further further embodiment, the chemical compounds represented by the chemical compound names are other than compounds having one or more monosaccharide moieties. In another further further embodiment, the chemical compounds represented by the chemical compound names are other than compounds having two or more glycoside-bond-linked monosaccharide moieties.

In another further further embodiment, the chemical compounds represented by the chemical compound names are other than polymers. In another further further embodiment, the chemical compounds represented by the chemical compound names are other than dendrimers.

In another further further embodiment, the chemical compounds represented by the chemical compound names are other than chemical compounds containing a sequence of subunits.

In a further further further embodiment, the sequence of subunits is linear, and each internal subunit comprises a first site of attachment to a first adjacent subunit, and a second site of attachment to a second adjacent subunit. In a further further further embodiment, each of the subunits is one of twenty possible subunits. In a further further further embodiment, each of the subunits is one of four possible subunits. In a further further further embodiment, each of the subunits is one of two or more possible subunits. In a further further further embodiment, each of the subunits is one of ten or more possible subunits. In a further further further embodiment, each of the subunits is one of twenty or more possible subunits. In a further further further embodiment, the sequence of subunits is branched.

In another further embodiment, the intellectual property comprises information regarding the utility of the inventive embodiments.

In another further embodiment, the business method comprises the step, performed by a user, of licensing the intellectual property.

In a further further embodiment, the invention is directed to said license.

In another further embodiment, the business method comprises the step, performed by a user, of enforcing the intellectual property.

In a further further embodiment, the invention is directed to a settlement or award resulting from enforcing the intellectual property.

In another further embodiment, the business method comprises the step, performed by a user, of assigning the intellectual property.

In a further further embodiment, the invention is directed to revenue realized from assigning the intellectual property.

In another further embodiment, the business method has the improvement of producing intellectual property comprising a large number of inventive embodiments in less time than by previous methods. In another further embodiment, the business method has the improvement of producing intellectual property comprising a large number of inventive embodiments at lower cost than by previous methods.

In a further further embodiment, the inventive embodiments fall within the scope of a genus disclosed within the intellectual property.

In a further further further embodiment, the genus is represented as a Markush group.

In another embodiment, the invention is directed to a business method, wherein said business method comprises the steps, performed in a data processing system comprising one or more CPUs, of:

creating a first set of data objects using the computer program article of manufacture, such that the first set of data objects is a set of chemical-compound-name data objects, wherein said set of chemical-compound-name data objects comprises one or more chemical-compound-name data objects, and wherein each chemical-compound-name data object is a chemical compound name, wherein each chemical compound name represents a chemical compound; and

creating a second set of data objects using the computer program article of manufacture, such that the second set of data objects is a set of chemical-compound-preparation data objects, wherein said set of chemical-compound-preparation data objects comprises one or more chemical-compound-preparation data objects, and wherein each chemical-compound-preparation data object is a chemical compound preparation, wherein one or more of the chemical compound preparations comprise information regarding the preparation of one or more of the chemical compounds represented by the chemical-compound-name data objects; and comprising the step, performed by a user, of:

creating intellectual property using one or more of the chemical compound names and one or more of the chemical compound preparations.

In a further embodiment, the intellectual property is licensed. In another further embodiment, the intellectual property is assigned. In another further embodiment, the intellectual property is a patent. In another further embodiment, the intellectual property is a statutory invention registration. In another further embodiment, the intellectual property is a patent application. In another further embodiment, the intellectual property is a trade secret. In another further embodiment, the business method has the improvement of producing intellectual property comprising a large number of chemical compound names and chemical compound preparations in less time than by previous methods. In another further embodiment, the business method has the improvement of producing intellectual property comprising a large number of chemical compound names and chemical compound preparations at lower cost than by previous methods.

In another further embodiment, the business method comprises the step, performed by a user, of licensing the intellectual property.

In a further further embodiment, the invention is directed to said license.

In another further embodiment, the business method comprises the step, performed by a user, of enforcing the intellectual property.

In a further further embodiment, the invention is directed to a settlement or award resulting from enforcing the intellectual property.

In another further embodiment, the business method comprises the step, performed by a user, of assigning the intellectual property.

In a further further embodiment, the invention is directed to revenue realized from assigning the intellectual property.

In another embodiment, the invention is directed to a business method, wherein said business method comprises the steps, performed by a user, of:

providing one or more of the data objects of said set of data objects created using the computer program article of manufacture, wherein one or more of the data objects so provided are chemical compound names, wherein each of the chemical compound names represents a chemical compound, and

providing enablement information, wherein said enablement information is information related to enabling one of skill in the art to make one or more of such chemical compounds.

In a further embodiment, the enablement information comprises one or more references. In another further embodiment, the enablement information comprises one or more chemical compound preparations. In another further embodiment, the enablement information is provided by the chemical compound names, such that one of skill in the art is able to make the chemical compounds without undue experimentation given the chemical compound names.

In another further embodiment, the business method comprises the step, performed by a user, of licensing the intellectual property.

In a further further embodiment, the invention is directed to said license.

In another further embodiment, the business method comprises the step, performed by a user, of enforcing the intellectual property.

In a further further embodiment, the invention is directed to a settlement or award resulting from enforcing the intellectual property.

In another further embodiment, the business method comprises the step, performed by a user, of assigning the intellectual property.

In a further further embodiment, the invention is directed to revenue realized from assigning the intellectual property.

In another further embodiment, the business method has the improvement of producing intellectual property comprising a large number of chemical compound names at lower cost and in less time than by previous methods.

In another further embodiment, the business method comprises the step, performed by a user, of providing utility information, where said utility information is used to establish the utility of one or more of the chemical compounds.

In a further further embodiment, one or more of the chemical compounds are structurally related to a biologically active chemical compound, and the utility information comprises information related to the utility of the biologically active chemical compound.

In a further further further embodiment, one or more of the chemical compounds and the biologically active chemical compound share a common utility.

In another further further embodiment, the utility information comprises information regarding two or more utilities.

In another further further embodiment, one or more of the chemical compounds have utility as a pharmaceutical and as a compound that is able to absorb ultraviolet light.

In a further further further embodiment, one or more of the chemical compounds have utility as an ultraviolet light absorbing dye.

In another further embodiment, the business method further comprises the step, performed by a user, of providing a file, wherein the file comprises the chemical compound names so provided and the enablement information. In another further embodiment, the number of data objects in the set of data objects is equal to or greater than one hundred. In another further embodiment, the number of data objects in the set of data objects is equal to or greater than one thousand. In another further embodiment, the number of data objects in the set of data objects is equal to or greater than one hundred thousand.

In another further embodiment, the business method further comprises the steps, performed by a user, of:

providing the structure of a biologically active chemical compound,

analyzing the structure of said biologically active chemical compound in order to postulate a genus of structurally related target chemical compounds, such that the names of each of the structurally related target chemical compounds of such genus each share one or more common chemical compound name fragments, and

analyzing the genus of structurally related target chemical compounds in order to select variable strings which are able to be used to create the chemical compound names, such that each chemical compound name represents one of the names of a structurally related target chemical compound embraced by the genus of structurally related target chemical compounds.

In a further further embodiment, the genus of structurally related chemical compounds is represented as a Markush group. In another further further embodiment, the genus of structurally related chemical compounds does not embrace the biologically active chemical compound. In another further further embodiment, the genus of structurally related chemical compounds embraces the biologically active chemical compound. In another further further embodiment, the biologically active compound is a drug compound. In another further further embodiment, the biologically active chemical compound is a patented chemical compound.

In another further further embodiment, the business method further comprises the step, performed by a user, of analyzing the structure of said biologically active chemical compound, wherein said biologically active chemical compound is a patented pharmaceutical compound, in order to postulate the genus of structurally related target chemical compounds, such that one or more of the structurally related target chemical compounds of said genus are embraced by a patented genus of chemical compounds.

In a further further further embodiment, the business method comprises the steps, performed by a user, of: creating intellectual property using the chemical compound names and the enablement information; and offering the intellectual property for license or assignment to one or more licensees or assignees of one or more patents covering said patented pharmaceutical compound.

In a further further further further embodiment, the business method comprises the step, performed by a user, of publishing the intellectual property.

In another further embodiment, the business method comprises the step, performed by a user, of creating intellectual property by analyzing a biologically active chemical compound in order to create the data-object-creation data, such that said data-object-creation data is able to be used to create chemical compound names representing chemical compounds that are structurally similar to the biologically active chemical compound.

In a further further embodiment, the intellectual property is created inexpensively.

In a further further further embodiment, the cost of creating the intellectual property is less than one quarter of the revenue generated by the intellectual property. In another further further further embodiment, the cost of creating the intellectual property is less than five percent of the revenue generated by the intellectual property.

In another further further embodiment, the business method comprises the step, performed by a user, of providing utility information, where said utility information is used to establish the utility of one or more of the chemical compounds.

In a further further further embodiment, the utility information comprises information related to the utility of the biologically active chemical compound.

In another further further embodiment, the intellectual property comprises chemical compound species embraced by a chemical compound genus claimed in a competing patent or competing patent application.

In a further further further embodiment, the genus is represented as a Markush group. In another further further further embodiment, the intellectual property is an unfiled patent application. In another further further further embodiment, the intellectual property is a patent or patent application. In another further further further embodiment, the intellectual property is a statutory invention registration. In another further further further embodiment, the intellectual property is a trade secret.

In another further further embodiment, the intellectual property is blocking intellectual property, and the biologically active chemical compound is a prior-art chemical compound, and the business method further comprises the step, performed by a user, of offering to assign or license the blocking intellectual property; wherein the chemical compound names of the blocking intellectual property are chemical compound names of compounds structurally related to the prior-art chemical compound.

In a further further further embodiment, the business method comprises the step, performed by a user, of publishing the intellectual property.

In another embodiment, the set of variable strings resides in computer memory. In another embodiment, the set of variable strings is input by a user. In another embodiment, the set of variable strings has one subset of variable strings. In another embodiment, the set of variable strings has two subsets of variable strings. In another embodiment, the set of variable strings has at least three and no more than five subsets of variable strings. In another embodiment, the set of variable strings comprises six or more subsets of variable strings. In another embodiment, one or more of the variable strings of the set of variable strings are null strings.

In another embodiment, the set of variable strings is input by a user. In another embodiment, one or more of the variable strings are input by a user. In another embodiment, one or more of the variable strings are input by a user and one or more of the variable strings are located in a file. In another embodiment, a user selects one or more of the variable strings of the set of variable strings from a group of variable strings located in a file.

In another embodiment, the set of variable strings is located in a file.

In a further embodiment, the file is a spreadsheet.

In a further further embodiment, each subset of variable strings of the set of variable strings is organized in a separate column in the spreadsheet.

In a further further further embodiment, each variable string of each subset of variable strings is organized in a different row in the spreadsheet.

In another further embodiment, the set of variable strings is incorporated into computer software.

In a further further embodiment, the computer software comprises a set of computer instructions used in making the data objects of the set of data objects.

In another embodiment each data object of the set of data objects is created using the computer program article of manufacture such that the variable strings within each data object are valid variable strings for that data object, such that no data object of the set of data objects is created that has one or more variable strings that are invalid for that data object. In another embodiment, no input from a user occurs for the duration of the process of creating each of the data objects of the set of data objects. In another embodiment, the data processing system creates each of the data objects of the set of data objects using the data-object-creation data without input from a user.

In another embodiment, the duration of the process of creating the set of data objects using the data-object-creation data is less than one second. In another embodiment, the duration of the process of creating the set of data objects is greater than or equal to one second and less than one minute. In another embodiment, the duration of the process of creating the set of data objects is greater than or equal to one minute and less than ten minutes. In another embodiment, the duration of the process of creating the set of data objects is greater than or equal to ten minutes and less than one hour. In another embodiment, the duration of the process of creating the set of data objects is greater than or equal to one hour and less than one day. In another embodiment, the duration of the process of creating the set of data objects is greater than or equal to one day.

In another embodiment, one or more of the variable strings of the set of variable strings are excluded from one or more data objects of the set of data objects.

In a further embodiment, the data-object-creation data comprises information used in determining which variable strings are to be excluded from each of the data objects of the set of data objects.

In a further further embodiment, one or more of the variable strings of the set of variable strings are excluded from one or more of the data objects of the set of data objects, but not from all of the data objects of the set of data objects.

In another further embodiment, one or more of the variable strings of one or more of the subsets of variable strings of the set of variable strings are excluded from one or more of the data objects of the set of data objects.

In another further embodiment, the data-object-creation data comprises information used in determining which variable strings are to be excluded from each of the data objects of the set of data objects.

In a further further embodiment, one or more of the variable strings of the set of variable strings are excluded from one or more of the data objects of the set of data objects, but not from all of the data objects of the set of data objects.

In another embodiment, the data-object-creation data comprises a template string, wherein said template string comprises a set of variable-directing strings, wherein said set of variable-directing strings comprises one or more variable-directing strings, and wherein said template string further comprises a set of exon strings, wherein the set of exon strings comprises one or more exon strings,

wherein one or more of the variable-directing strings of the set of variable-directing strings corresponds to one of the subsets of variable strings of the set of variable strings, such that each variable-directing string of the set of variable-directing strings corresponds to one of the subsets of variable strings of the set of variable strings,

wherein said computer program article of manufacture further comprises:

instruction means for creating each one of the data objects of the set of data objects using the template string such that:

each one of the data objects of the set of data objects comprises each one of the exon strings of the set of exon strings, and one variable string of the set of variable strings for each variable-directing string of the set of variable-directing strings;

wherein each one of the variable-directing strings corresponds to a different variable-string locus within the data objects of the set of data objects, such that the number of variable-string loci within each one of the data objects of the set of data objects is equal to the number of variable-directing strings of the set of variable-directing strings,

wherein each one of the variable-string loci corresponds to the subset of variable strings that corresponds to that variable-string locus' variable-directing string,

wherein said computer program article of manufacture further comprises:

instruction means for directing the placement, using each one of the variable-directing strings of the set of variable-directing strings, of one of the variable strings from the corresponding subset of variable strings, at the variable string locus corresponding to that variable-directing string, within each one of the data objects of the set of data objects,

such that the set of data objects so created comprises all of the data objects representing all of the permutations of placements, at each one of the variable-string loci, of a different variable string of the subset of variable strings corresponding to that variable-string locus;

wherein said computer program article of manufacture further comprises:

instruction means for outputting the set of data objects.

In another embodiment, one or more of the data objects of the set of data objects are chemical compound names, and

wherein the set of data-object-creation data comprises a template string, wherein said template string comprises a set of variable-directing strings, wherein the set of variable-directing strings comprises one or more variable-directing strings,

wherein said computer program article of manufacture comprises:

instruction means for receiving said template string, and

instruction means for creating each one of the chemical compound names of the set of chemical compound names, using the template string as a template, by using each one of the variable-directing strings in the set of variable-directing strings of the template string to direct the replacement of that variable-directing string with one of the variable strings of the set of variable strings.

In one embodiment, the invention is directed to a business method for acquiring intellectual property comprising the steps, performed in a data processing system comprising one or more CPUs, of:

providing data-object-creation data, wherein said data-object-creation data comprises a set of variable strings, wherein the set of variable strings comprises one or more subsets of variable strings, and wherein each subset of variable strings of the set of variable strings comprises one or more variable strings,

creating a set of data objects, wherein the set of data objects comprises one or more data objects, using the data-object-creation data, such that each of the data objects of the set of data objects comprises one or more variable strings of the set of variable strings; wherein the data objects of the set of data objects are inventive embodiments; and comprising the step, performed by a user, of:

creating the intellectual property using one or more of the inventive embodiments.

In another embodiment, each of the variable strings of the set of variable strings comprises more than one letter. In another embodiment, one or more of the variable strings of the set of variable strings each comprise more than one letter. In another embodiment, each variable string of the set of variable strings is other than a single character representing one of the letters selected from a, t, g, c, and u. In another embodiment, each of one or more variable strings of the set of variable strings are other than a single character representing one of the letters selected from a, t, g, c, and u. In another embodiment, each of the variable strings of the set of variable strings comprises other than a single letter. In another embodiment, one or more of the variable strings of the set of variable strings each comprise more than one letter. In another embodiment, one or more of the variable strings of the set of variable strings represent other than a nucleic acid moiety. In another embodiment, one or more of the variable strings of the set of variable strings represent other than an amino acid moiety. In another embodiment, one or more of the variable strings of the set of variable strings represent other than a carbohydrate moiety.

In another embodiment, one or more of the inventive embodiments are chemical compound names, wherein each chemical compound name represents a chemical compound, and wherein the business method comprises: creating the intellectual property using one or more of the chemical compound names and information related to enabling one of skill in the art to make one or more of the chemical compounds represented by the chemical compound names.

In a further embodiment, the chemical compounds represented by the chemical compound names are other than DNA compounds. In another further embodiment, the chemical compounds represented by the chemical compound names are other than RNA compounds. In another further embodiment, the chemical compounds represented by the chemical compound names are other than compounds having one or more mononucleotide moieties. In another further embodiment, the chemical compounds represented by the chemical compound names are other than compounds having two or more mononucleotide moieties.

In another further embodiment, the chemical compounds represented by the chemical compound names are other than polypeptides. In another further embodiment, the chemical compounds represented by the chemical compound names are other than compounds having one or more peptide-linked amino acid moieties. In another further embodiment, the chemical compounds represented by the chemical compound names are other than compounds having two or more peptide-linked amino acid moieties. In another further embodiment, the chemical compounds represented by the chemical compound names are other than enzymes.

In another further embodiment, the chemical compounds represented by the chemical compound names are other than sugars. In another further embodiment, the chemical compounds represented by the chemical compound names are other than carbohydrates. In another further embodiment, the chemical compounds represented by the chemical compound names are other than polysaccharides. In another further embodiment, the chemical compounds represented by the chemical compound names are other than compounds having one or more monosaccharide moieties. In another further embodiment, the chemical compounds represented by the chemical compound names are other than compounds having two or more glycoside-bond-linked monosaccharide moieties.

In another further embodiment, the chemical compounds represented by the chemical compound names are other than polymers. In another further embodiment, the chemical compounds represented by the chemical compound names are other than dendrimers.

In another further embodiment, the chemical compounds represented by the chemical compound names are other than chemical compounds containing a sequence of subunits.

In a further further embodiment, the sequence of subunits is linear, and each internal subunit comprises a first site of attachment to a first adjacent subunit, and a second site of attachment to a second adjacent subunit. In a further further embodiment, each of the subunits is one of twenty possible subunits. In a further further embodiment, each of the subunits is one of four possible subunits. In a further further embodiment, each of the subunits is one of two or more possible subunits. In a further further embodiment, each of the subunits is one of ten or more possible subunits. In a further further embodiment, each of the subunits is one of twenty or more possible subunits. In a further further embodiment, the sequence of subunits is branched.

In another embodiment, one or more of the inventive embodiments are genera of chemical compounds, and wherein the business method further comprises: creating the intellectual property using one or more of the genera of chemical compounds and information related to enabling one of skill in the art to make one or more of the chemical compounds embraced by one or more of the genera of chemical compounds. In another embodiment, the inventive embodiments are chemical compound preparations.

In another embodiment, the business method comprises the step, performed by a user, of licensing the intellectual property.

In a further embodiment, the invention is directed to said license.

In another embodiment, the business method comprises the step, performed by a user, of enforcing the intellectual property.

In a further embodiment, the invention is directed to a settlement or award resulting from enforcing the intellectual property.

In another embodiment, the business method comprises the step, performed by a user, of assigning the intellectual property.

In a further embodiment, the invention is directed to revenue realized from assigning the intellectual property.

In another embodiment, the data-object-creation data resides in computer memory. In another embodiment, the method comprises altering the physical composition of the data processing system. In another embodiment, one or more variable strings of the set of variable strings are the products of functions. In another embodiment, one or more variable strings of the set of variable strings are the products of functions in a spreadsheet. In another embodiment, one or more variable strings of the set of variable strings occupy cells in a spreadsheet. In another embodiment, one or more variable strings of the set of variable strings represent molecular weights.

In another embodiment, at least one of the data objects of the set of data objects comprises text.

In a further embodiment, each data object of the set of data objects comprises text.

In another embodiment, at least one of the data objects of the set of data objects comprises graphics.

In a further embodiment, each data object of the set of data objects comprises graphics.

In a further further embodiment, such graphics represent chemical structure.

In another embodiment, at least one of the data objects of the set of data objects comprises text and graphics.

In a further embodiment, each data object of the set of data objects comprises text and graphics.

In a further further embodiment, such graphics represent chemical structure.

In another embodiment, the method further comprises the step, performed in a data processing system comprising one or more CPUs, of: outputting one or more of the data objects of the set of data objects to a table.

In another embodiment, the invention is directed to a table comprising one or more of the data objects of the set of data objects.

In a further embodiment, said table comprises each data object of the set of data objects. In another further embodiment, said table comprises one or more of the data objects of the set of data objects such that each data object of the data objects comprised within the table is arranged in a different row of the table, and each variable string of each such data object is arranged in a different column in the row corresponding to that data object. In another further embodiment, said table comprises one or more of the data objects of the set of data objects such that each data object of the data objects comprised within the table is arranged in a different column of the table, and each variable string of each such data object is arranged in a different row in the column corresponding to that data object. In another further embodiment, said table comprises one or more items of graphics representing chemical structure. In another further embodiment, said table comprises one or more textual representations of chemical structure. In another further embodiment, the table resides in computer memory.

In another embodiment, the method further comprises the step, performed in a data processing system comprising one or more CPUs, of: outputting one or more data objects of the set of data objects to a document, wherein the intellectual property is creating using the document.

In a further embodiment, the order of components of one or more of the data objects so output to the document differs from the order of components of the corresponding data objects as-created. In another further embodiment, the order of components of the data objects so output to the document is the same as the order of components of the corresponding data objects as-created.

In another embodiment, the invention is directed to a document comprising one or more data objects of the set of data objects.

In a further embodiment, said document comprises each data object of the set of data objects. In another further embodiment, said document is published. In another further embodiment, said document is unpublished. In another further embodiment, said document is a printed document.

In another further embodiment, said document is an electronic document.

In a further further embodiment, the invention is directed to a method of creating a printed document, performed in a data processing system comprising one or more CPUs, comprising: providing the electronic document; and printing the electronic document using computer instructions to direct the physical process of printing the electronic document using a printer.

In another further embodiment, said document resides in computer memory. In another further embodiment, the invention is directed to computer storage media in which is stored said document.

In another further embodiment, the document is stored in a computer data base.

In a further further embodiment, the invention is directed to said computer data base.

In another further embodiment, the document is available via the internet.

In a further further embodiment, the document is a printed document available via the internet. In another further further embodiment, the document is an electronic document available via the internet. In another further further embodiment, the document is available over the internet using a password.

In another embodiment, the invention is directed to intellectual property comprising one or more data objects of the set of data objects.

In a further embodiment, the intellectual property is a patent application.

In a further further embodiment, the patent application is an unfiled patent application. In another further further embodiment, the patent application is a filed patent application. In another further further embodiment, the patent application is a provisional application. In another further further embodiment, the patent application is a non-provisional application. In another further further embodiment, the patent application is a statutory invention registration application.

In another further embodiment, the intellectual property is a patent. In another further embodiment, the intellectual property is a statutory invention registration. In another further embodiment, the intellectual property is a trade secret. In another further embodiment, the intellectual property is licensed intellectual property. In another further embodiment, the one or more data objects of the set of data objects comprised within the intellectual property represent inventive embodiments, and the intellectual property further comprises information regarding the enablement and utility of one or more of such inventive embodiments.

In another further embodiment, the one or more data objects of the set of data objects comprised within the intellectual property represent inventive embodiments, and the intellectual property further comprises information regarding enabling one of skill in the relevant art to make one or more of such inventive embodiments.

In a further further embodiment, said intellectual property is offered for license or assignment.

In a further further further embodiment, the business method comprises the step, performed by a user, of publishing the intellectual property.

In another further further embodiment, said intellectual property is a filed, unpublished patent application that is offered for license or assignment. In another further further embodiment, said intellectual property is a trade secret that is offered for license.

In another further further embodiment, one or more of the inventive embodiments are chemical compound names, and the intellectual property is a patent application comprising the chemical compound names, and one or more incorporations by reference to a previously-published reference.

In a further further further embodiment, the previously-published reference is a published patent application. In another further further further embodiment, the previously-published reference is an issued patent.

In another further further embodiment, one or more of the inventive embodiments are chemical compound names, wherein each of the chemical compound names represents a chemical compound, and wherein one or more of said chemical compounds represented by the chemical compound names are encompassed by a prior art genus of chemical compounds.

In a further further further embodiment, the prior art genus of chemical compounds is represented as a Markush group.

In another further further embodiment, the intellectual property is a blocking patent.

In a further further further embodiment, one or more of the inventive embodiments of the blocking patent are chemical compound names, and one or more of the chemical compound names of the blocking patent are embraced by a genus disclosed in a different patent or patent application.

In a further further further further embodiment, the genus is represented as a Markush group.

In another embodiment, the set of data objects comprises more than twenty-five data objects. In another embodiment, the set of data objects comprises more than one hundred data objects. In another embodiment, the set of data objects comprises more than two hundred and fifty data objects. In another embodiment, the set of data objects comprises more than one thousand data objects. In another embodiment, the set of data objects comprises more than ten thousand data objects. In another embodiment, the set of data objects comprises more than fifty thousand data objects. In another embodiment, the set of data objects comprises more than one hundred thousand data objects. In another embodiment, the set of data objects comprises more than one million data objects. In another embodiment, the set of data objects comprises more than ten million data objects. In another embodiment, the set of data objects comprises more than one billion data objects. In another embodiment, the number of data objects in the set of data objects is greater than or equal to twenty-five and less than one hundred. In another embodiment, the number of data objects in the set of data objects is greater than or equal to one hundred and less than five hundred. In another embodiment, the number of data objects in the set of data objects is greater than or equal to five hundred and less than one thousand. In another embodiment, the number of data objects in the set of data objects is greater than or equal to one thousand and less than ten thousand. In another embodiment, the number of data objects in the set of data objects is greater than or equal to ten thousand and less than one hundred thousand. In another embodiment, the number of data objects in the set of data objects is greater than or equal to one hundred thousand and less than one million. In another embodiment, the number of data objects in the set of data objects is greater than or equal to one million and less than one billion.

In another embodiment, the set of variable strings resides in computer memory. In another embodiment, the set of variable strings is input by a user. In another embodiment, the set of variable strings has one subset of variable strings. In another embodiment, the set of variable strings has two subsets of variable strings. In another embodiment, the set of variable strings has at least three and no more than five subsets of variable strings. In another embodiment, the set of variable strings comprises six or more subsets of variable strings. In another embodiment, one or more of the variable strings of the set of variable strings are null strings.

In another embodiment, each of the data objects of the set of data objects has the same number of variable strings.

In a further embodiment, the data objects of the set of data objects each have the same number of variable strings from each subset of variable strings as every other data object of the set of data objects.

In a further further embodiment, each of the data objects of the set of data objects has one variable string from each of two subsets of variable strings. In another further further embodiment, each of the data objects of the set of data objects has one variable string from a first subset of variable strings, one variable string from a second subset of variable strings, and two variable strings from a third subset of variable strings.

In another further further embodiment, the variable strings within each subset of variable strings are ranked within that subset, and each subset of variable strings of the set of variable strings is ranked within the set of variable strings, such that, for the purpose of ranking the subsets of variable strings, where the data objects of the set of data objects have more than one variable string from a given subset of variable strings, that subset of variable strings is considered to be a different subset of variable strings for each occurrence of a variable string from that subset of variable strings within each data object of the set of data objects; and wherein:

the data objects of the set of data objects are created using an iterative process, whereby the first data object of the set of data objects is created using the first variable string of the first-ranked subset of variable strings, and the first variable string of each other ranked subset of variable strings used in creating said first data object; and the second data object of the set of data objects is created using the second variable string of the first-ranked subset of variable strings, and the first variable strings of each of the other ranked subsets of variable strings used in creating said second data object, such that the set of data objects so created comprises data objects representing all of the possible permutations of inclusions of variable strings within said data objects.

In a further further further embodiment, each of the data objects of the set of data objects has one variable string, wherein said variable string is from a subset of variable strings having twenty variable strings, and the number of data objects in the set of data objects so created is twenty.

In another further further further embodiment, each of the data objects of the set of data objects has three variable strings, wherein one of the variable strings is from a first subset of variable strings having ten variable strings, and where the first subset of variable strings is the first-ranked subset of variable strings, and the other two variable strings are from a second subset of variable strings having five variable strings, and where the second subset of variable strings is the second-ranked and third-ranked subsets of variable strings, and the number of data objects in the set of data objects so created is two hundred and fifty.

In another further further embodiment, the variable strings within each subset of variable strings are ranked within that subset, and each subset of variable strings of the set of variable strings is ranked within the set of variable strings, such that, for the purpose of ranking the subsets of variable strings, where the data objects of the set of data objects have more than one variable string from a given subset of variable strings, that subset of variable strings is considered to be a different subset of variable strings for each occurrence of a variable string from that subset of variable strings within each data object of the set of data objects; and wherein:

the data objects of the set of data objects are created using an iterative process, whereby a first prospective data object contains the first variable string of the first-ranked subset of variable strings, and the first variable string of each other ranked subset of variable strings used in creating said first prospective data object; and a second prospective data object contains the second variable string of the first-ranked subset of variable strings, and the first variable strings of each of the other ranked subsets of variable strings used in creating said second prospective data object; and continuing said iterative process such that all of the prospective data objects together comprise prospective data objects representing all of the possible permutations of inclusions of variable strings within said prospective data objects; and wherein said method further comprises the step, performed in a data processing system comprising one or more CPUs, of:

testing each prospective data object to determine whether the combination of variable strings within that prospective data object is a valid combination of such variable strings: where if the combination of variable strings is not a valid combination of variable strings, that prospective data object is not one of the data objects of the set of data objects; and where if the combination of variable strings is a valid combination of variable strings, that prospective data object is one of the data objects of the set of data objects.

In a further further further embodiment, a prospective data object is determined to contain an invalid combination of variable strings before all of the variable strings have been assigned to that prospective data object. In another further further further embodiment, all of the prospective data objects are created before the test is performed to determine which prospective data objects have an invalid combination of variable strings. In another further further further embodiment, a prospective data object is determined to comprise an invalid combination of variable strings based on a single variable string.

In another embodiment, the set of variable strings is input by a user. In another embodiment, one or more of the variable strings are input by a user. In another embodiment, one or more of the variable strings are input by a user and one or more of the variable strings are located in a file. In another embodiment, a user selects one or more of the variable strings of the set of variable strings from a group of variable strings located in a file.

In another embodiment, the set of variable strings is located in a file.

In a further embodiment, the file is a spreadsheet.

In a further further embodiment, each subset of variable strings of the set of variable strings is organized in a separate column in the spreadsheet.

In a further further further embodiment, each variable string of each subset of variable strings is organized in a different row in the spreadsheet.

In another further embodiment, the set of variable strings is incorporated into computer software.

In a further further embodiment, the computer software comprises a set of computer instructions used in making the data objects of the set of data objects.

In another embodiment, each of the data objects of the set of data objects has one variable string from each subset of variable strings of the set of variable strings. In another embodiment, one or more of the subsets of variable strings of the set of variable strings have one variable string. In another embodiment each data object of the set of data objects is created such that the variable strings within each data object are valid variable strings for that data object, such that no data object of the set of data objects is created that has one or more variable strings that are invalid for that data object.

In another embodiment, no input from a user occurs for the duration of the process of creating each of the data objects of the set of data objects. In another embodiment, the data processing system creates each of the data objects of the set of data objects using the data-object-creation data without input from a user.

In another embodiment, the duration of the process of creating the set of data objects using the data-object-creation data is less than one second. In another embodiment, the duration of the process of creating the set of data objects is greater than or equal to one second and less than one minute. In another embodiment, the duration of the process of creating the set of data objects is greater than or equal to one minute and less than ten minutes. In another embodiment, the duration of the process of creating the set of data objects is greater than or equal to ten minutes and less than one hour. In another embodiment, the duration of the process of creating the set of data objects is greater than or equal to one hour and less than one day. In another embodiment, the duration of the process of creating the set of data objects is greater than or equal to one day.

In another embodiment, one or more of the variable strings of the set of variable strings are excluded from one or more data objects of the set of data objects.

In a further embodiment, the data-object-creation data comprises information used in determining which variable strings are to be excluded from each of the data objects of the set of data objects.

In a further further embodiment, one or more of the variable strings of the set of variable strings are excluded from one or more of the data objects of the set of data objects, but not from all of the data objects of the set of data objects.

In another further embodiment, one or more of the variable strings of one or more of the subsets of variable strings of the set of variable strings are excluded from one or more of the data objects of the set of data objects.

In another further embodiment, the data-object-creation data comprises information used in determining which variable strings are to be excluded from each of the data objects of the set of data objects.

In a further further embodiment, one or more of the variable strings of the set of variable strings are excluded from one or more of the data objects of the set of data objects, but not from all of the data objects of the set of data objects.

In one embodiment, the invention is directed to a business method; the method includes creating intellectual property; the method of creating the intellectual property includes using a computer to create a group of chemical compound names; the group of chemical compound names includes several chemical compound names; the chemical compound names are created by combining phrases.

In another embodiment, three or more chemical compound names are created.

In another embodiment, one or more phrases are the same in all of the chemical compound names, and one or more phrases are different for several of the chemical compound names.

In a further embodiment, each of the chemical compound names contains two or more phrases that vary between chemical compound names.

In another embodiment, one or more of the phrases contains a graphical representation of chemical structure. In another embodiment, one or more of the chemical compound names contains a graphical representation of chemical structure.

In another embodiment, the group of chemical compound names is created by dividing a chemical compound name into two or more segments, and adding together one phrase for each segment to create each chemical compound name.

In a further embodiment, each segment has a set of phrases corresponding to it; and each set of phrases has one or more phrases; and each chemical compound name is formed by adding together one phrase for each segment, where the phrase that is added for a given segment is from the set of phrases that corresponds to that segment.

In a further further embodiment, the number of sets of phrases is equal to the number of segments, and each set of phrases corresponds to a different segment. In another further further embodiment, the number of sets of phrases is less than the number of segments, and at least one of the sets of phrases corresponds to more than one segment.

In another further further embodiment, the segments are arranged in a particular order, and each chemical compound name is formed by adding together the phrases in the same order as the segments.

In a further further further embodiment, the group of chemical compound names is created using a computer; the computer creates each chemical compound name by putting together one phrase for each segment; the phrase for each segment comes from the set of phrases corresponding to that segment. In another further further further embodiment, the computer generates every possible chemical compound name that can be created given the segments, sets of phrases, and phrases.

In one embodiment, the invention is directed to a method, using a computer, of creating a set of descriptions containing one or more descriptions; the set of descriptions is created starting with a group of segments; the group of segments contains two or more segments; each segment corresponds to a set of phrases, and each set of phrases contains one or more phrases; each description is created by joining one phrase for each segment from the set of phrases corresponding to that segment.

In another embodiment, the number of sets of phrases is equal to the number of segments, and each set of phrases corresponds to a different segment. In another embodiment, the number of sets of phrases is less than the number of segments, and at least one set of phrases corresponds to more than one segment.

In another embodiment, the set of phrases is created using a computer.

In a further embodiment, the group of segments and the sets of phrases are provided by a user. In another further embodiment, the group of segments and/or the sets of phrases are provided by the computer.

In one embodiment, the invention is directed to a business method, wherein said business method comprises the steps, performed by a user, of:

providing a set of chemical compound names, wherein the set of chemical compound names comprises one thousand or more chemical compound names, wherein each chemical compound name represents a chemical compound,

providing enablement information pertaining to the chemical compounds represented by the chemical compound names, and

creating intellectual property using the chemical compound names and the enablement information.

In another embodiment, the intellectual property comprises a genus of chemical compounds, wherein the genus of chemical compounds comprises one or more variable sites, wherein each of the chemical compounds has one variable group at each variable site, and wherein the intellectual property comprises definitions of allowable groups for each variable site, wherein each definition of an allowable group for each variable site defines the variable groups that can be present at that variable site.

In a further embodiment, the genus of chemical compounds is represented as a Markush group. In another further embodiment, the genus of chemical compounds has three variable sites, and the group of chemical compound names has chemical compound names with fifteen different variable groups for each variable site, and the number of chemical compound names in the set of chemical compound names is two thousand.

In another embodiment, the business method comprises the step, performed by a user, of licensing the intellectual property.

In a further embodiment, the invention is directed to said license.

In another embodiment, the business method comprises the step, performed by a user, of enforcing the intellectual property.

In a further embodiment, the invention is directed to a settlement or award resulting from enforcing the intellectual property.

In another embodiment, the business method comprises the step, performed by a user, of assigning the intellectual property.

In a further embodiment, the invention is directed to revenue realized from assigning the intellectual property.

In another embodiment, the method comprises altering the physical composition of the data processing system.

In another embodiment, at least one of the data objects of the chemical compound names comprises text.

In a further embodiment, each chemical compound name comprises text.

In another embodiment, at least one of the chemical compound names comprises graphics.

In a further embodiment, each chemical compound name comprises graphics.

In another embodiment, at least one of the chemical compound names comprises text and graphics.

In a further embodiment, each chemical compound name comprises text and graphics.

In another embodiment, the method further comprises the step, performed in a data processing system comprising one or more CPUs, of outputting one or more chemical compound names to a document, wherein the intellectual property is created using the document.

In a further embodiment, the order of components of one or more of the chemical compound names so output to the document differs from the order of components of the corresponding chemical compound names as-created. In another further embodiment, the order of components of the chemical compound names so output to the document is the same as the order of components of the corresponding chemical compound names as-created.

In another embodiment, the invention is directed to a document comprising one or more chemical compound names.

In a further embodiment, said document comprises each chemical compound name. In another further embodiment, said document is published. In another further embodiment, said document is unpublished. In another further embodiment, said document is a printed document.

In another further embodiment, said document is an electronic document.

In a further further embodiment, the invention is directed to a method of creating a printed document, performed in a data processing system comprising one or more CPUs, comprising: providing the electronic document; and printing the electronic document using computer instructions to direct the physical process of printing the electronic document using a printer.

In another further embodiment, said document resides in computer memory. In another further embodiment, the invention is directed to computer storage media in which is stored said document.

In another further embodiment, the document is stored in a computer data base.

In a further further embodiment, the invention is directed to said computer data base.

In another further embodiment, the document is available via the internet.

In a further further embodiment, the document is a printed document available via the internet. In another further further embodiment, the document is an electronic document available via the internet. In another further further embodiment, the document is available over the internet using a password.

In another embodiment, the invention is directed to intellectual property comprising one or more data objects of the set of data objects.

In a further embodiment, the intellectual property is a patent application.

In a further further embodiment, the patent application is an unfiled patent application. In another further further embodiment, the patent application is a filed patent application. In another further further embodiment, the patent application is a provisional application. In another further further embodiment, the patent application is a non-provisional application. In another further further embodiment, the patent application is a statutory invention registration application.

In another further embodiment, the intellectual property is a patent. In another further embodiment, the intellectual property is a statutory invention registration. In another further embodiment, the intellectual property is a trade secret. In another further embodiment, the intellectual property is licensed intellectual property.

In a further further embodiment, said intellectual property is offered for license or assignment.

In a further further further embodiment, the business method comprises the step, performed by a user, of publishing the intellectual property.

In another further further embodiment, said intellectual property is a filed, unpublished patent application that is offered for license or assignment. In another further further embodiment, said intellectual property is a trade secret that is offered for license.

In another further further embodiment, the intellectual property is a patent application comprising the chemical compound names, and one or more incorporations by reference to a previously-published reference.

In a further further further embodiment, the previously-published reference is a published patent application. In another further further further embodiment, the previously-published reference is an issued patent.

In another further further embodiment, one or more of said chemical compounds are encompassed by a prior art genus of chemical compounds.

In a further further further embodiment, the prior art genus of chemical compounds is represented by a Markush group.

In another further further embodiment, the intellectual property is a blocking patent.

In a further further further embodiment, one or more of the chemical compound names of the blocking patent are embraced by a genus disclosed in a different patent or patent application.

In a further further further further embodiment, the genus is represented as a Markush group.

In another embodiment, the number of chemical compound names is greater than ten thousand. In another embodiment, the number of chemical compound names is greater than fifty thousand. In another embodiment, the number of chemical compound names is greater than one hundred thousand. In another embodiment, the number of chemical compound names is greater than one million. In another embodiment, the number of chemical compound names is greater than ten million. In another embodiment, the number of chemical compound names is greater than one billion. In another embodiment, the number of chemical compound names is greater than or equal to one thousand and less than ten thousand. In another embodiment, the number of chemical compound names is greater than or equal to ten thousand and less than one hundred thousand. In another embodiment, the number of chemical compound names is greater than or equal to one hundred thousand and less than one million. In another embodiment, the number of chemical compound names is greater than or equal to one million and less than one billion.

In another embodiment, the chemical compounds represented by the chemical compound names are other than DNA compounds. In another embodiment, the chemical compounds represented by the chemical compound names are other than RNA compounds. In another embodiment, the chemical compounds represented by the chemical compound names are other than compounds having one or more mononucleotide moieties. In another embodiment, the chemical compounds represented by the chemical compound names are other than compounds having two or more mononucleotide moieties.

In another embodiment, the chemical compounds represented by the chemical compound names are other than polypeptides. In another embodiment, the chemical compounds represented by the chemical compound names are other than compounds having one or more peptide-linked amino acid moieties. In another embodiment, the chemical compounds represented by the chemical compound names are other than compounds having two or more peptide-linked amino acid moieties. In another embodiment, the chemical compounds represented by the chemical compound names are other than enzymes.

In another embodiment, the chemical compounds represented by the chemical compound names are other than sugars. In another embodiment, the chemical compounds represented by the chemical compound names are other than carbohydrates. In another embodiment, the chemical compounds represented by the chemical compound names are other than polysaccharides. In another embodiment, the chemical compounds represented by the chemical compound names are other than compounds having one or more monosaccharide moieties. In another embodiment, the chemical compounds represented by the chemical compound names are other than compounds having two or more glycoside-bond-linked monosaccharide moieties.

In another embodiment, the chemical compounds represented by the chemical compound names are other than polymers. In another embodiment, the chemical compounds represented by the chemical compound names are other than dendrimers.

In another embodiment, the chemical compounds represented by the chemical compound names are other than chemical compounds containing a sequence of subunits.

In a further embodiment, the sequence of subunits is linear, and each internal subunit comprises a first site of attachment to a first adjacent subunit, and a second site of attachment to a second adjacent subunit. In a further embodiment, each of the subunits is one of twenty possible subunits. In a further embodiment, each of the subunits is one of four possible subunits. In a further embodiment, each of the subunits is one of two or more possible subunits. In a further embodiment, each of the subunits is one of ten or more possible subunits. In a further embodiment, each of the subunits is one of twenty or more possible subunits. In a further embodiment, the sequence of subunits is branched.

In one embodiment, the invention is directed to a method of adding value to intellectual property comprising the steps, performed by a user, of:

providing an intellectual property instrument,

providing a set of inventive embodiments comprising one or more inventive embodiments, and

using the intellectual property instrument and one or more of the inventive embodiments of the set of inventive embodiments to create a value-added intellectual property instrument, wherein the value-added intellectual property instrument comprises one or more of the inventive embodiments of the set of inventive embodiments.

In one embodiment, the invention is directed to a method of adding value to intellectual property comprising the steps, performed by a user, of:

providing an intellectual property instrument,

providing a set of inventive embodiments comprising one or more inventive embodiments, and

using the intellectual property instrument and one or more of the inventive embodiments of the set of inventive embodiments to create a value-added intellectual property instrument, wherein the value-added intellectual property instrument comprises one or more of the inventive embodiments of the set of inventive embodiments, wherein the set of inventive embodiments is a set of data objects, and wherein each inventive embodiment of the set of inventive embodiments is a data object of the set of data objects, wherein the set of data objects is created by the steps, performed by a data processing system comprising one or more CPUs, of:

providing data-object-creation data, wherein said data-object-creation data comprises a set of variable strings, wherein the set of variable strings comprises one or more subsets of variable strings, and wherein each subset of variable strings of the set of variable strings comprises one or more variable strings, and

creating each of the data objects of the set of data objects, using the data-object-creation data, such that each of the data objects of the set of data objects comprises one or more variable strings of the set of variable strings.

In another embodiment, each of the variable strings of the set of variable strings comprises more than one letter. In another embodiment, one or more of the variable strings of the set of variable strings each comprise more than one letter. In another embodiment, each variable string of the set of variable strings is other than a single character representing one of the letters selected from a, t, g, c, and u. In another embodiment, each of one or more variable strings of the set of variable strings are other than a single character representing one of the letters selected from a, t, g, c, and u. In another embodiment, each of the variable strings of the set of variable strings comprises other than a single letter. In another embodiment, one or more of the variable strings of the set of variable strings each comprise more than one letter. In another embodiment, one or more of the variable strings of the set of variable strings represent other than a nucleic acid moiety. In another embodiment, one or more of the variable strings of the set of variable strings represent other than an amino acid moiety. In another embodiment, one or more of the variable strings of the set of variable strings represent other than a carbohydrate moiety.

In another embodiment, a user or business entity causes the method to be used to add value to intellectual property assigned or licensed to that user or business entity. In another embodiment, a user or business entity causes the method to be used to add value to intellectual property assigned or licensed to one or more of the persons or business entities to whom the user or business entity owes a duty. In another embodiment, a user or business entity causes the method to be used to add value to intellectual property that is not assigned or licensed to the user or business entity, or to one or more of the persons or business entities to whom the user owes a duty.

In another embodiment, the data-object-creation data resides in computer memory. In another embodiment, the method comprises altering the physical composition of the data processing system. In another embodiment, one or more variable strings of the set of variable strings are the products of functions. In another embodiment, one or more variable strings of the set of variable strings are the products of functions in a spreadsheet. In another embodiment, one or more variable strings of the set of variable strings occupy cells in a spreadsheet. In another embodiment, one or more variable strings of the set of variable strings represent molecular weights.

In another embodiment, at least one of the inventive embodiments of the set of inventive embodiments comprises text.

In a further embodiment, each inventive embodiment of the set of inventive embodiments comprises text.

In another embodiment, at least one of the inventive embodiments of the set of inventive embodiments comprises graphics.

In a further embodiment, each inventive embodiment of the set of inventive embodiments comprises graphics.

In a further further embodiment, such graphics represent chemical structure.

In another embodiment, at least one of the inventive embodiments of the set of inventive embodiments comprises text and graphics.

In a further embodiment, each inventive embodiment of the set of inventive embodiments comprises text and graphics.

In a further further embodiment, such graphics represent chemical structure.

In another embodiment, the method further comprises the step, performed in a data processing system comprising one or more CPUs, of: outputting one or more of the inventive embodiments of the set of inventive embodiments to a table.

In another embodiment, one or more of the inventive embodiments of the set of inventive embodiments are represented in a table.

In a further embodiment, said table comprises each inventive embodiment of the set of inventive embodiments. In another further embodiment, said table comprises one or more of the inventive embodiments of the set of inventive embodiments such that each inventive embodiment of the inventive embodiments comprised within the table is arranged in a different row of the table, and each variable string of each such inventive embodiment is arranged in a different column in the row corresponding to that inventive embodiment. In another further embodiment, said table comprises one or more of the inventive embodiments of the set of inventive embodiments such that each inventive embodiment of the inventive embodiments comprised within the table is arranged in a different column of the table, and each variable string of each such inventive embodiment is arranged in a different row in the column corresponding to that inventive embodiment. In another further embodiment, said table comprises one or more items of graphics representing chemical structure. In another further embodiment, said table comprises one or more textual representations of chemical structure. In another further embodiment, the table resides in computer memory.

In another embodiment, the method further comprises the step, performed in a data processing system comprising one or more CPUs, of: outputting one or more inventive embodiments of the set of inventive embodiments to the intellectual property instrument.

In a further embodiment, the order of components of one or more of the inventive embodiments so output to the intellectual property instrument differs from the order of components of the corresponding inventive embodiments as-created. In another further embodiment, the order of components of the inventive embodiments so output to the intellectual property instrument is the same as the order of components of the corresponding inventive embodiments as-created.

In another embodiment, the invention is directed to the value-added intellectual property instrument.

In a further embodiment, the value-added intellectual property instrument comprises each inventive embodiment of the set of inventive embodiments. In another further embodiment, the value-added intellectual property instrument is published. In another further embodiment, the value-added intellectual property instrument is unpublished. In another further embodiment, the value-added intellectual property instrument is a printed document. In another further embodiment, the value-added intellectual property instrument is an electronic intellectual property instrument.

In another further embodiment, said value-added intellectual property instrument resides in computer memory. In another further embodiment, the invention is directed to computer storage media in which is stored said value-added intellectual property instrument.

In another further embodiment, the value-added intellectual property instrument is stored in a computer data base.

In a further further embodiment, the invention is directed to said computer data base.

In another further embodiment, the value-added intellectual property instrument is available via the internet.

In a further further embodiment, the value-added intellectual property instrument is a printed intellectual property document available via the internet. In another further further embodiment, the value-added intellectual property instrument is an electronic intellectual property instrument available via the internet. In another further further embodiment, the value-added intellectual property instrument is available over the internet using a password.

In another embodiment, the invention is directed to the value-added intellectual property represented by the value-added intellectual property instrument.

In a further embodiment, the value-added intellectual property instrument comprises each inventive embodiment of the set of inventive embodiments. In another further embodiment, the value-added intellectual property instrument is published. In another further embodiment, the value-added intellectual property instrument is unpublished. In another further embodiment, the value-added intellectual property instrument is a printed document. In another further embodiment, the value-added intellectual property instrument is an electronic intellectual property instrument. In another further embodiment, said value-added intellectual property instrument resides in computer memory. In another further embodiment, the invention is directed to computer storage media in which is stored said value-added intellectual property instrument.

In another further embodiment, the value-added intellectual property instrument document is stored in a computer data base.

In a further further embodiment, the invention is directed to said computer data base.

In another further embodiment, the value-added intellectual property instrument is available via the internet.

In a further further embodiment, the value-added intellectual property instrument is a printed intellectual property document available via the internet. In another further further embodiment, the value-added intellectual property instrument is an electronic intellectual property instrument available via the internet. In another further further embodiment, the value-added intellectual property instrument is available over the internet using a password.

In another embodiment, the invention is directed to the value-added intellectual property represented by the value-added intellectual property instrument.

In a further embodiment, the value-added intellectual property is represented as a patent application.

In a further further embodiment, the patent application is an unfiled patent application. In another further further embodiment, the patent application is a filed patent application. In another further further embodiment, the patent application is a provisional application. In another further further embodiment, the patent application is a non-provisional application. In another further further embodiment, the patent application is a statutory invention registration application.

In another further embodiment, the value-added intellectual property is represented as a patent. In another further embodiment, the value-added intellectual property is represented as a statutory invention registration. In another further embodiment, the value-added intellectual property is represented as a trade secret. In another further embodiment, the value-added intellectual property is licensed intellectual property. In another further embodiment, the value-added intellectual property is enforced.

In another embodiment, the method comprises the step, performed by a user, of licensing the value-added intellectual property.

In a further embodiment, the invention is directed to said license.

In another embodiment, the method comprises the step, performed by a user, of enforcing the value-added intellectual property.

In a further embodiment, the invention is directed to a settlement or award resulting from enforcing the intellectual property.

In another embodiment, the method comprises the step, performed by a user, of assigning the value-added intellectual property.

In a further embodiment, the invention is directed to revenue realized from assigning the value-added intellectual property.

In another embodiment, the method has the improvement of adding value to intellectual property by incorporating a large number of inventive embodiments in less time than by previous methods. In another embodiment, the method has the improvement of adding value to intellectual property by incorporating a large number of inventive embodiments at lower cost than by previous methods.

In a further embodiment, the inventive embodiments fall within the scope of a genus disclosed within the intellectual property.

In a further further embodiment, the genus is represented as a Markush group.

In another embodiment, the method further comprises the steps, performed in a data processing system comprising one or more CPUs, of:

creating a first set of inventive embodiments using the method of creating a set of data objects, such that the first set of inventive embodiments is a set of chemical-compound-name data objects, wherein said set of chemical-compound-name data objects comprises one or more chemical-compound-name data objects, and wherein each chemical-compound-name data object is a chemical compound name, wherein each chemical compound name represents a chemical compound; and

creating a second set of inventive embodiments using the method of creating a set of data objects, such that the second set of inventive embodiments is a set of chemical-compound-preparation data objects, wherein said set of chemical-compound-preparation data objects comprises one or more chemical-compound-preparation data objects, and wherein each chemical-compound-preparation data object is a chemical compound preparation, wherein one or more of the chemical compound preparations comprise information regarding the preparation of one or more of the chemical compounds represented by the chemical-compound-name data objects;

such that the value-added intellectual property instrument comprises one or more of the chemical compound names and one or more of the chemical compound preparations.

In a further embodiment, the value-added intellectual property represented by the value-added intellectual property instrument is licensed. In another further embodiment, the value-added intellectual property represented by the value-added intellectual property instrument is assigned. In another further embodiment, the value-added intellectual property represented by the value-added intellectual property instrument is a patent. In another further embodiment, the value-added intellectual property represented by the value-added intellectual property instrument is a statutory invention registration. In another further embodiment, the value-added intellectual property represented by the value-added intellectual property instrument is a patent application. In another further embodiment, the value-added intellectual property represented by the value-added intellectual property instrument is a trade secret. In another further embodiment, the method has the improvement of producing value-added intellectual property comprising a large number of chemical compound names and chemical compound preparations in less time than by previous methods. In another further embodiment, the method has the improvement of producing value-added intellectual property comprising a large number of chemical compound names and chemical compound preparations at lower cost than by previous methods.

In another further embodiment, the method comprises the step, performed by a user, of licensing the value-added intellectual property.

In a further further embodiment, the invention is directed to said license.

In another further embodiment, the method comprises the step, performed by a user, of enforcing the value-added intellectual property.

In a further further embodiment, the invention is directed to a settlement or award resulting from enforcing the value-added intellectual property.

In another further embodiment, the method comprises the step, performed by a user, of assigning the value-added intellectual property.

In a further further embodiment, the invention is directed to revenue realized from assigning the value-added intellectual property.

In another embodiment, the method further comprises the step, performed by a user, of incorporating additional enablement information into the value-added intellectual property instrument.

In a further embodiment, the additional enablement information comprises one or more references.

In another embodiment, the method further comprises the step, performed by a user, of incorporating additional utility information into the value-added intellectual property instrument.

In a further embodiment, the additional utility information comprises information regarding two or more different utilities. In another further embodiment, the additional utility information comprises information regarding a different utility than the utility originally disclosed within the intellectual property.

In another embodiment, the business method further comprises the steps, performed by a user, of:

providing the structure of a biologically active chemical compound comprised within the original intellectual property,

analyzing the structure of said biologically active chemical compound comprised within the original intellectual property instrument in order to postulate a genus of structurally related target chemical compounds, such that the names of each of the structurally related target chemical compounds of such genus each share one or more common chemical compound name fragments, and

analyzing the genus of structurally related target chemical compounds in order to select variable strings which are able to be used to create the inventive embodiments of the set of inventive embodiments, wherein the inventive embodiments are chemical compound names, such that each chemical compound name represents one of the names of a structurally related target chemical compound embraced by the genus of structurally related target chemical compounds.

In a further embodiment, the genus is represented as a Markush group. In another further embodiment, the genus of structurally related chemical compounds does not embrace the biologically active chemical compound. In another further embodiment, the genus of structurally related chemical compounds embraces the biologically active chemical compound. In another further embodiment, the biologically active compound is a drug compound. In another further embodiment, the biologically active chemical compound is a patented chemical compound.

In another further embodiment, one or more of the structurally related target chemical compounds of said genus are embraced by a patented genus of chemical compounds.

In a further further embodiment, the business method comprises the step, performed by a user, of offering the value-added intellectual property for license or assignment to one or more licensees or assignees of one or more patents covering said patented pharmaceutical compound.

In another further embodiment, the value is added to the intellectual property inexpensively.

In a further further embodiment, the cost of adding value to the intellectual property is less than one quarter the value added to the intellectual property. In another further further embodiment, the cost of adding value to the intellectual property is less than five percent of the value added to the intellectual property. In another further further embodiment, the cost of adding value to the intellectual property is less than one percent of the value added to the intellectual property.

In another embodiment, the number of inventive embodiments incorporated within the value-added intellectual property instrument via said method is greater than twenty-five. In another embodiment, the number of inventive embodiments incorporated within the value-added intellectual property instrument via said method is greater than one hundred. In another embodiment, the number of inventive embodiments incorporated within the value-added intellectual property instrument via said method is greater than two hundred and fifty. In another embodiment, the number of inventive embodiments incorporated within the value-added intellectual property instrument via said method is greater than one thousand. In another embodiment, the number of inventive embodiments incorporated within the value-added intellectual property instrument via said method is greater than ten thousand. In another embodiment, the number of inventive embodiments incorporated within the value-added intellectual property instrument via said method is greater than fifty thousand. In another embodiment, the number of inventive embodiments incorporated within the value-added intellectual property instrument via said method is greater than one hundred thousand. In another embodiment, the number of inventive embodiments incorporated within the value-added intellectual property instrument via said method is greater than one million. In another embodiment, the number of inventive embodiments incorporated within the value-added intellectual property instrument via said method is greater than ten million. In another embodiment, the number of inventive embodiments incorporated within the value-added intellectual property instrument via said method is greater than one billion. In another embodiment, the number of inventive embodiments incorporated within the value-added intellectual property instrument via said method is greater than or equal to twenty-five and less than one hundred. In another embodiment, the number of inventive embodiments incorporated within the value-added intellectual property instrument via said method is greater than or equal to one hundred and less than five hundred. In another embodiment, the number of inventive embodiments incorporated within the value-added intellectual property instrument via said method is greater than or equal to five hundred and less than one thousand. In another embodiment, the number of inventive embodiments incorporated within the value-added intellectual property instrument via said method is greater than or equal to one thousand and less than ten thousand. In another embodiment, the number of inventive embodiments incorporated within the value-added intellectual property instrument via said method is greater than or equal to ten thousand and less than one hundred thousand. In another embodiment, the number of inventive embodiments incorporated within the value-added intellectual property instrument via said method is greater than or equal to one hundred thousand and less than one million. In another embodiment, the number of inventive embodiments incorporated within the value-added intellectual property instrument via said method is greater than or equal to one million and less than one billion.

In another embodiment, the set of variable strings resides in computer memory. In another embodiment, the set of variable strings is input by a user. In another embodiment, the set of variable strings has one subset of variable strings. In another embodiment, the set of variable strings has two subsets of variable strings. In another embodiment, the set of variable strings has at least three and no more than five subsets of variable strings. In another embodiment, the set of variable strings comprises six or more subsets of variable strings. In another embodiment, one or more of the variable strings of the set of variable strings are null strings.

In another embodiment, each of the data objects of the set of data objects has the same number of variable strings.

In a further embodiment, the data objects of the set of data objects each have the same number of variable strings from each subset of variable strings as every other data object of the set of data objects.

In a further further embodiment, each of the data objects of the set of data objects has one variable string from each of two subsets of variable strings. In another further further embodiment, each of the data objects of the set of data objects has one variable string from a first subset of variable strings, one variable string from a second subset of variable strings, and two variable strings from a third subset of variable strings.

In another further further embodiment, the variable strings within each subset of variable strings are ranked within that subset, and each subset of variable strings of the set of variable strings is ranked within the set of variable strings, such that, for the purpose of ranking the subsets of variable strings, where the data objects of the set of data objects have more than one variable string from a given subset of variable strings, that subset of variable strings is considered to be a different subset of variable strings for each occurrence of a variable string from that subset of variable strings within each data object of the set of data objects; and wherein:

the data objects of the set of data objects are created using an iterative process, whereby the first data object of the set of data objects is created using the first variable string of the first-ranked subset of variable strings, and the first variable string of each other ranked subset of variable strings used in creating said first data object; and the second data object of the set of data objects is created using the second variable string of the first-ranked subset of variable strings, and the first variable strings of each of the other ranked subsets of variable strings used in creating said second data object, such that the set of data objects so created comprises data objects representing all of the possible permutations of inclusions of variable strings within said data objects.

In a further further further embodiment, each of the data objects of the set of data objects has one variable string, wherein said variable string is from a subset of variable strings having twenty variable strings, and the number of data objects in the set of data objects so created is twenty.

In another further further further embodiment, each of the data objects of the set of data objects has three variable strings, wherein one of the variable strings is from a first subset of variable strings having ten variable strings, and where the first subset of variable strings is the first-ranked subset of variable strings, and the other two variable strings are from a second subset of variable strings having five variable strings, and where the second subset of variable strings is the second-ranked and third-ranked subsets of variable strings, and the number of data objects in the set of data objects so created is two hundred and fifty.

In another further further embodiment, the variable strings within each subset of variable strings are ranked within that subset, and each subset of variable strings of the set of variable strings is ranked within the set of variable strings, such that, for the purpose of ranking the subsets of variable strings, where the data objects of the set of data objects have more than one variable string from a given subset of variable strings, that subset of variable strings is considered to be a different subset of variable strings for each occurrence of a variable string from that subset of variable strings within each data object of the set of data objects; and wherein:

the data objects of the set of data objects are created using an iterative process, whereby a first prospective data object contains the first variable string of the first-ranked subset of variable strings, and the first variable string of each other ranked subset of variable strings used in creating said first prospective data object; and a second prospective data object contains the second variable string of the first-ranked subset of variable strings, and the first variable strings of each of the other ranked subsets of variable strings used in creating said second prospective data object; and continuing said iterative process such that all of the prospective data objects together comprise prospective data objects representing all of the possible permutations of inclusions of variable strings within said prospective data objects; and wherein said method further comprises the step, performed in a data processing system comprising one or more CPUs, of:

testing each prospective data object to determine whether the combination of variable strings within that prospective data object is a valid combination of such variable strings: where if the combination of variable strings is not a valid combination of variable strings, that prospective data object is not one of the data objects of the set of data objects; and where if the combination of variable strings is a valid combination of variable strings, that prospective data object is one of the data objects of the set of data objects.

In a further further further embodiment, a prospective data object is determined to contain an invalid combination of variable strings before all of the variable strings have been assigned to that prospective data object. In another further further further embodiment, all of the prospective data objects are created before the test is performed to determine which prospective data objects have an invalid combination of variable strings. In another further further further embodiment, a prospective data object is determined to comprise an invalid combination of variable strings based on a single variable string.

In another embodiment, the set of variable strings is input by a user. In another embodiment, one or more of the variable strings are input by a user. In another embodiment, one or more of the variable strings are input by a user and one or more of the variable strings are located in a file. In another embodiment, a user selects one or more of the variable strings of the set of variable strings from a group of variable strings located in a file.

In another embodiment, the set of variable strings is located in a file.

In a further embodiment, the file is a spreadsheet.

In a further further embodiment, each subset of variable strings of the set of variable strings is organized in a separate column in the spreadsheet.

In a further further further embodiment, each variable string of each subset of variable strings is organized in a different row in the spreadsheet.

In another further embodiment, the set of variable strings is incorporated into computer software.

In a further further embodiment, the computer software comprises a set of computer instructions used in making the data objects of the set of data objects.

In another embodiment, each of the data objects of the set of data objects has one variable string from each subset of variable strings of the set of variable strings. In another embodiment, one or more of the subsets of variable strings of the set of variable strings have one variable string. In another embodiment each data object of the set of data objects is created such that the variable strings within each data object are valid variable strings for that data object, such that no data object of the set of data objects is created that has one or more variable strings that are invalid for that data object.

In another embodiment, no input from a user occurs for the duration of the process of creating each of the data objects of the set of data objects. In another embodiment, the data processing system creates each of the data objects of the set of data objects using the data-object-creation data without input from a user.

In another embodiment, the duration of the process of creating the set of data objects using the data-object-creation data is less than one second. In another embodiment, the duration of the process of creating the set of data objects is greater than or equal to one second and less than one minute. In another embodiment, the duration of the process of creating the set of data objects is greater than or equal to one minute and less than ten minutes. In another embodiment, the duration of the process of creating the set of data objects is greater than or equal to ten minutes and less than one hour. In another embodiment, the duration of the process of creating the set of data objects is greater than or equal to one hour and less than one day. In another embodiment, the duration of the process of creating the set of data objects is greater than or equal to one day.

In another embodiment, one or more of the variable strings of the set of variable strings are excluded from one or more data objects of the set of data objects.

In a further embodiment, the data-object-creation data comprises information used in determining which variable strings are to be excluded from each of the data objects of the set of data objects.

In a further further embodiment, one or more of the variable strings of the set of variable strings are excluded from one or more of the data objects of the set of data objects, but not from all of the data objects of the set of data objects.

In another further embodiment, one or more of the variable strings of one or more of the subsets of variable strings of the set of variable strings are excluded from one or more of the data objects of the set of data objects.

In another further embodiment, the data-object-creation data comprises information used in determining which variable strings are to be excluded from each of the data objects of the set of data objects.

In a further further embodiment, one or more of the variable strings of the set of variable strings are excluded from one or more of the data objects of the set of data objects, but not from all of the data objects of the set of data objects.

In another embodiment, one or more of the data objects of the set of data objects are chemical compound names.

In a further embodiment, the chemical compounds represented by the chemical compound names are other than DNA compounds. In another further embodiment, the chemical compounds represented by the chemical compound names are other than RNA compounds. In another further embodiment, the chemical compounds represented by the chemical compound names are other than compounds having one or more mononucleotide moieties. In another further embodiment, the chemical compounds represented by the chemical compound names are other than compounds having two or more mononucleotide moieties.

In another further embodiment, the chemical compounds represented by the chemical compound names are other than polypeptides. In another further embodiment, the chemical compounds represented by the chemical compound names are other than compounds having one or more peptide-linked amino acid moieties. In another further embodiment, the chemical compounds represented by the chemical compound names are other than compounds having two or more peptide-linked amino acid moieties. In another further embodiment, the chemical compounds represented by the chemical compound names are other than enzymes.

In another further embodiment, the chemical compounds represented by the chemical compound names are other than sugars. In another further embodiment, the chemical compounds represented by the chemical compound names are other than carbohydrates. In another further embodiment, the chemical compounds represented by the chemical compound names are other than polysaccharides. In another further embodiment, the chemical compounds represented by the chemical compound names are other than compounds having one or more monosaccharide moieties. In another further embodiment, the chemical compounds represented by the chemical compound names are other than compounds having two or more glycoside-bond-linked monosaccharide moieties.

In another further embodiment, the chemical compounds represented by the chemical compound names are other than polymers. In another further embodiment, the chemical compounds represented by the chemical compound names are other than dendrimers.

In another further embodiment, the chemical compounds represented by the chemical compound names are other than chemical compounds containing a sequence of subunits.

In a further further embodiment, the sequence of subunits is linear, and each internal subunit comprises a first site of attachment to a first adjacent subunit, and a second site of attachment to a second adjacent subunit. In a further further embodiment, each of the subunits is one of twenty possible subunits. In a further further embodiment, each of the subunits is one of four possible subunits. In a further further embodiment, each of the subunits is one of two or more possible subunits. In a further further embodiment, each of the subunits is one of ten or more possible subunits. In a further further embodiment, each of the subunits is one of twenty or more possible subunits. In a further further embodiment, the sequence of subunits is branched.

In another embodiment, one or more of the data objects of the set of data objects are genera of chemical compounds. In another embodiment, one or more of the data objects of the set of data objects are chemical compound preparations.

In another embodiment, the data-object-creation data comprises a set of variable-directing strings comprising one or more variable-directing strings, wherein the variable-directing strings of the set of variable-directing strings comprise information used in creating each of the data objects of the set of data objects by directing the placement of the variable strings within such data objects.

In a further embodiment, one or more of the inventive embodiments of the set of inventive embodiments are chemical compound names. In another further embodiment, one or more of the inventive embodiments of the set of inventive embodiments are genera of chemical compounds. In another further embodiment, one or more of the inventive embodiments of the set of inventive embodiments are chemical compound preparations. In another further embodiment, the invention is directed the value-added intellectual property represented by the value-added intellectual property instrument.

In another embodiment, the data-object-creation data comprises a template string, wherein said template string comprises a set of variable-directing strings, wherein said set of variable-directing strings comprises one or more variable-directing strings, and wherein said template string further comprises a set of exon strings, wherein the set of exon strings comprises one or more exon strings,

wherein each of the subsets of variable strings corresponds to one or more variable-directing strings of the set of variable-directing strings, such that each variable-directing string of the set of variable-directing strings has a corresponding subset of variable strings of the set of variable strings,

wherein the template string is used in the creation of each of the data objects of the set of data objects such that:

each of the data objects of the set of data objects comprises: every one of the exon strings of the set of exon strings; and one variable string of the corresponding subset of variable strings for each variable-directing string of the set of variable-directing strings;

wherein each of the variable-directing strings corresponds to a different variable-string locus within the data objects of the set of data objects, such that the number of variable-string loci within each of the data objects of the set of data objects is equal to the number of variable-directing strings of the set of variable-directing strings,

wherein each of the variable-string loci corresponds to the subset of variable strings that corresponds to that variable-string locus' variable-directing string,

and each of the variable-directing strings of the set of variable-directing strings is used to direct the placement of one of the variable strings from the corresponding subset of variable strings, at the variable-string locus corresponding to that variable-directing string, within each of the data objects of the set of data objects;

such that the set of data objects so created comprises all of the data objects representing all of the permutations of placements, at each of the variable-string loci, of each of the variable strings of the subset of variable strings corresponding to that variable-string locus.

In a further embodiment, one or more of the inventive embodiments of the set of inventive embodiments are chemical compound names. In another further embodiment, one or more of the inventive embodiments of the set of inventive embodiments are genera of chemical compounds. In another further embodiment, one or more of the data objects of the set of data objects are chemical compound preparations.

In another embodiment, the method is used to add value to a trade secret. In another embodiment, the method is used to add value to a patent application before it is filed. In another embodiment, the method is used to add value to a patent.

In another embodiment, the intellectual property to which value is added is a patent.

In a further embodiment, the method comprises the step, performed by a user, of filing the value-added intellectual property instrument as a patent application. In another further embodiment, the method comprises the step, performed by a user, of filing the value-added intellectual property instrument as a statutory invention registration. In another further embodiment, the method comprises the step, performed by a user, of offering the value-added intellectual property represented by the value-added intellectual property instrument for assignment. In another further embodiment, the method comprises the step, performed by a user, of offering a license to the value-added intellectual property represented by the value-added intellectual property instrument. In another further embodiment, the method comprises the step, performed by a user, of publishing the value-added intellectual property instrument.

In one embodiment, the invention is directed to a method of adding value to intellectual property, comprising:

a step for providing an intellectual property instrument,

a step for providing inventive embodiments, and

a step for creating value-added intellectual property using the intellectual property instrument and inventive embodiments.

In another embodiment, the method further comprises a step for creating the inventive embodiments.

In another embodiment, the method further comprises a step for creating the inventive embodiments using a data processing system comprising one or more CPUs.

In a further embodiment, the inventive embodiments are chemical inventive embodiments.

In a further further embodiment, the chemical inventive embodiments are chemical compound names.

In a further further further embodiment, the chemical compounds represented by the chemical compound names are other than DNA compounds. In another further further further embodiment, the chemical compounds represented by the chemical compound names are other than RNA compounds. In another further further further embodiment, the chemical compounds represented by the chemical compound names are other than compounds having one or more mononucleotide moieties. In another further further further embodiment, the chemical compounds represented by the chemical compound names are other than compounds having two or more mononucleotide moieties.

In another further further further embodiment, the chemical compounds represented by the chemical compound names are other than polypeptides. In another further further further embodiment, the chemical compounds represented by the chemical compound names are other than compounds having one or more peptide-linked amino acid moieties. In another further further further embodiment, the chemical compounds represented by the chemical compound names are other than compounds having two or more peptide-linked amino acid moieties. In another further further further embodiment, the chemical compounds represented by the chemical compound names are other than enzymes.

In another further further further embodiment, the chemical compounds represented by the chemical compound names are other than sugars. In another further further further embodiment, the chemical compounds represented by the chemical compound names are other than carbohydrates. In another further further further embodiment, the chemical compounds represented by the chemical compound names are other than polysaccharides. In another further further further embodiment, the chemical compounds represented by the chemical compound names are other than compounds having one or more monosaccharide moieties. In another further further further embodiment, the chemical compounds represented by the chemical compound names are other than compounds having two or more glycoside-bond-linked monosaccharide moieties.

In another further further further embodiment, the chemical compounds represented by the chemical compound names are other than polymers. In another further further further embodiment, the chemical compounds represented by the chemical compound names are other than dendrimers.

In another further further further embodiment, the chemical compounds represented by the chemical compound names are other than chemical compounds containing a sequence of subunits.

In a further further further further embodiment, the sequence of subunits is linear, and each internal subunit comprises a first site of attachment to a first adjacent subunit, and a second site of attachment to a second adjacent subunit. In a further further further further embodiment, each of the subunits is one of twenty possible subunits. In a further further further further embodiment, each of the subunits is one of four possible subunits. In a further further further further embodiment, each of the subunits is one of two or more possible subunits. In a further further further further embodiment, each of the subunits is one of ten or more possible subunits. In a further further further further embodiment, each of the subunits is one of twenty or more possible subunits. In a further further further further embodiment, the sequence of subunits is branched.

In another further further embodiment, the chemical inventive embodiments are preparations of chemical compounds. In another further further embodiment, the chemical inventive embodiments are genera of chemical compounds. In another further further embodiment, the number of chemical inventive embodiments of the set of chemical inventive embodiments is greater than or equal to one hundred. In another further further embodiment, the number of chemical inventive embodiments of the set of chemical inventive embodiments is greater than or equal to one thousand. In another further further embodiment, the number of chemical inventive embodiments of the set of chemical inventive embodiments is greater than or equal to ten thousand. In another further further embodiment, the number of chemical inventive embodiments of the set of chemical inventive embodiments is greater than or equal to one hundred thousand. In another further further embodiment, the number of chemical inventive embodiments of the set of chemical inventive embodiments is greater than or equal to one million. In another further further embodiment, the number of chemical inventive embodiments of the set of chemical inventive embodiments is greater than or equal to one billion.

In another further embodiment, the value-added intellectual property comprises an incorporation by reference to the intellectual property to which value is added. In another further embodiment, the value-added intellectual property discloses one or more utilities disclosed in the intellectual property to which value is added. In another further embodiment, the value-added intellectual property comprises enablement information disclosed in the intellectual property to which value is added. In another further embodiment, the value-added intellectual property comprises one percent or more of the disclosure of the intellectual property to which value is added. In another further embodiment, the value-added intellectual property comprises five percent or more of the disclosure of the intellectual property to which value is added. In another further embodiment, the value-added intellectual property comprises ten percent or more of the disclosure of the intellectual property to which value is added. In another further embodiment, the value-added intellectual property comprises twenty-five percent or more of the disclosure of the intellectual property to which value is added. In another further embodiment, the value-added intellectual property comprises fifty percent or more of the disclosure of the intellectual property to which value is added. In another further embodiment, the value-added intellectual property comprises seventy-five percent or more of the disclosure of the intellectual property to which value is added. In another further embodiment, the value-added intellectual property comprises ninety percent or more of the disclosure of the intellectual property to which value is added.

In another further embodiment, the step for creating the inventive embodiments comprises using the disclosure of the intellectual property to which value is added in order to create the inventive embodiments.

In a further further embodiment, the value-added intellectual property comprises: one or more inventive embodiments that fall within the scope of one or more of the claims of the intellectual property to which value is added; and one or more inventive embodiments that fall outside the scope of the claims of the intellectual property to which value is added. In another further further embodiment, all of the inventive embodiments fall outside the scope of the claims of the intellectual property to which value is added. In another further further embodiment, all of the inventive embodiments fall inside the scope of the claims of the intellectual property to which value is added.

In one embodiment, the invention is directed to a method, in a data processing system comprising one or more CPUs, of creating a set of data objects, wherein said set of data objects comprises one or more data objects, comprising:

a step for providing data-object-creation data, wherein the data-object-creation data comprises a set of variable strings, wherein the set of variable strings comprises one or more subsets of variable strings, and wherein each subset of variable strings of the set of variable strings comprises one or more variable strings, and

a step for creating each of the data objects of the set of data objects using the data-object-creation data such that each of the data objects of the set of data objects comprises one or more variable strings of the set of variable strings.

In another embodiment, each of the variable strings of the set of variable strings comprises more than one letter. In another embodiment, one or more of the variable strings of the set of variable strings each comprise more than one letter. In another embodiment, each variable string of the set of variable strings is other than a single character representing one of the letters selected from a, t, g, c, and u. In another embodiment, each of one or more variable strings of the set of variable strings are other than a single character representing one of the letters selected from a, t, g, c, and u. In another embodiment, each of the variable strings of the set of variable strings comprises other than a single letter. In another embodiment, one or more of the variable strings of the set of variable strings each comprise more than one letter. In another embodiment, one or more of the variable strings of the set of variable strings represent other than a nucleic acid moiety. In another embodiment, one or more of the variable strings of the set of variable strings represent other than an amino acid moiety. In another embodiment, one or more of the variable strings of the set of variable strings represent other than a carbohydrate moiety.

In another embodiment, the method further comprises a step for creating the data objects.

In another embodiment, the method further comprises a step for creating the data objects using a data processing system comprising one or more CPUs.

In a further embodiment, the data objects are chemical data objects.

In a further further embodiment, the chemical data objects are chemical compound names.

In a further further further embodiment, the chemical compounds represented by the chemical compound names are other than DNA compounds. In another further further further embodiment, the chemical compounds represented by the chemical compound names are other than RNA compounds. In another further further further embodiment, the chemical compounds represented by the chemical compound names are other than compounds having one or more mononucleotide moieties. In another further further further embodiment, the chemical compounds represented by the chemical compound names are other than compounds having two or more mononucleotide moieties.

In another further further further embodiment, the chemical compounds represented by the chemical compound names are other than polypeptides. In another further further further embodiment, the chemical compounds represented by the chemical compound names are other than compounds having one or more peptide-linked amino acid moieties. In another further further further embodiment, the chemical compounds represented by the chemical compound names are other than compounds having two or more peptide-linked amino acid moieties. In another further further further embodiment, the chemical compounds represented by the chemical compound names are other than enzymes.

In another further further further embodiment, the chemical compounds represented by the chemical compound names are other than sugars. In another further further further embodiment, the chemical compounds represented by the chemical compound names are other than carbohydrates. In another further further further embodiment, the chemical compounds represented by the chemical compound names are other than polysaccharides. In another further further further embodiment, the chemical compounds represented by the chemical compound names are other than compounds having one or more monosaccharide moieties. In another further further further embodiment, the chemical compounds represented by the chemical compound names are other than compounds having two or more glycoside-bond-linked monosaccharide moieties.

In another further further further embodiment, the chemical compounds represented by the chemical compound names are other than polymers. In another further further further embodiment, the chemical compounds represented by the chemical compound names are other than dendrimers.

In another further further further embodiment, the chemical compounds represented by the chemical compound names are other than chemical compounds containing a sequence of subunits.

In a further further further further embodiment, the sequence of subunits is linear, and each internal subunit comprises a first site of attachment to a first adjacent subunit, and a second site of attachment to a second adjacent subunit. In a further further further further embodiment, each of the subunits is one of twenty possible subunits. In a further further further further embodiment, each of the subunits is one of four possible subunits. In a further further further further embodiment, each of the subunits is one of two or more possible subunits. In a further further further further embodiment, each of the subunits is one of ten or more possible subunits. In a further further further further embodiment, each of the subunits is one of twenty or more possible subunits. In a further further further further embodiment, the sequence of subunits is branched.

In another further further embodiment, the chemical data objects are preparations of chemical compounds. In another further further embodiment, the chemical data objects are genera of chemical compounds. In another further further embodiment, the number of chemical data objects of the set of chemical data objects is greater than or equal to one hundred. In another further further embodiment, the number of chemical data objects of the set of chemical data objects is greater than or equal to one thousand. In another further further embodiment, the number of chemical data objects of the set of chemical data objects is greater than or equal to ten thousand. In another further further embodiment, the number of chemical data objects of the set of chemical data objects is greater than or equal to one hundred thousand. In another further further embodiment, the number of chemical data objects of the set of chemical data objects is greater than or equal to one million. In another further further embodiment, the number of chemical data objects of the set of chemical data objects is greater than or equal to one billion.

In another further embodiment, the invention is directed to a method of adding value to intellectual property, comprising:

a step for providing intellectual property, and

a step for creating value-added intellectual property using the intellectual property and one or more of the data objects of the set of data objects.

In a further further embodiment, the value-added intellectual property comprises an incorporation by reference to the intellectual property to which value is added. In another further further embodiment, the value-added intellectual property discloses one or more utilities disclosed in the intellectual property to which value is added. In another further further embodiment, the value-added intellectual property comprises enablement information disclosed in the intellectual property to which value is added. In another further further embodiment, the value-added intellectual property comprises one percent or more of the disclosure of the intellectual property to which value is added. In another further further embodiment, the value-added intellectual property comprises five percent or more of the disclosure of the intellectual property to which value is added. In another further further embodiment, the value-added intellectual property comprises ten percent or more of the disclosure of the intellectual property to which value is added. In another further further embodiment, the value-added intellectual property comprises twenty-five percent or more of the disclosure of the intellectual property to which value is added. In another further further embodiment, the value-added intellectual property comprises fifty percent or more of the disclosure of the intellectual property to which value is added. In another further further embodiment, the value-added intellectual property comprises seventy-five percent or more of the disclosure of the intellectual property to which value is added. In another further further embodiment, the value-added intellectual property comprises ninety percent or more of the disclosure of the intellectual property to which value is added.

In another further further embodiment, the step for creating the data objects comprises using the disclosure of the intellectual property to which value is added in order to create the data objects.

In a further further further embodiment, the value-added intellectual property comprises: one or more inventive embodiments that fall within the scope of one or more of the claims of the intellectual property to which value is added; and one or more inventive embodiments that fall outside the scope of the claims of the intellectual property to which value is added. In another further further further embodiment, all of the inventive embodiments fall outside the scope of the claims of the intellectual property to which value is added. In another further further further embodiment, all of the inventive embodiments fall inside the scope of the claims of the intellectual property to which value is added.

In one embodiment, the invention is directed to a method of creating intellectual property comprising:

a step for providing a set of inventive embodiments, wherein the set of inventive embodiments comprises one thousand or more inventive embodiments,

a step for providing enablement information, and

a step for providing utility information, and

a step for combining the set of inventive embodiments, the enablement information, and the utility information to produce the intellectual property.

In another embodiment, the method further comprises a step for creating the inventive embodiments.

In another embodiment, the method further comprises a step for creating the inventive embodiments using a data processing system comprising one or more CPUs.

In a further embodiment, the inventive embodiments are chemical inventive embodiments.

In a further further embodiment, the chemical inventive embodiments are chemical compound names.

In a further further further embodiment, the chemical compounds represented by the chemical compound names are other than DNA compounds. In another further further further embodiment, the chemical compounds represented by the chemical compound names are other than RNA compounds. In another further further further embodiment, the chemical compounds represented by the chemical compound names are other than compounds having one or more mononucleotide moieties. In another further further further embodiment, the chemical compounds represented by the chemical compound names are other than compounds having two or more mononucleotide moieties.

In another further further further embodiment, the chemical compounds represented by the chemical compound names are other than polypeptides. In another further further further embodiment, the chemical compounds represented by the chemical compound names are other than compounds having one or more peptide-linked amino acid moieties. In another further further further embodiment, the chemical compounds represented by the chemical compound names are other than compounds having two or more peptide-linked amino acid moieties. In another further further further embodiment, the chemical compounds represented by the chemical compound names are other than enzymes.

In another further further further embodiment, the chemical compounds represented by the chemical compound names are other than sugars. In another further further further embodiment, the chemical compounds represented by the chemical compound names are other than carbohydrates. In another further further further embodiment, the chemical compounds represented by the chemical compound names are other than polysaccharides. In another further further further embodiment, the chemical compounds represented by the chemical compound names are other than compounds having one or more monosaccharide moieties. In another further further further embodiment, the chemical compounds represented by the chemical compound names are other than compounds having two or more glycoside-bond-linked monosaccharide moieties.

In another further further further embodiment, the chemical compounds represented by the chemical compound names are other than polymers. In another further further further embodiment, the chemical compounds represented by the chemical compound names are other than dendrimers.

In another further further further embodiment, the chemical compounds represented by the chemical compound names are other than chemical compounds containing a sequence of subunits.

In a further further further further embodiment, the sequence of subunits is linear, and each internal subunit comprises a first site of attachment to a first adjacent subunit, and a second site of attachment to a second adjacent subunit. In a further further further further embodiment, each of the subunits is one of twenty possible subunits. In a further further further further embodiment, each of the subunits is one of four possible subunits. In a further further further further embodiment, each of the subunits is one of two or more possible subunits. In a further further further further embodiment, each of the subunits is one of ten or more possible subunits. In a further further further further embodiment, each of the subunits is one of twenty or more possible subunits. In a further further further further embodiment, the sequence of subunits is branched.

In another further further embodiment, the chemical inventive embodiments are preparations of chemical compounds. In another further further embodiment, the chemical inventive embodiments are genera of chemical compounds. In another further further embodiment, the number of chemical inventive embodiments of the set of chemical inventive embodiments is greater than or equal to one hundred. In another further further embodiment, the number of chemical inventive embodiments of the set of chemical inventive embodiments is greater than or equal to one thousand. In another further further embodiment, the number of chemical inventive embodiments of the set of chemical inventive embodiments is greater than or equal to ten thousand. In another further further embodiment, the number of chemical inventive embodiments of the set of chemical inventive embodiments is greater than or equal to one hundred thousand. In another further further embodiment, the number of chemical inventive embodiments of the set of chemical inventive embodiments is greater than or equal to one million. In another further further embodiment, the number of chemical inventive embodiments of the set of chemical inventive embodiments is greater than or equal to one billion.

In another further embodiment, the intellectual property comprises an incorporation by reference to the intellectual property to which value is added. In another further embodiment, the intellectual property discloses one or more utilities disclosed in the intellectual property to which value is added. In another further embodiment, the intellectual property comprises enablement information disclosed in the intellectual property to which value is added. In another further embodiment, the intellectual property comprises one percent or more of the disclosure of the intellectual property to which value is added. In another further embodiment, the intellectual property comprises five percent or more of the disclosure of the intellectual property to which value is added. In another further embodiment, the intellectual property comprises ten percent or more of the disclosure of the intellectual property to which value is added. In another further embodiment, the intellectual property comprises twenty-five percent or more of the disclosure of the intellectual property to which value is added. In another further embodiment, the intellectual property comprises fifty percent or more of the disclosure of the intellectual property to which value is added. In another further embodiment, the intellectual property comprises seventy-five percent or more of the disclosure of the intellectual property to which value is added. In another further embodiment, the intellectual property comprises ninety percent or more of the disclosure of the intellectual property to which value is added.

### Uses and Advantages

Essentially every patent or patent application for which a colorable argument can be made supporting patentability of at least one claim or potential claim has value. The value of a claim is roughly a function of:
1) the relative prospective value of the claim as a function of the relative breadth of the scope (represented by the set S_{c}) and the nature of the subject matter of the claim (A_{c});
2) the relative probability that the claim would be held valid (P_{c});
3) a constant (c).

V_{c}=c*A_{c}*P_{c}

In considering the difference between the value of two claims ΔV, where ΔV=V₁−V₂ and where C₂ is a narrow dependent claim of C₁ such that S₂ is a proper subset of S₁ (S₂ ⊂ S₁), the mathematics becomes more complex.

C₁ may be more “valuable” than C₂ (ΔV>0) because A₁>A₂; however, C₁ is not necessarily more valuable than C₂ because there is a somewhat greater likelihood that the broader claim will be held invalid, such that P₁<PL₂. An unforeseen prior art reference that falls within the scope of the difference between the subject matter of C₁ and C₂ (S₁\S₂, where S₁\S₂ is the relative complement of S₂ relative to S₁) may render the broader claim invalid where the narrower claim would stand. This can also apply when a circumstance material to patentability arises that renders C₁ invalid where C₂ would stand. This is of particular (but not necessary) concern where S₁\S₂ is directed to subject matter that is of less relative commercial value than that of S₂. The lost value component due to the increased risk of invalidity may be greater than the added value component due to the broader scope.

On the other hand, where two claims (C₂ and C₃) are dependent claims of a broader claim (C₁), and where the combined subject matter of C₂ and C₃ is equal to the subject matter of C₁ (S_{2 ∪ S}₃=S₁) and where S₂ is not equal to S₃, the combined value of C₂ and C₃ is generally greater than the value of C₁. This analysis is an approximation and assumes that all claims are properly drafted and supported and that dependent claims of a valid broader claim will also be valid.

A circumstance material to patentability that would cause either C₂ or C₃ to be invalid would necessarily cause C₁ to be invalid; however, there can be circumstances material to patentability that will invalidate C₁ and either C₂ or C₃ but not the other. Therefore, the scope component of the value of claims C₂ and C₃ together will be the same as that of C₁, but C₂ and C₃ together will have additional inherent value due to those instances where either C₂ or C₃ would be held valid but C₁ would not.

The inherent value continues to increase as the scope of the subject matter is distributed among an increasingly larger number of claims of increasingly narrower scope. When there are three dependent claims (C₂, C₃, and C₄) of C₁, and where C₂, C₃, and C₄ together are equal in scope to C₁, and where each of C₂, C₃, and C₄ are different from each other such that the subject matter is somewhat evenly distributed between them, the inherent value due to spreading the subject matter coverage over more potentially-valid claims increases. There can now be circumstances in which C₁ and one (or both) of C₂ and C₃ are invalidated by circumstances material to patentability but C₄ remains valid.

The increased value resulting from spreading the claimed subject matter over many claims increases and approaches a theoretical maximum at which the maximum possible claim scope will be preserved if some part of the scope of the broad claim is found to be unpatentable. This value is maximized when only that value that must be surrendered is lost.

One factor that tends to limit the additional expected value realized by adding additional claims is the transaction costs. Fees for additional claims and per-page fees can increase this cost significantly. Fees for additional claims can be avoided, however, because support for additional claims can be disclosed in the specification and serve as the basis for additional claims later if needed. Furthermore, per-page fees are an insignificant added expense because the price per page is nominal and in many cases there can be support for several narrower embodiments per page.

A much greater factor that tends to increase the cost of adding additional claims is the cost of the human labor. Typically, additional claims or support for such claims are created by a skilled claim drafter who considers the broad claim and creates each of the narrower claims by making choices and adding further claim limitations. Skilled claim drafters commonly command large salaries and the cost of adding support for each additional claim can be high. Innovations that provide a means for creating a large number of claims or support for potential claims rapidly and inexpensively can lower the overall cost of adding such claims or embodiments to intellectual property. Such innovations can create value by increasing the value of intellectual property; therefore the innovations have utility and merit the protection of the intellectual property laws.

After a first inventor has obtained a first patent for her invention, a second inventor may obtain a second patent with claims directed to subject matter falling within the scope of the first patent. While this second patent does not impinge on the first inventor's right to exclude others from engaging in activity within the scope of her patent, including the right to exclude the second inventor, the value of the first patent is nevertheless diminished.

The second patent grants the second inventor the right to exclude others, including the first inventor, from engaging in activity that falls within the scope of the claims of the second patent. The first inventor now has a disincentive to conduct research directed toward improvements or other subject matter within the scope of the claims of the second patent because she would have to obtain a license, or may be barred outright if the second inventor refuses to grant a license. Furthermore, the value of the first patent is diminished because any royalties from prospective licensees desiring to engage in activity within the scope of the second patent will presumably be reduced because the prospective licensees would need to obtain licenses from two different parties instead of only one. Worse, the prospective licensees may be altogether discouraged from operating in that area because of the increased transaction costs and potentially higher royalties.

If multiple patents issue with overlapping claim scope, the value of a given patent can decline with each additional patent because of the need to acquire multiple licenses in order to practice the invention. The greater the number of embodiments disclosed in a patent, particularly (but not necessarily) where the embodiments are distributed throughout the scope of the broadest claims, the greater the potential burden on other prospective patentees regarding issues related to novelty and non-obviousness. Other prospective patentees may have to settle for narrower claims than they would otherwise be entitled to if the first inventor had disclosed fewer embodiments, or may be altogether barred from obtaining a patent. Other prospective patentees may be discouraged from entering the technical field because of the limited prospects for obtaining intellectual property rights. An innovation that fortifies intellectual property by limiting the opportunity of others to obtain intellectual property rights within the scope of the intellectual property can create wealth for business entities; therefore there is a need in the art for such an innovation, and the innovation has utility and merits the protection of the intellectual property laws.

Defensive publications are often used in situations where an inventor may wish to make a published disclosure of her invention but does not wish to patent the invention herself. A problem may arise however if, despite the disclosure, a later inventor is able to obtain a patent with claims that read upon subject matter within the scope of the defensive publication. An innovation that decreases the likelihood that an inventor will be barred from practicing an invention within the scope of a disclosure of that invention, by limiting the opportunity of others to obtain patent rights within the scope of the disclosure, can create wealth for business entities; therefore, there is a need in the art for such an innovation, and the innovation has utility and merits the protection of the intellectual property laws.

Profit can also be realized by creating intellectual property that can potentially lessen the value of the intellectual property rights of others. Profit can be realized where an inventor creates blocking intellectual property disclosing numerous embodiments within the scope of the intellectual property of another. The value of the intellectual property of the other can be decreased because the other may have greater difficulty satisfying the requirements of novelty and non-obviousness in later patents directed to improvements or other subject matter within the scope of the earlier intellectual property. Profit can be realized by offering to assign or license the blocking intellectual property to the other assignee or licensee or some other entity in exchange for consideration. Profit can also be realized by offering to abandon or suppress an unpublished patent application or other unpublished intellectual property in exchange for consideration; if abandoned, the unpublished intellectual property generally cannot be used as a prior art reference against later-filed or later-invented intellectual property.

Intellectual property rights can be obtained where the disclosure of another establishes the basis for enablement and/or utility of claims where the subject matter is sufficiently closely related. Up-front costs can optionally be reduced by presenting secondary indicia of non-obviousness and/or arguments in support of non-obviousness after the filing date. There is a need in the art for an innovation that provides a means for generating revenue by obtaining blocking intellectual property and offering to assign, license, or abandon the blocking intellectual property; therefore such innovation has utility and merits the protection of the intellectual property laws.

Profit can also be realized from the value added by creating intellectual property that tends to provide an advantage in licensing negotiations and settlements of patent infringement litigation. By increasing the number of disclosed embodiments, there is a greater burden placed upon the prospective assignee, licensee or accused infringer to determine the value of the intellectual property. The transaction costs in determining the scope and validity of claims that may ultimately issue, time constraints, and the increased likelihood that particularly relevant embodiments may be missed may provide an incentive for the prospective assignee, licensee, or accused infringer to finalize an agreement or settle. There may also be a greater likelihood that the prospective assignee, licensee, or accused infringer will presume that the intellectual property is stronger due to the greater likelihood of obtaining claims with broader scope. Where an assignee has an advantage in such negotiations, that advantage increases the likelihood that the negotiations will result in terms more favorable to the assignee; therefore obtaining that advantage adds value. An innovation that facilitates increasing the number of disclosed embodiments can provide such an advantage in negotiations. There is a need in the art for such an innovation, and such innovation has utility and merits the protection of the intellectual property laws.

Where the intellectual property discloses a genus, profit can also be realized by adding value to the intellectual property by disclosing support for subgenera. Dependent claims in many cases can be expressed as a subgenus of the broader claim from which it depends. Adding support for additional subgenera can provide the same benefits that result from adding additional inventive embodiments. An innovation that facilitates increasing the number of subgenera can add value to intellectual property. There is a need in the art for such an innovation, and such innovation has utility and merits the protection of the intellectual property laws.

Profit can be realized from the value added to intellectual property by including a plurality of examples of making and/or using inventive embodiments within the disclosure of the intellectual property. Adding such examples may increase the likelihood of satisfying the requirement that the subject matter of the disclosure be enabled, have a demonstrated utility, and/or meet other requirements for patentability. An enabling disclosure can be effective as blocking intellectual property where it can render anticipated or obvious claims that read on the subject matter of the blocking intellectual property. Furthermore, many method claims directed to processes involving one or a small number of inventive embodiments can benefit from the disclosure of a plurality of examples of making or using the inventive embodiment/s, particularly (but not necessarily) where such examples are representative of the scope of the broader process claim.

Including experimental examples pertaining to chemical compound preparations in the disclosure increases the likelihood that the subject matter pertaining to those chemical compounds will be deemed enabled; therefore, value can be added to intellectual property by increasing the number of such examples. An innovation that facilitates increasing the number of examples of making and/or using inventive embodiments within the scope of the disclosure of the intellectual property can add value to intellectual property. There is a need in the art for such an innovation, and such innovation has utility and merits the protection of the intellectual property laws.

Classes of chemical compounds that vary from one another with regard to one or more variable groups are often amenable to the creation of a plurality of experimental procedures. In many cases a large number of analogs can be prepared by the same general synthetic procedure by varying one or more synthetic intermediates corresponding to one or more variable groups.

The ability to create or otherwise add value to intellectual property by adding a large number of inventive embodiments, examples, genera, and experimental information thereto is useful for small business entities because it offers an opportunity to enter a technology field with an otherwise prohibitively high financial barrier to entry. With little upfront expense, such business entities can acquire intellectual property and earn capital through licensing, assigning, or otherwise using or enforcing the intellectual property. The capital may in turn be used to finance research or further development of the technology or for other purposes.

In addition to the added value and profit that a rapid and inexpensive method of creating inventive embodiments, examples, and genera can offer, the method and computer program can offer other benefits to science and researchers. By specifically identifying numerous compounds, and by generating experimental procedures for their synthesis, the present method and computer program can convey a benefit to other researchers interested in preparing compounds that have been disclosed through use of the method and/or computer program. Use of the method and computer program will add to the store of knowledge, and valuable time and costly reagents that would otherwise be spent in pursuing such compounds may be saved.

The uses disclosed herein are offered by way of example only; one of skill in the art will appreciate other uses, and the uses disclosed are not to be interpreted as imposing limitations on the claims. It is not required that all of the advantageous features and all of the advantages need to be incorporated into every embodiment of the invention.

What is claimed is:

1. A method, in a data processing system comprising one or more CPUs, of creating a set of data objects, wherein said set of data objects comprises one or more data objects, comprising the steps of:
providing data-object-creation data, wherein said data-object-creation data comprises a set of variable strings, wherein the set of variable strings comprises one or more subsets of variable strings, and wherein each subset of variable strings of the set of variable strings comprises one or more variable strings, and
creating each of the data objects of the set of data objects, using the data-object-creation data, such that each of the data objects of the set of data objects comprises one or more variable strings of the set of variable strings.

2. The method of claim 1, wherein one or more of the data objects of the set of data objects is a chemical compound name, wherein each chemical compound name represents a chemical compound.

3. The method of claim 1, wherein one or more of the data objects of the set of data objects are chemical compound preparations.

4. The method of claim 1, wherein one or more of the data objects of the set of data objects are genera of chemical compounds.

5. The method of claim 1, wherein the data-object-creation data comprises a set of variable-directing strings comprising one or more variable-directing strings; and
wherein each of the data objects of the set of data objects is created, using the data-object-creation data, such that each of the data objects of the set of data objects comprises one or more variable strings of the set of variable strings; and wherein the variable-directing stings of the set of variable-directing strings are used to direct the placement of the variable strings within such data objects.

6. The method of claim 1, wherein the set of data objects is a set of chemical compound names, and wherein each chemical compound name of the set of chemical compound names is a data object of the set of data objects; and
wherein the data-object-creation data comprises a template string, wherein the template string comprises a set of variable-directing strings, wherein the set of variable-directing strings comprises one or more variable-directing strings, and wherein each of the variable-directing strings comprises information; and
wherein each of the chemical compound names of the set of chemical compound names is created, using the template string as a template, by using the information contained within each of the variable-directing strings of the set of variable-directing strings of the template string to direct the replacement of that variable-directing string with one of the variable strings of the set of variable strings.

7. The method of claim 1, wherein:
the set of data objects is a set of chemical compound preparations, and wherein each chemical compound preparation of the set of chemical compound preparations is a data object of the set of data objects, wherein each such chemical compound preparation comprises information pertaining to a procedure for synthesizing a chemical compound, wherein the information of the chemical compound preparations of the set of chemical compound preparations pertains to either: preparations of the same chemical compound, or to preparations of two or more different chemical compounds; and
wherein the data-object-creation data comprises a template string, wherein the template string comprises characters that are common to all of the chemical compound preparations of the set of chemical compound preparations, and wherein said template string further comprises a set of variable-directing strings comprising one or more variable-directing strings; and
wherein each subset of variable strings corresponds to one or more variable-directing strings of the set of variable-directing strings, such that each variable-directing string of the set of variable-directing strings has a corresponding subset of variable strings of the set of variable strings,
wherein each chemical compound preparation of the set of chemical compound preparations is created, using the template string as a template, by replacing each of the variable-directing strings of the set of variable-directing strings of the template string with one of the variable strings of the subset of variable strings corresponding to that variable-directing string, such that the set of chemical compound preparations so created comprises all of the chemical compound preparations representing all of the permutations of replacements of each of the variable-directing strings of the set of variable-directing strings in the template string with one of the variable strings of the subset of variable strings corresponding to that variable-directing string.

8. The method of claim 1, wherein:
the data-object-creation data comprises a template string, wherein said template string comprises a set of variable-directing strings, wherein said set of variable-directing strings comprises one or more variable-directing strings, and wherein said template string further comprises a set of exon strings, wherein the set of exon strings comprises one or more exon strings,
wherein each of the subsets of variable strings corresponds to one or more variable-directing strings of the set of variable-directing strings, such that each variable-directing string of the set of variable-directing strings has a corresponding subset of variable strings of the set of variable strings,
wherein the template string is used in the creation of each of the data objects of the set of data objects such that:
each of the data objects of the set of data objects comprises: every one of the exon strings of the set of exon strings; and one variable string of the corresponding subset of variable strings for each variable-directing string of the set of variable-directing strings;
wherein each of the variable-directing strings corresponds to a different variable-string locus within the data objects of the set of data objects, such that the number of variable-string loci within each of the data objects of the set of data objects is equal to the number of variable-directing strings of the set of variable-directing strings,
wherein each of the variable-string loci corresponds to the subset of variable strings that corresponds to that variable-string locus' variable-directing string,
and each of the variable-directing strings of the set of variable-directing strings is used to direct the placement of one of the variable strings from the corresponding subset of variable strings, at the variable-string locus corresponding to that variable-directing string, within each of the data objects of the set of data objects;
such that the set of data objects so created comprises all of the data objects representing all of the permutations of placements, at each of the variable-string loci, of each of the variable strings of the subset of variable strings corresponding to that variable-string locus.

9. An item of intellectual property, wherein the item of intellectual property comprises one or more of the data objects of the set of data objects of claim 1.

10. A method, in a data processing system comprising one or more CPUs, of creating a set of data objects, wherein said set of data objects comprises one or more data objects, comprising:
a step for providing data-object-creation data, wherein the data-object-creation data comprises a set of variable strings, wherein the set of variable strings comprises one or more subsets of variable strings, and wherein each subset of variable strings of the set of variable strings comprises one or more variable strings, and
a step for creating each of the data objects of the set of data objects using the data-object-creation data such that each of the data objects of the set of data objects comprises one or more variable strings of the set of variable strings.

11. The method of claim 10, wherein one or more of the data objects of the set of data objects are chemical compound names, wherein each chemical compound name represents a chemical compound.

12. An item of intellectual property, wherein the item of intellectual property comprises one or more data objects of the set of data objects of claim 10.

13. A business method for acquiring intellectual property comprising the steps, performed in a data processing system comprising one or more CPUs, of:
providing a set of chemical data, wherein the set of chemical data comprises one or more items of chemical data,
using the set of chemical data to create a set of chemical information, wherein said set of chemical information comprises one or more items of chemical information; and
outputting one or more items of chemical information of the set of chemical data to a file.

14. The method of claim 13, wherein one or more of the items of chemical information output to the file is a chemical compound name, wherein each chemical compound name represents a chemical compound.

15. An item of intellectual property, wherein the item of intellectual property comprises the one or more items of chemical information output to the file of claim 13, and wherein said item of intellectual property is created using such file.

16. A business method for acquiring intellectual property comprising the steps, performed in a data processing system comprising one or more CPUs, of:
providing data-object-creation data, wherein said data-object-creation data comprises a set of variable strings, wherein the set of variable strings comprises one or more subsets of variable strings, and wherein each subset of variable strings of the set of variable strings comprises one or more variable strings,
creating a set of data objects, wherein the set of data objects comprises one or more data objects, using the data-object-creation data, such that each of the data objects of the set of data objects comprises one or more variable strings of the set of variable strings; wherein the data objects of the set of data objects are inventive embodiments; and comprising the step, performed by a user, of:
creating the intellectual property using one or more of the inventive embodiments.

17. The method of claim 16, wherein one or more of the inventive embodiments used in creating the intellectual property is a chemical compound name, wherein each chemical compound name represents a chemical compound.

18. The item of intellectual property of claim 16.

19. A business method, wherein said business method comprises the steps, performed by a user, of:
providing a set of chemical compound names, wherein the set of chemical compound names comprises one thousand or more chemical compound names, wherein each chemical compound name represents a chemical compound,
providing enablement information pertaining to the chemical compounds represented by the chemical compound names, and
creating intellectual property using the chemical compound names and the enablement information.

20. The method of claim 19, wherein said method further comprises the step, performed by a user, of licensing or assigning the intellectual property.

21. The intellectual property of claim 19.

22. A method of adding value to intellectual property comprising the steps, performed by a user, of:
providing an intellectual property instrument,
providing a set of inventive embodiments comprising one or more inventive embodiments, and
using the intellectual property instrument and one or more of the inventive embodiments of the set of inventive embodiments to create a value-added intellectual property instrument, wherein the value-added intellectual property instrument comprises one or more of the inventive embodiments of the set of inventive embodiments.

23. The method of claim 22 wherein:
the set of inventive embodiments is a set of data objects, and wherein each inventive embodiment of the set of inventive embodiments is a data object of the set of data objects, wherein the set of data objects is created by the steps, performed by a data processing system comprising one or more CPUs, of:
providing data-object-creation data, wherein said data-object-creation data comprises a set of variable strings, wherein the set of variable strings comprises one or more subsets of variable strings, and wherein each subset of variable strings of the set of variable strings comprises one or more variable strings, and
creating each of the data objects of the set of data objects, using the data-object-creation data, such that each of the data objects of the set of data objects comprises one or more variable strings of the set of variable strings.

24. The method of claim 22, wherein one or more of the inventive embodiments used in creating the value-added intellectual property instrument is a chemical compound name, wherein each chemical compound name represents a chemical compound.

25. The value-added intellectual property instrument of claim 22.

26. A method of adding value to intellectual property, comprising:
a step for providing an intellectual property instrument,
a step for providing inventive embodiments, and
a step for creating value-added intellectual property using the intellectual property instrument and inventive embodiments.

27. The method of claim 26, wherein one or more of the inventive embodiments is a chemical compound name, wherein each chemical compound name represents a chemical compound.

28. The value-added intellectual property of claim 26.

29. A method of creating intellectual property comprising:
a step for providing a set of inventive embodiments, wherein the set of inventive embodiments comprises one thousand or more inventive embodiments,
a step for providing enablement information, and
a step for providing utility information, and
a step for combining the set of inventive embodiments, the enablement information, and the utility information to produce the intellectual property.

30. The method of claim 29, wherein one of more of the inventive embodiments of the set of inventive embodiments is a chemical compound name, wherein each chemical compound name represents a chemical compound.

31. The intellectual property of claim 29.

32. A computer program article of manufacture having a computer readable medium having computer program logic recorded thereon for creating a set of data objects comprising one or more data objects, said computer program article of manufacture comprising:
instruction means for receiving data-object-creation data, wherein said data-object-creation data comprises a set of variable strings, wherein said set of variable strings comprises one or more subsets of variable strings, and wherein each subset of variable strings comprises one or more variable strings, and
instruction means for using the data-object-creation data to create each one of the data objects of the set of data objects, such that each one of the data objects of the set of data objects comprises one or more variable strings of the set of variable strings.

33. The computer program article of manufacture of claim 32, wherein the computer program article of manufacture comprises computer data and computer program logic that provides a user with a library of variable strings for use in creating the set of variable strings.

34. The computer program article of manufacture of claim 33, wherein one or more of the variable strings of the library of variable strings is a chemical compound name fragment.

35. A method of creating an item of intellectual property comprising the step, performed by a processor comprising one or more CPUs, of using the computer program article of manufacture of claim 32 to create the set of data objects, and wherein the method further comprises the step, performed by a user, of using the set of data objects of the set of data objects to create the item of intellectual property.
